(19) United States
(12) Patent Application Publication
(10) Pub. No.: US 2002/0129001 A1
(43) Pub. Date: Sep. 12, 2002

(54) Method and system for assimilation, integration and deployment of architectural, engineering and construction information technology

(76) Inventors: Jonathan S. Levkoff, Hilton Head, SC (US); Diane E. Smith, Hilton Head, SC (US); David S. Paris, Bluffton, SC (US); F. Mark Hazen, Bluffton, SC (US); Stephanie L. Sutay, Bluffton, SC (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(21) Appl. No.: 10/020,856

(22) Filed: Dec. 12, 2001

Related U.S. Application Data
(60) Provisional application No. 60/254,866, filed on Dec. 12, 2000.

(51) Int. Cl. G06F 7/00

(52) U.S. Cl. 707/1

(57) ABSTRACT

A database solution is provided for the Architecture, Engineering and Construction (AEC) industry. A unified database integrates manufacturer, engineering, building code and regulatory information relative to building components. Manufacturer product names and numbers are cross-referenced to a standard nomenclature and numbering system, thereby creating a generic, universal mechanism for coding all building components. An intelligent drag and drop functionality allows users to seamlessly transfer database information into all computer-aided design (CAD) and non-CAD document systems.

### CROSS REFERENCE TO RELATED APPLICATIONS

This application claims the benefit of U.S. Provisional Application No. 60/254,866 filed Dec. 12, 2000 entitled “METHOD AND SYSTEM FOR ASSIMILATION, INTEGRATION AND DEPLOYMENT OF ARCHITECTURAL, ENGINEERING AND CONSTRUCTION INFORMATION TECHNOLOGY.”

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND OF THE INVENTION

The present invention relates to the field of architecture, engineering and construction information technology.

Architectural, Engineering and Construction (AEC) information includes building components, permitting requirements, building codes, engineering standards, general governmental standards (e.g., OSHA in the United States), and industry-specific AEC guidelines and governmental requirements. That information, and modifications thereto, are integral to the entire AEC project lifecycle—from design through maintenance and re-engineering.

Building components include all items necessary to construct and operate a building project. The range of items includes gravel for roadbeds, doors and windows, complex machine tools and nuclear turbines. Globally, there are over 2200 categories of building components covering hundreds of thousands of items. Information on building components includes graphical representations, functional and engineering specifications, installation and maintenance instructions, and manufacturer's suggested retail pricing.

AEC projects include all public and private buildings and infrastructure (e.g., roads, airports) projects. Global construction expenditures and capital goods expenditures are in the trillions of dollars.

Currently, AEC information sources are highly fragmented—both within and across information types. The vast majority of global AEC information is not available electronically. Information that exists electronically typically resembles an electronic catalog—a new media version of old media content. It is not assimilated into an organized database; is not codified in a universally meaningful manner; and, is rarely useable except in a “view only” mode. Further, there is no integration across information types. Therefore, AEC participants must now search for, acquire, and assimilate that information manually. Integration into project documents (graphics and text) is also primarily manual. Many architects and engineers use computer-aided design (CAD) tools. However, these tools are little more than electronic pencils.

The AEC industry is in need of a universal, standardized platform for representing and tracking building components during their entire lifecycle. The present invention fulfills this need.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings an embodiment that is presently preferred. It should be understood, however, that the invention is not limited to the precise arrangements and instrumentalities shown. In the drawings:

FIG. 1 shows excerpts of a product analysis data spreadsheet;

FIG. 2 shows an entity relationship diagram created based on the data in the product analysis data spreadsheet in FIG. 1;

FIGS. 3A-3E shows an XML data representation of the entity relationship diagram of FIG. 2;

FIGS. 4A-4D show excerpts of another product analysis data spreadsheet;

FIG. 5 shows an entity relationship diagram created based on the data in the product analysis data spreadsheet in FIGS. 4A-4D;

FIG. 6 shows another entity relationship diagram for modeling key data of building components;

FIGS. 7A-7I show user interface screens for use in the present invention;

FIGS. 8A and 8B show user interface screens of a CAD application program, and illustrate the association of a unique building component identification number with a building component element in accordance with the present invention;

FIG. 9 shows a schematic block diagram of the overall architecture of one embodiment of the present invention;

FIG. 10 shows a cross-reference table of the different building component identification numbers used in the present invention;

FIG. 11 shows an example of how a building component is coded with a characteristic-based identification number;

FIGS. 12 and 13 shows additional user interface screens for use in the present invention;

FIGS. 14-17 show examples of regulatory code compliance rules;

FIG. 18 shows a schematic block diagram of the overall architecture of a regulatory code compliance process;

FIGS. 19A-19G, taken together, are flowcharts that show the process flow of database creation, quality control and maintenance in accordance with a second embodiment of the present invention;

FIGS. 20A-20D, taken together, are flowcharts that show the process flow when using a website of the database host in accordance with a second embodiment of the present invention;

FIGS. 21A-21I, taken together, are flowcharts that show the process flow of user registration and account maintenance in accordance with a second embodiment of the present invention;

FIGS. 22A-22E, taken together, are flowcharts that show the process flow of project management in accordance with a second embodiment of the present invention;

FIGS. 23A and 23B, taken together, are flowcharts that show the process flow of user-created components in accordance with the second embodiment of the present invention;

FIGS. 24A and 24B, taken together, are flowcharts that show the process flow of changing components in a component database in accordance with a second embodiment of the present invention; and

FIGS. 25, 26, 27, 28A and 28B show a network configuration and hardware architecture configuration of a database system in accordance with a second embodiment of the present invention.

### BRIEF SUMMARY OF THE INVENTION

A unified database integrates manufacturer, engineering, building code and regulatory information relative to building components. Manufacturer product names and numbers are cross-referenced to a standard nomenclature and numbering system, thereby creating a generic, universal mechanism for coding all building components. An intelligent drag and drop functionality allows users to seamlessly transfer database information into all computer-aided design (CAD) and non-CAD document systems.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

Definitions

The following definitions are provided to promote understanding of the invention.

building component data element—data representation of a physical building component. One type of data element may be a data object, such as a cell (cel) file, which has drag-and-drop capabilities.

drawing file or design file—specialized application programs are used for computer-aided design and drafting (CAD). The two most popular CAD programs are AutoCAD® and MicroStation®. The file format for an application program is identified by the suffix of the file name. The standard AutoCAD drawing file format is DWG, and the standard MicroStation drawing file format is DGN. Many other CAD drawing file formats exist, such as DWF (Drawing Web Format, an AutoCAD web-based format), DXF (Drawing Exchange Format, a generic format), and WMF (Windows Meta File, a file format that allows a drawing from a CAD program file format to be used in a non-CAD program (e.g., Word document)). The present invention may be used when interfacing with any CAD or non-CAD application program that uses building component data elements, either directly or indirectly. The phrases “drawing file” and “design file” are used interchangeably.

vendor-specific building component—a uniquely identifiable building component sold by a specific vendor. For example, Lightolier sells a Calculite commercial-grade incandescent A lamp downlight having a 4½ inch aperture. Lightolier also sells a low profile version having the same aperture. Lightolier further sells a similar downlight having a 6 inch aperture, a 6 inch aperture in a low profile version, and a 7½ inch aperture. Each of these products is a uniquely identifiable building component. Furthermore, these downlights may be mounted vertically or horizontally. If any physical differences exist between the vertical and horizontal downlights, then the vertical downlights are considered to be unique from the horizontal downlights. Furthermore, if any significant physical changes are made to this line of downlights in a new product year, then the new downlights are considered to be unique from the old line of downlights.

vendor-specific building component data element—a building component data element that represents a specific vendor (manufacturer) product or component. For example, a drag-and-drop cell file may represent a low profile commercial-grade incandescent A lamp downlight having a 4½ inch aperture. In a conventional approach, the cell file represents exact or approximate dimensional characteristics of the downlight so that when the downlight is placed in a drawing file or design file, the downlight appears properly scaled in relation to other drawing elements. However, the cell file does not contain any information that identifies the downlight by vendor name or number. In accordance with the present invention, the cell file (or its equivalent data element) contains such vendor-specific information. In this manner, a user who inspects the drawing file or design file, or an inventory of its contents, can determine the exact dimensional characteristics of the downlight, as well as the exact vendor's product selected by the creator of the drawing file or design file.

generic building component identification number—an identification number assigned to each physically unique building component. In the Lightolier example above, each of the downlights would receive a different identification number. If any significant physical changes were made to this specific line of downlights in a new product year, then the new downlights would be considered unique from the old line of downlights and thus would receive a new set of identification numbers. This identification number is also referred to below as the “GCID” or “Databuilt product ID.” If General Electric sells a downlight that is physically identical to a Lightolier downlight, then the General Electric downlight is assigned the exact same GCID. Thus, a customer who wants to swap out or compare identical building components may do so by locating building components with identical GCID's. However, as described below, the customer preferably is not provided access to the GCID's and actually conducts the search using a building component number that does not reveal the GCID.

vendor identification number—a number arbitrarily assigned to each building component vendor. For example, General Electric may be assigned vendor ID number 4992408, whereas Lightolier may be assigned vendor ID number 145551. This number is also referred to below as the “VID.”

unique building component identification number—a unique number assigned to each unique building component of each vendor. This number is an algorithmic combination of the VID and GCID. In one preferred embodiment described herein, the algorithmic combination is a concatenation of the VID and GCID. This number is also referred to below as a “unique building component identifier,” a “UCID,” “Databuilt number,” or “Databuilt Internal ID” of a building component.

The UCID may be represented in two different forms, namely, an unencoded form and an encoded form. In the unencoded form using a concatenation scheme, the UCID may have a format of VID+GCID, and is represented as a numerical value. In one preferred embodiment of the present invention, the encoded form is a zero-padded concatenation of a hexadecimal equivalent of the VID and GCID, with additional hexadecimal checksum digits and version digits. The UCID is preferably represented in encoded form when used by the public. In this manner, proprietary aspects of the numbering schemes are hidden from the public. The encoded UCID may also be used to create bar codes for attachment to, or association with, building components.

Since the UCID may be decoded to obtain the GCID, a user that wants to find an exact match for a specific building component, may enter the encoded UCID (e.g., bar code), and obtain any matching building components from other vendors that have the same GCID. To maintain the secrecy of the numbering scheme, the user is presented with the encoded UCID of the matching building components and/or a physical description of the matching product that is sufficient to allow the user to request the building component from a vendor. All vendors are informed of their UCID's of the building components so that user requests based on UCID's can be efficiently processed.

external object identifier—This number is also referred to below as an “EOI” and a “characteristic identification number.” The EOI is a building component value that is created based upon characteristics (attributes) of the building component. The EOI is represented by a string of numbers with a dot (period) separating each characteristic. Every building component in a given category has the same number of positions (digits) separated by the periods. The position within these dotted numbers of the individual digits is the same across the entire category. For example, all building components within a particular category that has the number “5” in the seventh position share a common attribute. The encoding scheme determines what the number “5” means in the seventh position. Zeroes are used in EOI positions when the building component does not have the particular attribute specified by that position.

The EOI may be used to locate building components of other vendors that may be comparable, equivalent, or substitutable for a building component of a particular vendor. Building components that are functional equivalents may have extremely similar or even identical EOI values. The length of the EOI depends upon the number of defined characteristics. If a building component is defined by a large number of characteristics, it is likely that two building components from different manufacturers may be physically identical (i.e., a customer may consider the two building components to be identical to each other), but may have slightly different characteristics (e.g., eggshell finish vs. off-white finish). If color is one of the characteristics, then the two building components will have slightly different EOI's, perhaps differing only by one digit. A search of building components similar to the eggshell finish building component would likely locate the off-white finish component, especially if there were no other different characteristics.

Each UCID has a corresponding EOI.

project database—the project database stores all of the building component data elements that users have selected and inserted into a CAD-based drawing file or design file, or into a non-CAD application program (e.g., spreadsheet, word processing program, presentation software). The project database is partitioned either logically or physically by building project so that every project has its own identifiable project database entries. A project may be the construction of a house at 105 Elm Street, the design of an industrial plant at 1100 Commerce Drive, an overpass at mileage marker 222 of I-95 in Virginia, etc. An important feature of the present invention is that the project database contains UCID's of the selected building components, as opposed to generic identifiers of a building component. In this manner, the project database has precise knowledge of the exact building components to be used (or in use) for a project.

Detailed Disclosure—Embodiment 1

The present invention is described in the context of a global information services company, known as Databuilt, Inc. The scope of the present invention, howerver, is not limited to the specific manner in which services are delivered by Databuilt, Inc.

I. Building Component Database

To implement the present invention, a database of building components is created. The database is structured to allow for easy interactivity and updating. One suitable process for creating the database when none currently exists is set forth in the steps below.

1. Select a category of building components to add to the database.

2. Identify properties, features, attributes and the like of building components in the category. These will vary according to the building component. Both physical (parametric) attributes and non-physical (non-parametric) attributes should be identified. Non-physical attributes may include installation instructions, warranty information, maintenance instructions, or compliance code data of building components, listings of other building components that are compatible with specific building components, and listing of other building components that are necessary to install or use with specific building components.

3. Create a product analysis data spreadsheet for the category of building components. A data analyst would typically perform this function.

4. Create an entity relationship diagram (ERD) for the category of building components. One suitable software tool for creation of the ERD is the ERwin ERD tool, commercially available from Logic Works, Inc., Princeton, N.J. A data modeler would typically perform this function.

4. Create an XML data representation of the ERD.

5. Create an XML database of the building components. One suitable software tool for creating the XML database is Oracle 9i. A data architect would typically perform steps 4 and 5.

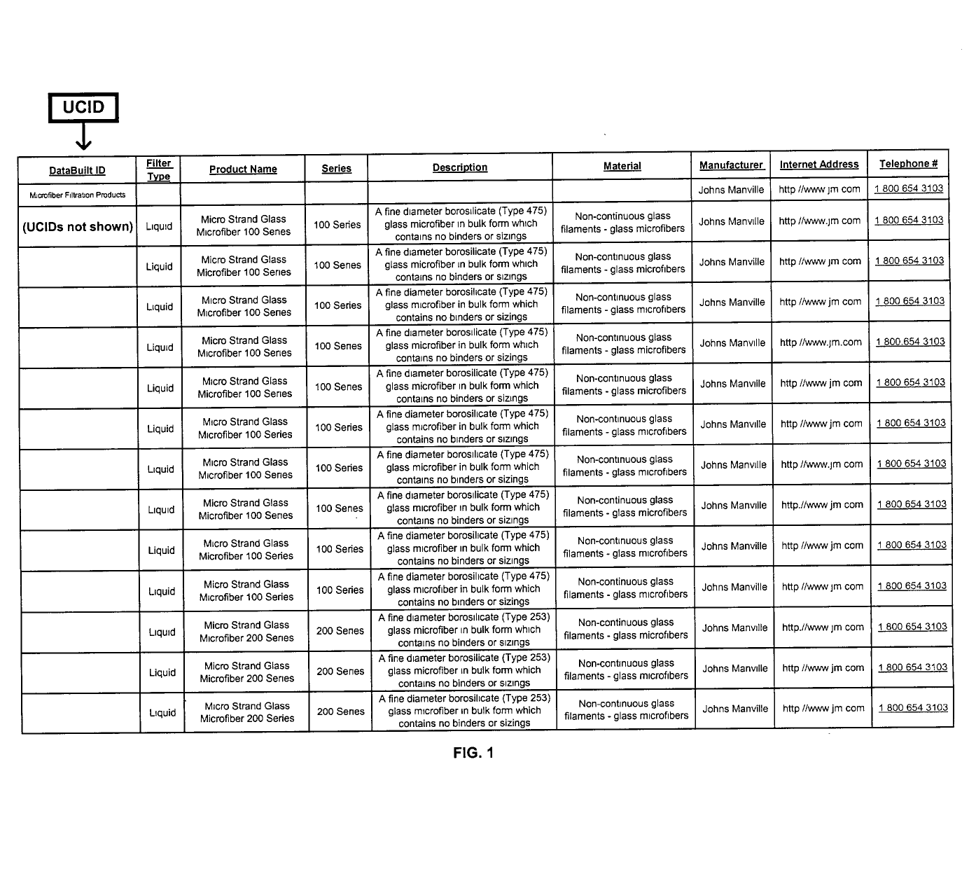

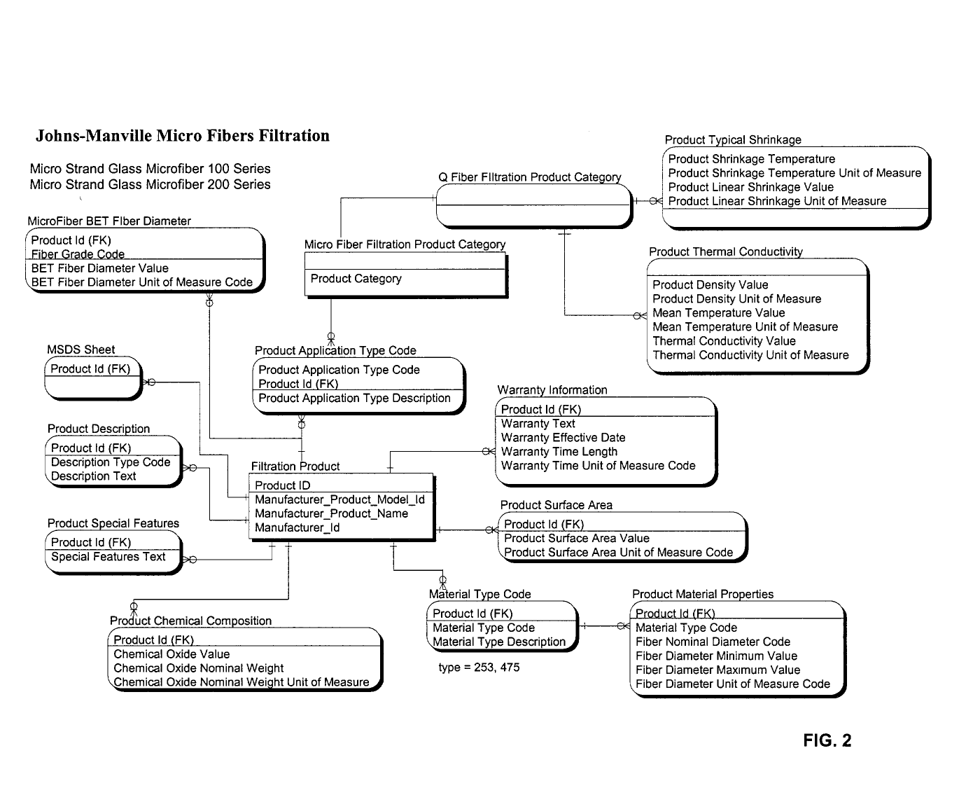

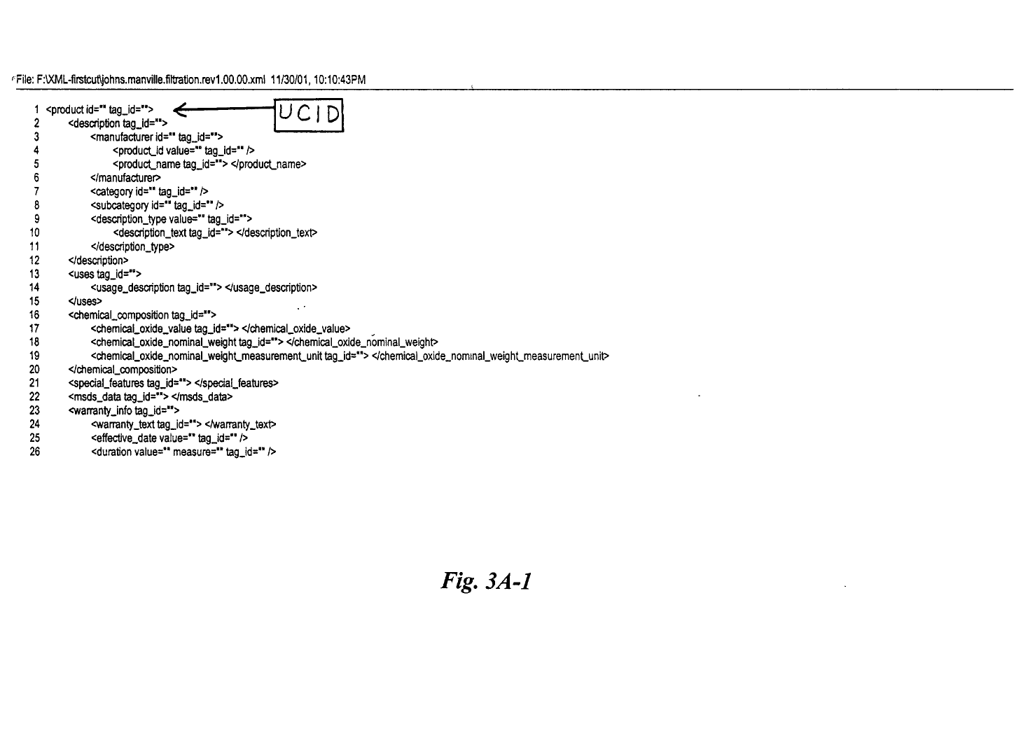

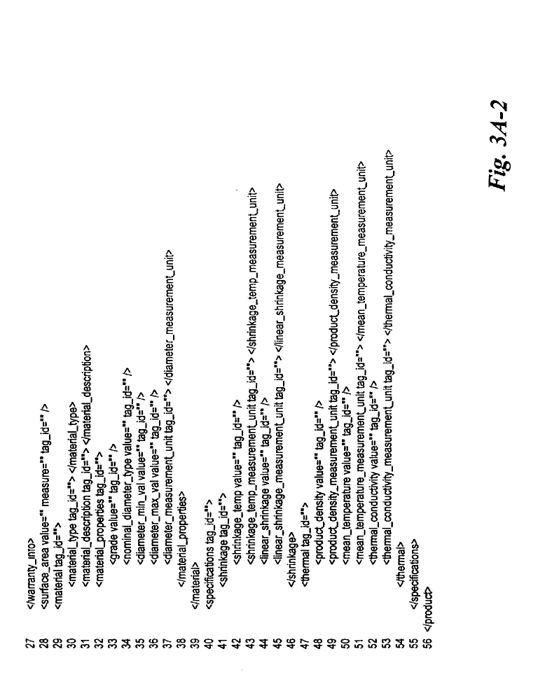

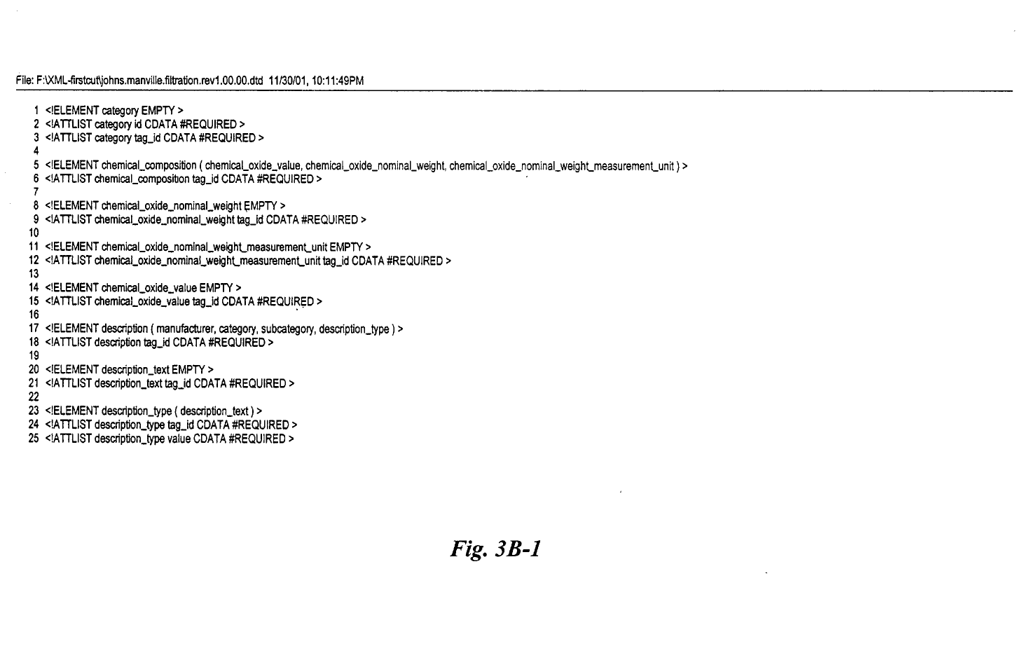

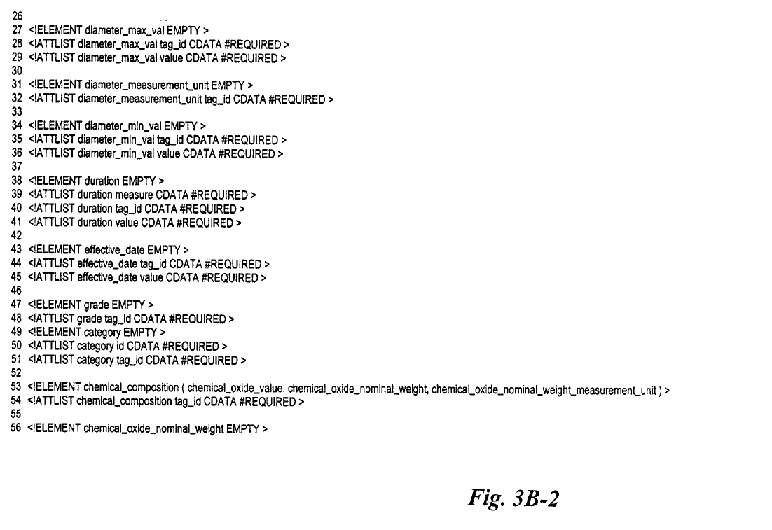

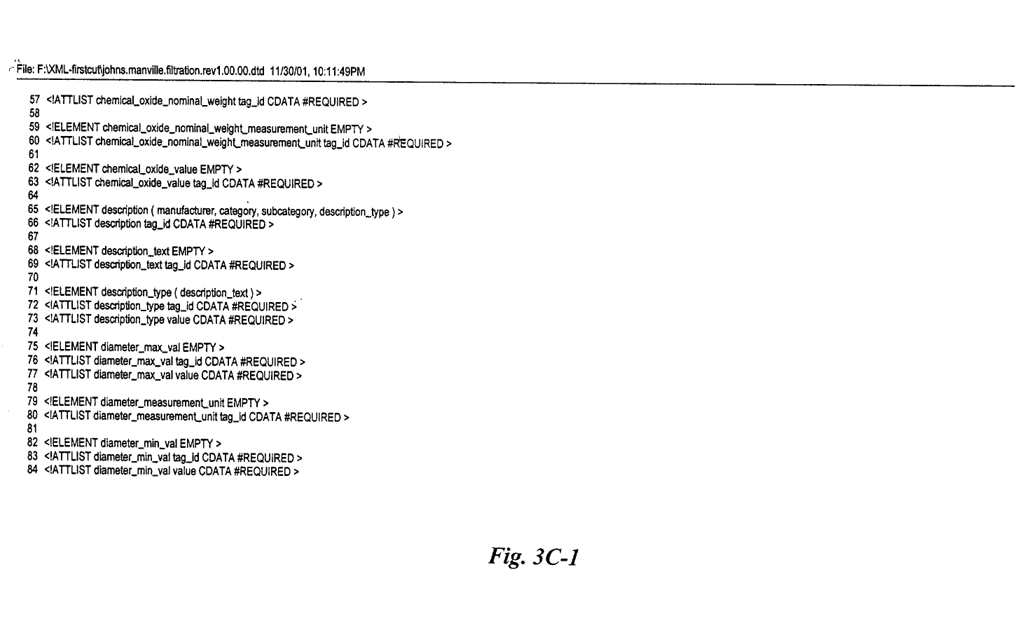

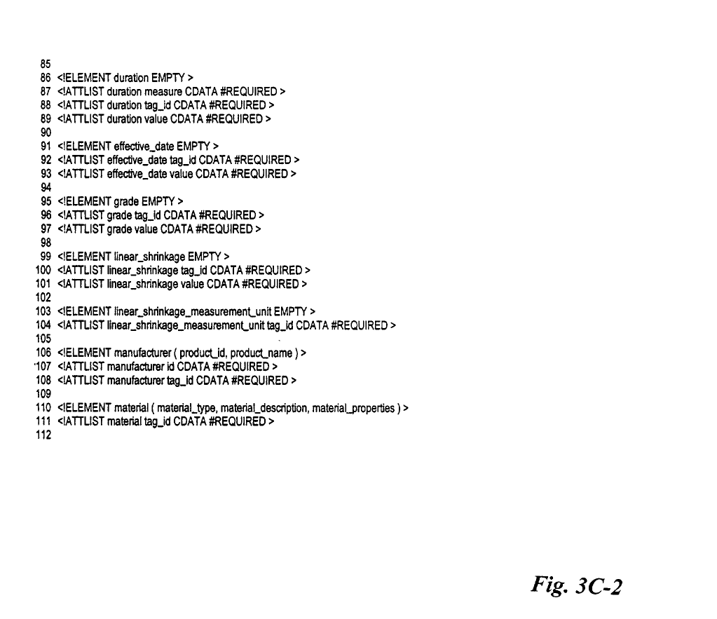

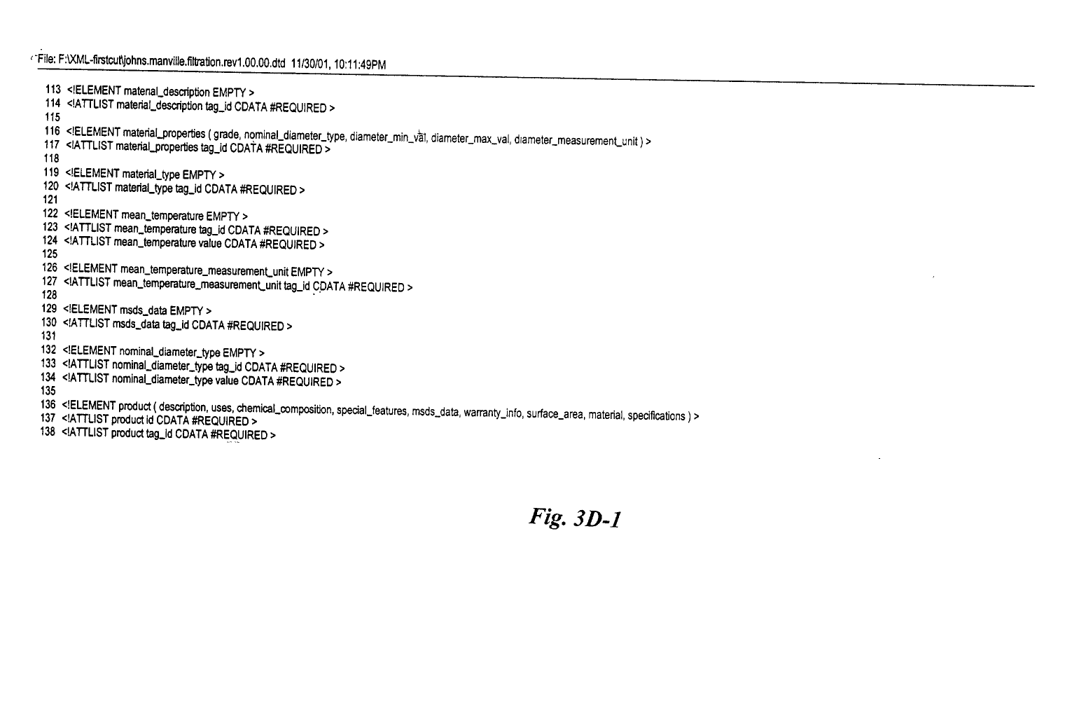

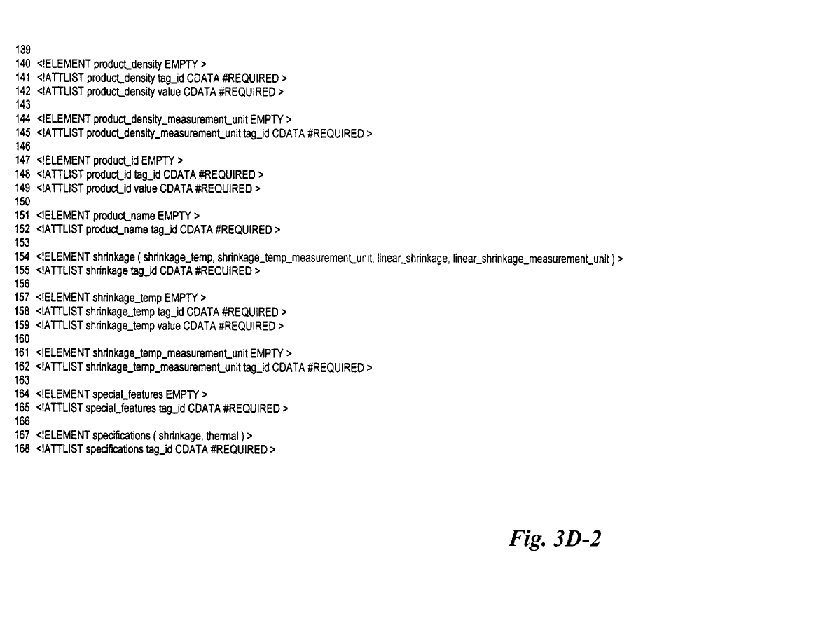

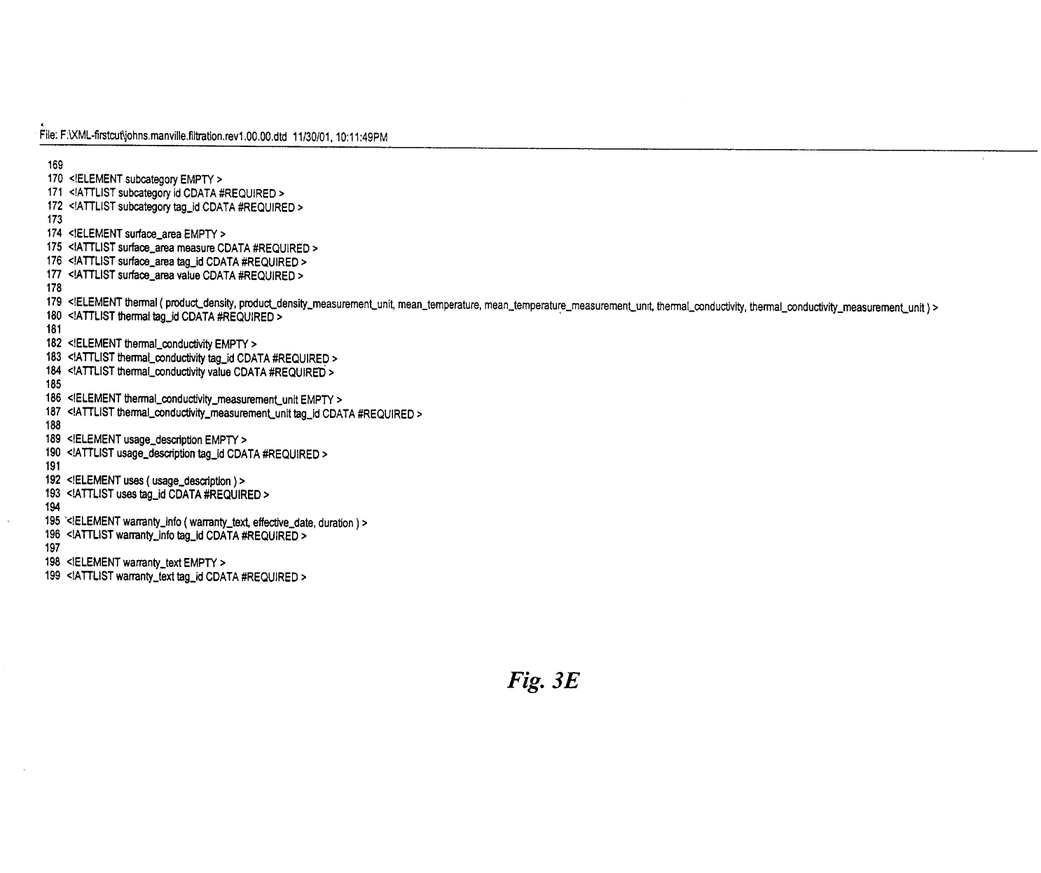

FIG. 1 and FIG. 2, and FIGS. 3A-3E show an example of this process for microfiber filtration products. In this example, a product line from Johns-Manville was used to identify properties, features, attributes and the like of the products.

FIG. 1 shows excerpts of the product analysis data spreadsheet (steps 1-3).

FIG. 2 shows the ERD (step 4).

FIGS. 3A-3E shows the XML data representation of the ERD (step 5).

The XML database is then created by mapping the tags in the XML data representation to the actual data of a vendor's product. This mapping may be done manually, or may be automated by converting data in vendor catalogs (e.g., PDF formatted data) directly into the appropriate XML data.

If the XML database currently exists for the building component (here, microfiber filtration products), then steps 1-5 need not be repeated, and the data may be immediately entered. However, every new vendor product line and every update of a previously entered vendor product line must be examined to determine if any changes or additions must be made to the structure of the XML database. For example, a new product may be introduced that has a previously undefined significant property or characteristic when must then be added to the XML database.

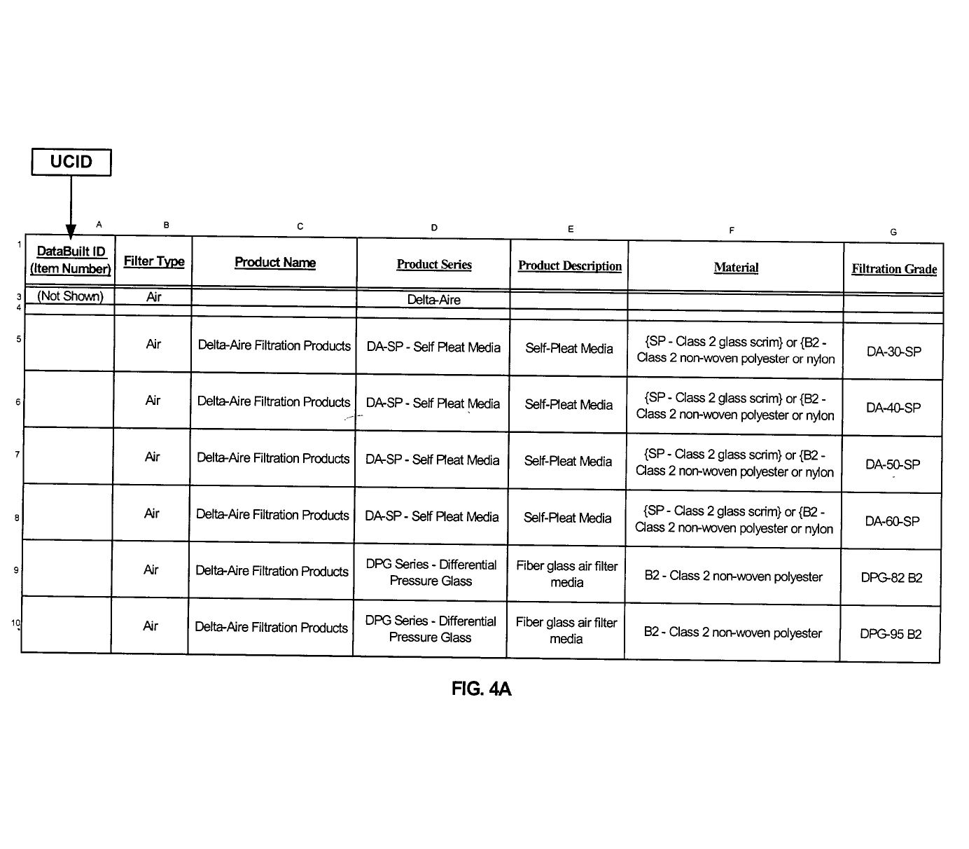

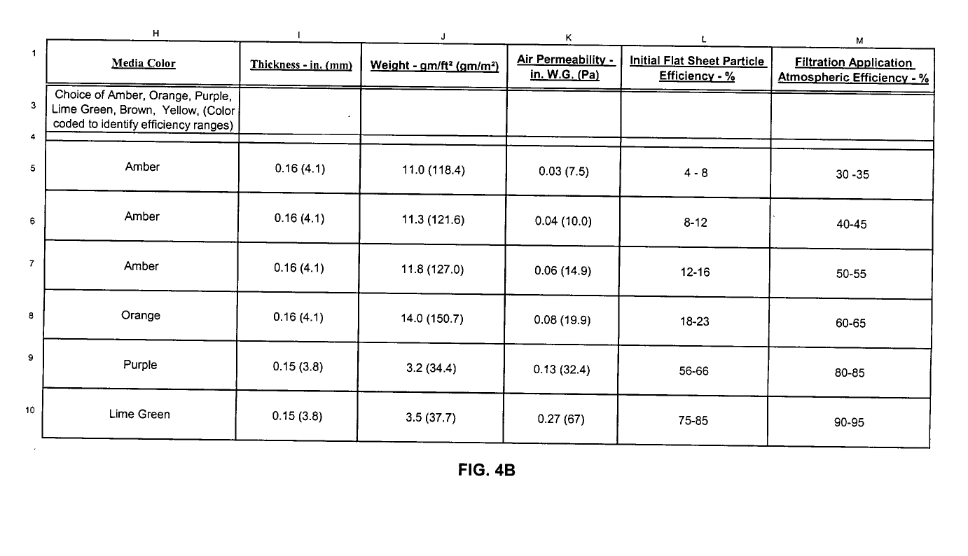

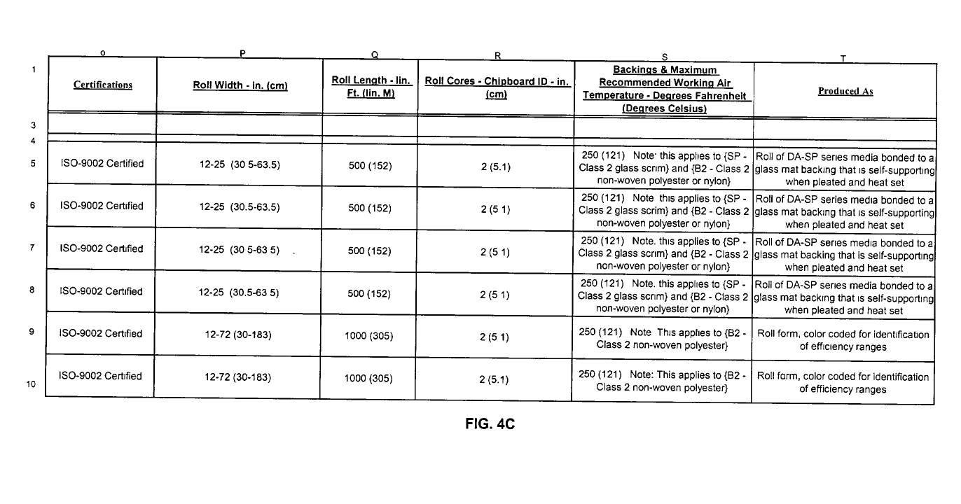

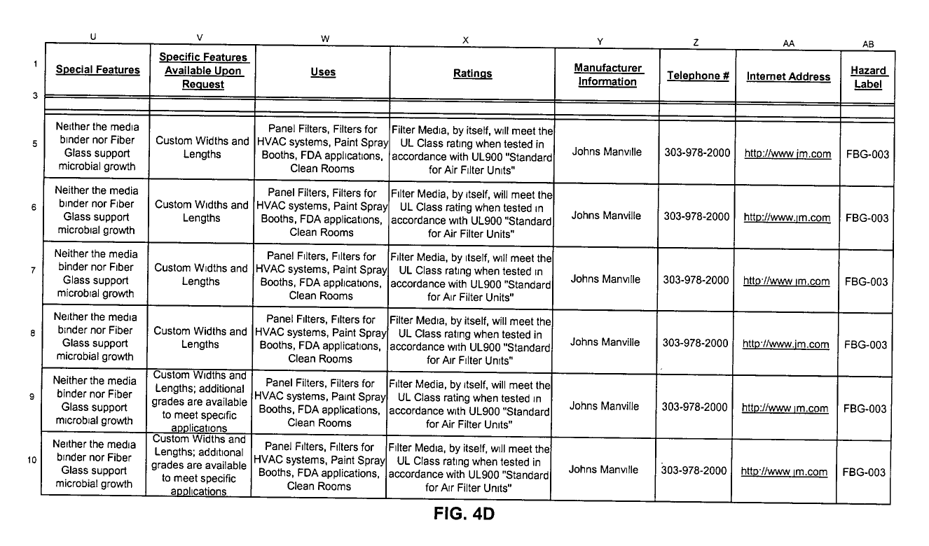

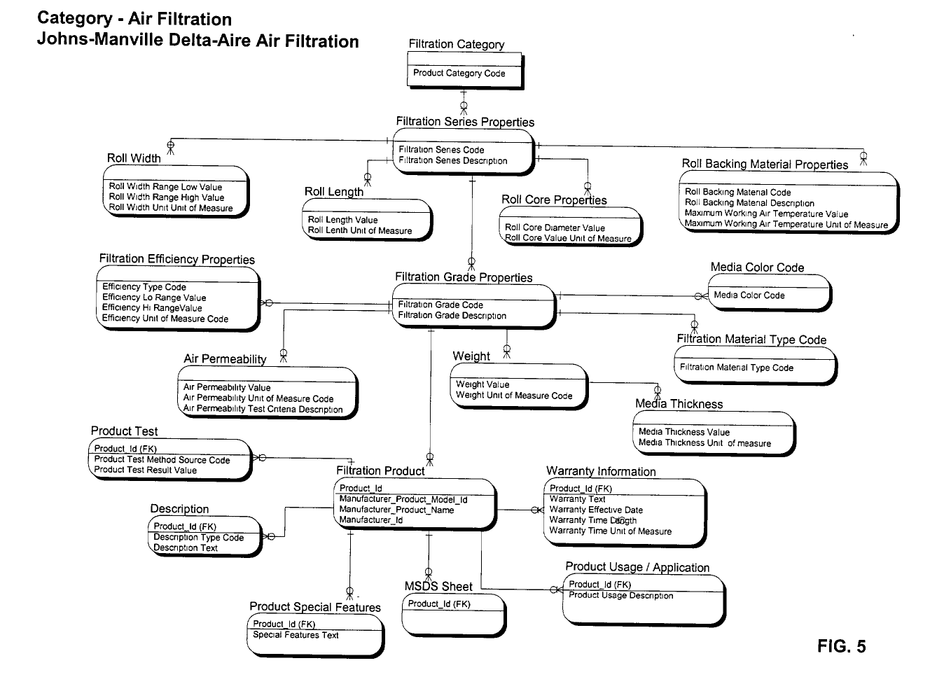

FIGS. 4A-4D and FIG. 5 show another example of the database creation process for a different building component, namely air filtration products. FIGS. 4A-4D show excerpts of the product analysis data spreadsheet. FIG. 5 shows the corresponding ERD.

To simplify the ERD modeling process which must be conducted for an extremely large number of disparate types of building components, the properties, features, attributes and the like of building components may be nested at two or more levels. In a two level nesting, a first or top level may include all of the properties, features, attributes and the like that exist for most or all building components, whereas a lower level may include a plurality of second levels for describing the properties, features, attributes and the like that exist only for a specific class of building components. For example, the top level may include product identifying information, price information, and warranty information, since all building components will have such information. A lower level may be defined for filtration products which have properties, features and attributes specific only to such products. Additional lower levels (at the same level as filtration products) may be defined for fasteners, roofing materials, etc.

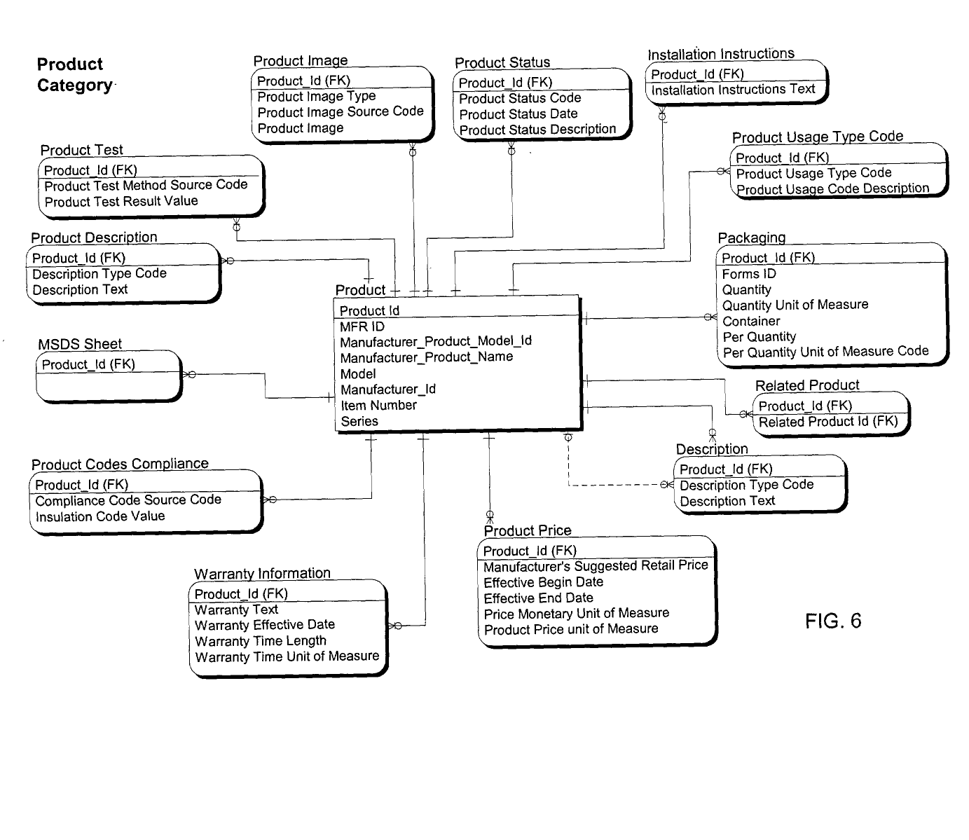

FIG. 6 shows an example of a top level ERD for such a nested scheme. The XML database created from unnested and nested ERD's is the same.

An important feature of the present invention is that each building component is identified by a UCID that distinguishes the building component from every other building component, including identical building components made by other vendors. The tag for the UCID is shown in FIG. 3A, line 1, and is referred to as the “product ID.” The “product ID” referred to in the ERD is UCID.

One attribute of a building component tracks whether the building component is “active” (i.e., commercially available) or “inactive” (no longer commercially available). In one suitable scheme, the attribute has a value of “1” for active and “0” for inactive. If a building component changes from “1” to “0” due to a vendor discontinuing a building component, a data stamped log entry is made in a history file. If the building component subsequently becomes available again, another log entry is made.

II. Project Database

As described above in the Definitions section, the project database stores all of the building component data elements that users have selected and inserted into a CAD-based drawing file or design file, or into a non-CAD application program (e.g., spreadsheet, word processing program). In this manner, the project database has precise knowledge of the exact building components to be used (or in use) for a user's project.

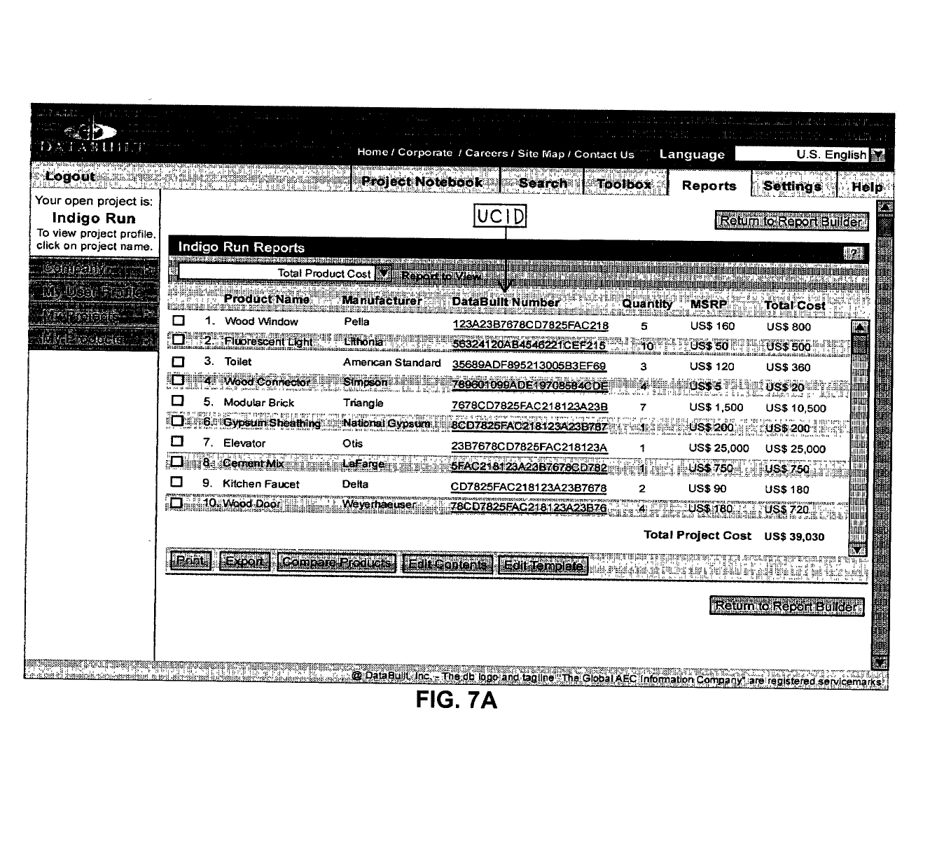

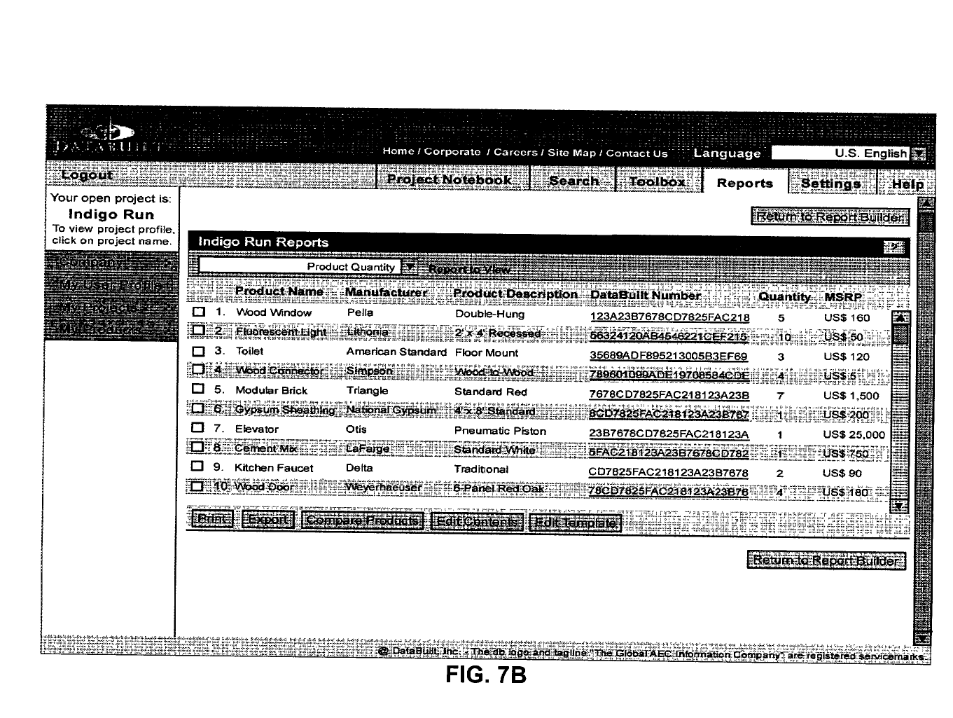

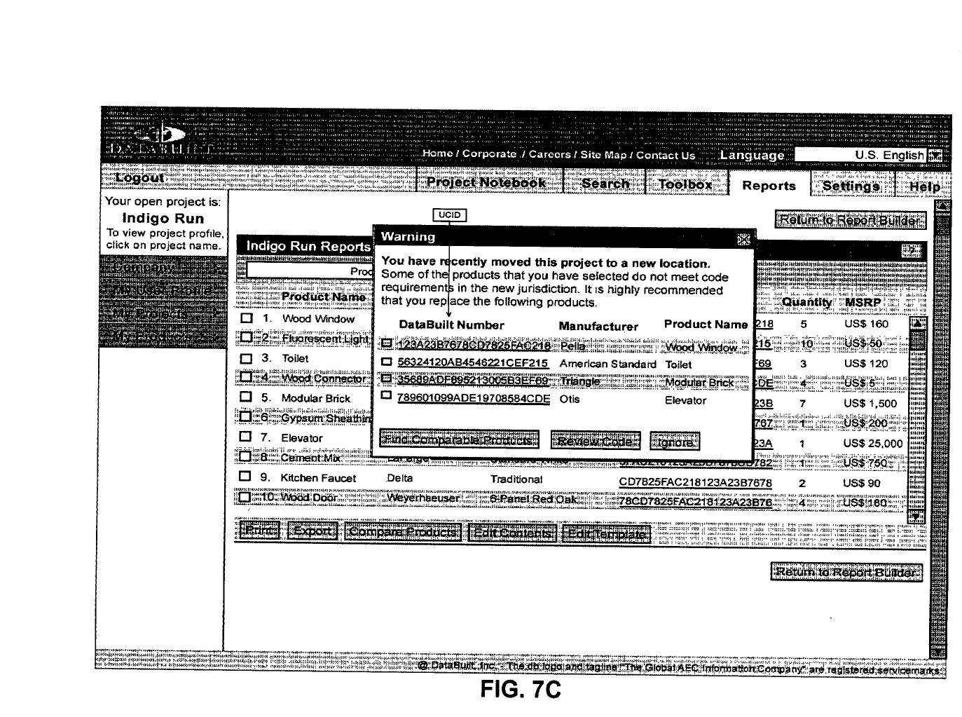

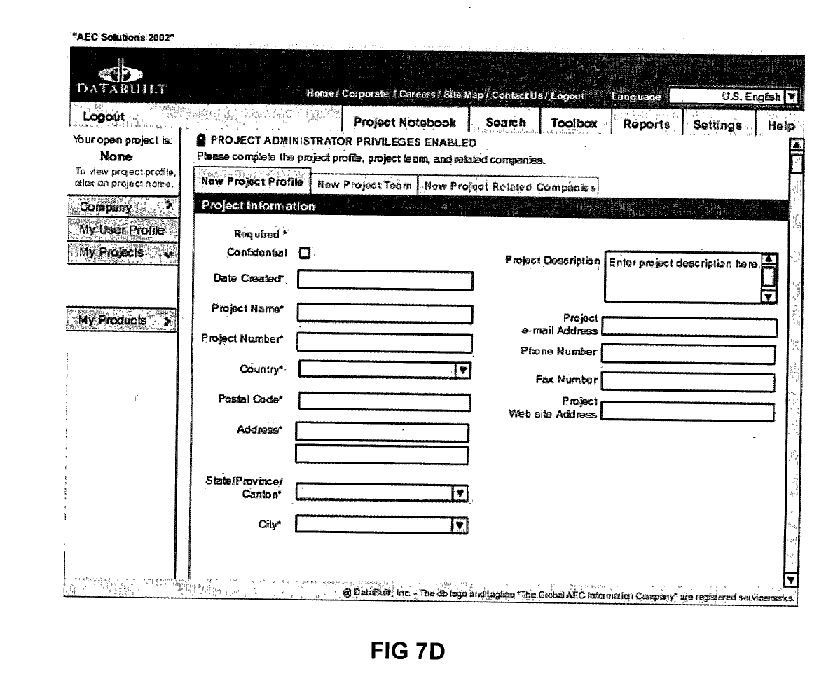

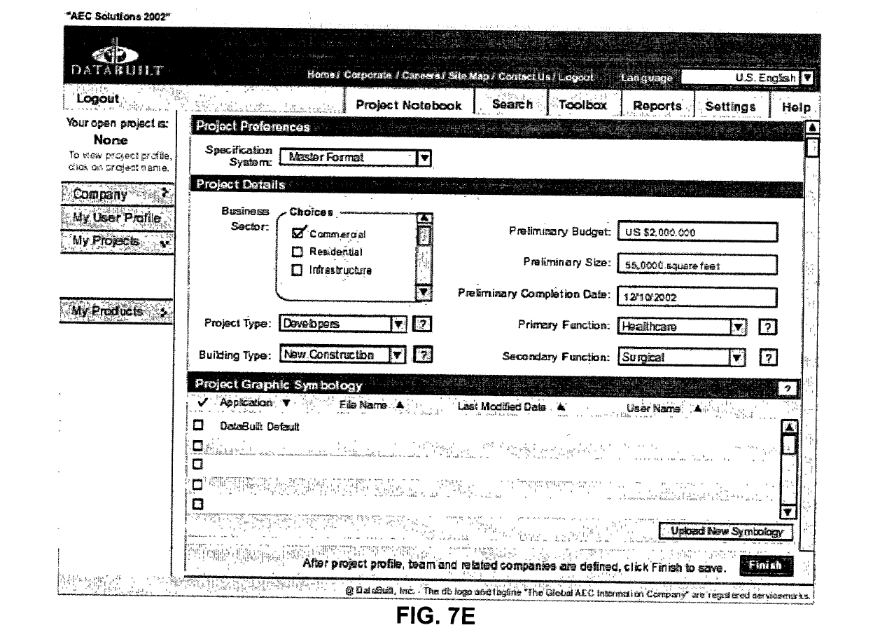

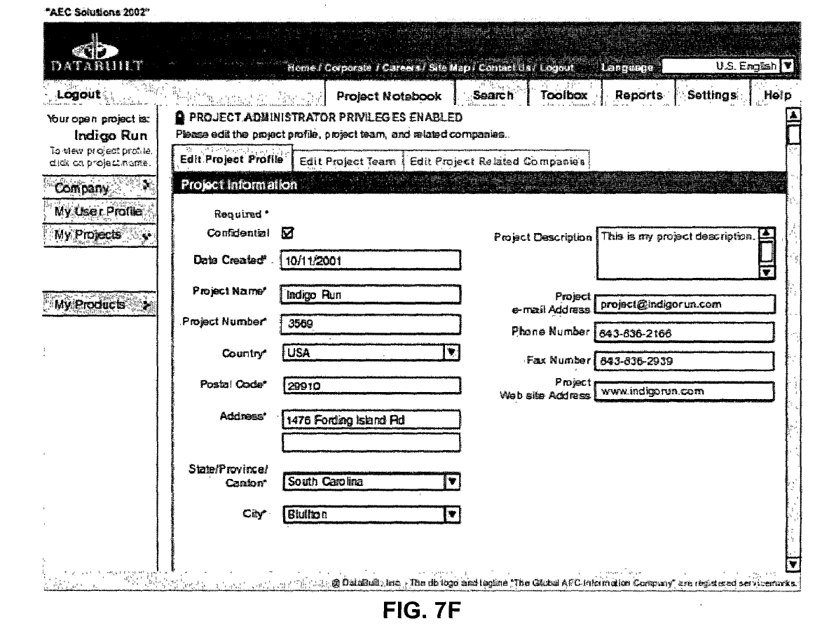

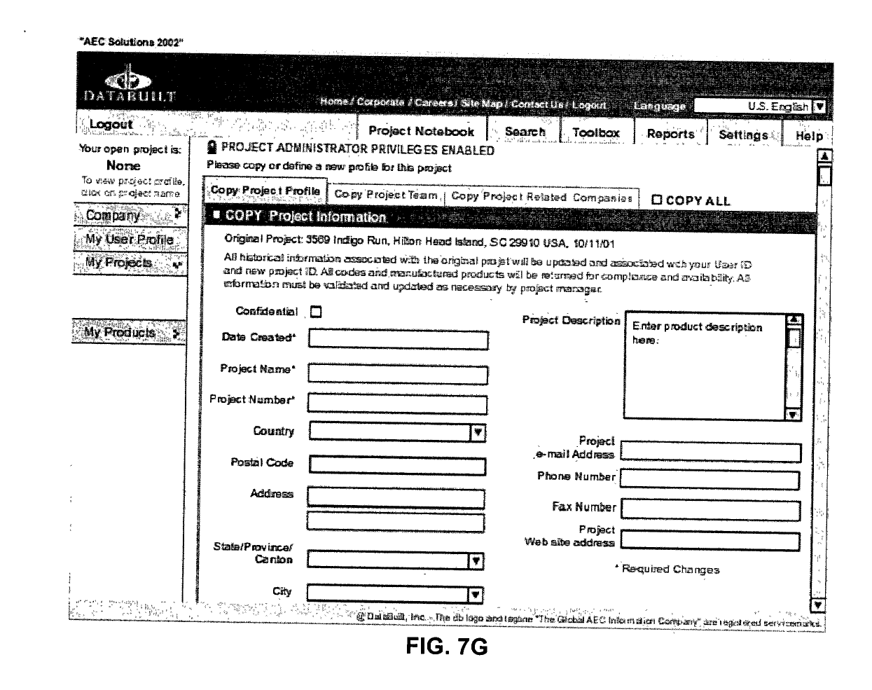

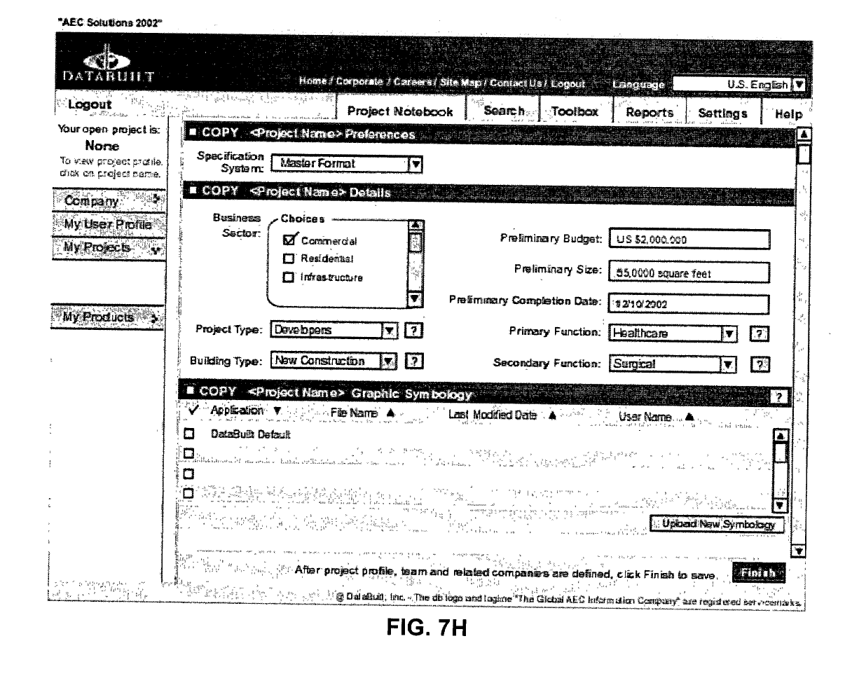

FIGS. 7A and 7B show a user interface screen and illustrates an example of database entries for some building components used in a project called Indigo Run. At a minimum, the database stores a UCID (Databuilt Number in FIGS. 7A and 7B) and quantity for each building component. Preferably, the UCID is presented in its encoded, hexadecimal format. Alternatively, additional descriptive data fields may be presented, such as product name, manufacturer, product description and price. The project database may be stored as an extension of the XML database, or as a separate database linked to the XML database. Accordingly, all of the detailed building component information that has been stored in the XML database may be accessed by selecting the UCID. In a web-based solution, the UCID's may be hyperlinked to the remaining building component information.

FIG. 7C is another user interface screen that displays a warning related to the selected building components. FIG. 7C is described in more detail below.

FIGS. 7D-7I show additional user interface screens that are used to define projects. These figures are self-explanatory and thus are not described further. However, an important feature of the present invention is that each project is defined by one or more geographic identifiers which specify where the project is located. The geographic identifier may include one or more of a zip code, street address, latitute/longitude, a city or municipality, a state, and the like. Preferably, there is a geographic identifier for each set of building codes for which the property must comply. Each project is further defined by a zoning identifier which specifies the zoning of the project location. The geographic identifier and the zoning identifier are used to verify that the selected building components are in compliance with all appropriate building codes.

III. Drawing Files

In a CAD-based environment, the present invention may be used to store all of the building component data elements that users have selected and inserted into a drawing file.

AutoCAD and Microstation allow non-graphical data to be associated with elements in a drawing file by using comment fields (object comments). In Microstation, the comment fields are provided in “tags.” For example, tags may be used to define a graphical image of a pipe as being a “pipe” having a “4 inch diameter.” The process of creating a tag set and attaching, editing and reviewing tags is well known in the prior art, and thus is not described in detail. A short tutorial on this topic may be found in the following newsletter article: DiMauro, R. “Making the Association with Tags,” The Client Server, Vol. 6, No. 3, March 1998, published by Bentley Systems, Inc.

The present invention uses the comment field to store the UCID. In a Microstation embodiment, the user creates a tag in the tag set for storing the UCID.

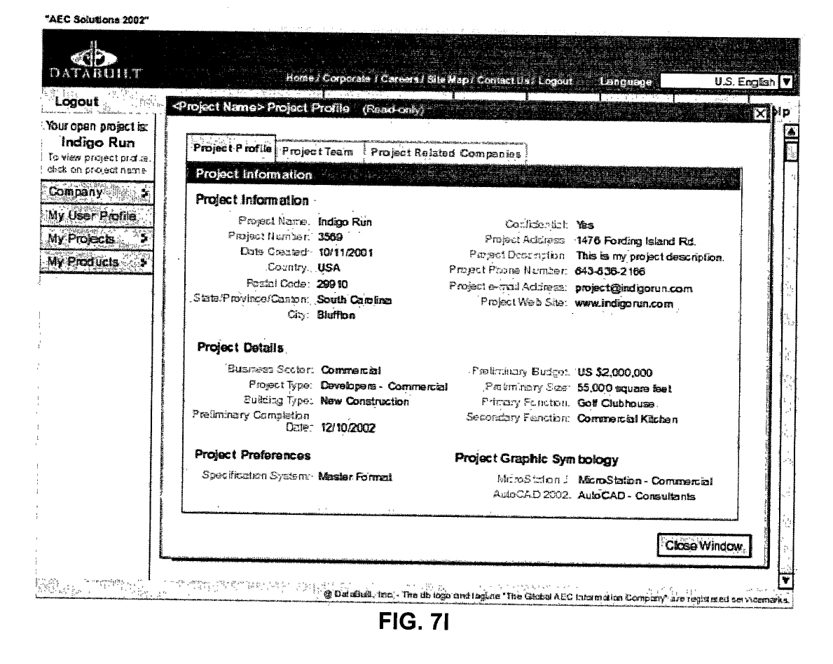

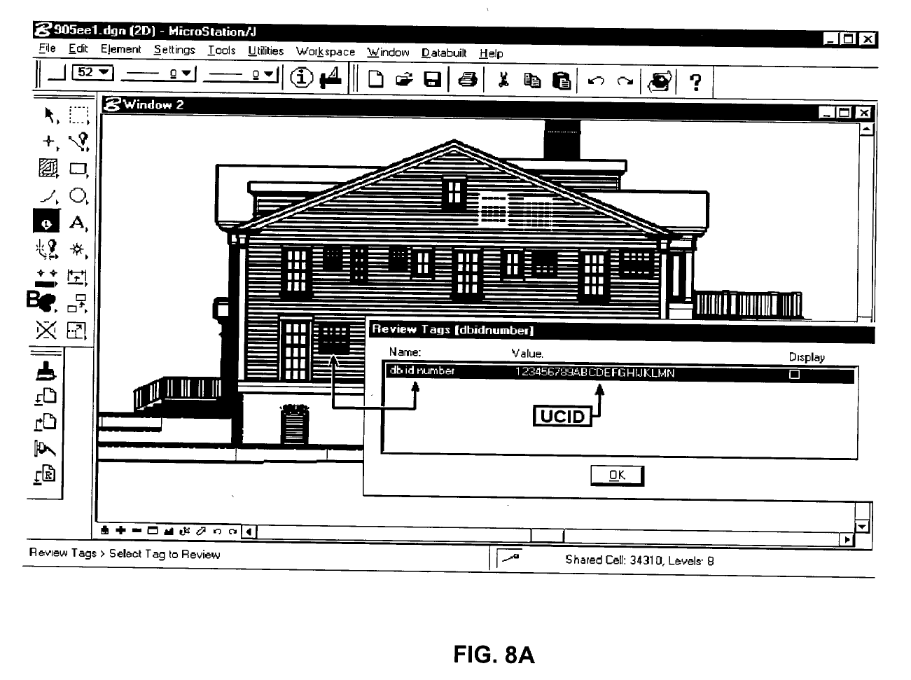

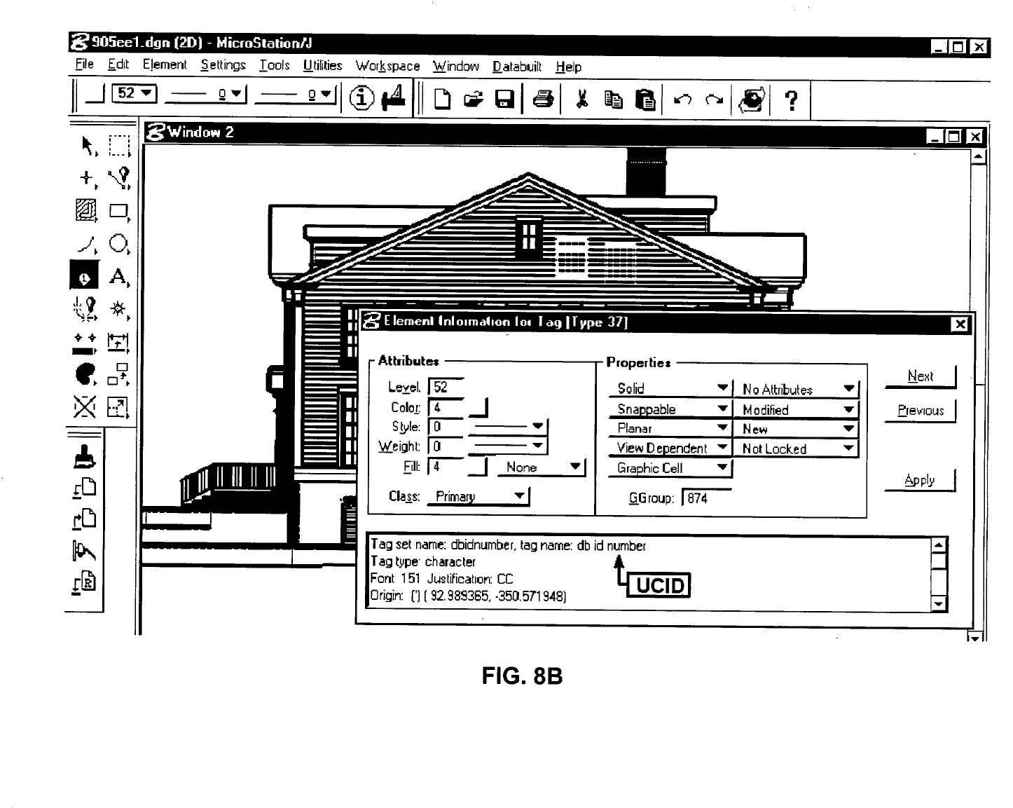

FIGS. 8A and 8B show a user interface screen that is displaying a DGN file created using Microstation in accordance with the present invention. The project shown in FIG. 8A is a residential home. One of the building components that the user has selected is a specific window. The user has highlighted the window and has requested to review the tags associated with the window. One of the tags has a name “db id number” and is used to store the UCID, preferably an encoded UCID. FIGS. 8A and 8B show the tag data for the highlighted window. The present invention thus uses the conventional tag to store a UCID which identifies the vendor and exact vendor product that the window represents.

IV. Drawing Files and Database Configurations

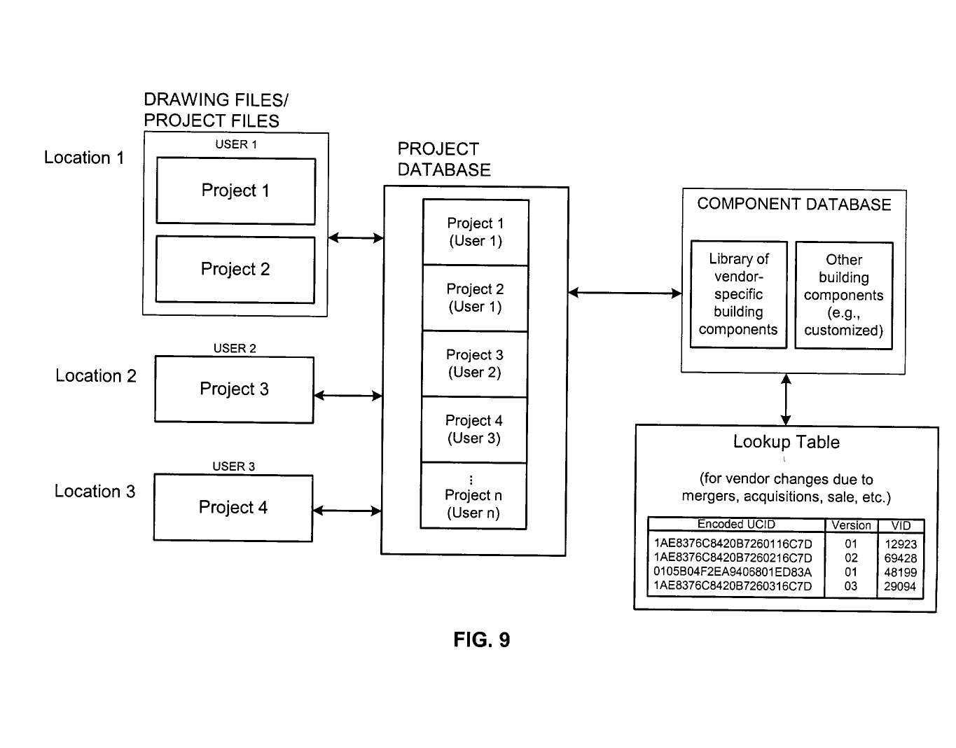

FIG. 9 shows one preferred embodiment of the present invention wherein the CAD application program and user's drawing files are at a first location, the project database is at a second location, and the component database is at a third location. Alternatively, the project database may also be co-located with the component database. In this configuration, a communication medium, such as a private network or public network (e.g., the Internet) allows the user to select components for the drawing file. The project database does not store the user's drawing files or the associated CAD application programs, and thus cannot recreate the user's drawings. The project database only has an inventory of the contents of each drawing file. Likewise, the application program at the location of the drawing files cannot independently generate the information stored at the project database, and summarized in FIG. 7A.

If a user disconnects from the project database, all that the user can do is open each tag and read out the UCID's in the tag data one by one. However, the user will not have access to the complete and updated data related to the UCID. Nor can the user take advantage of additional application programs that execute in conjunction with the project database and component database, as described in more detail below.

In the configuration of FIG. 9, a user may continue to edit the drawing file disconnected from the project database and component database. The user may edit and delete existing data elements, or add data elements that are obtained from locations other than the component database. If the user subsequently reconnects with the project database after making any changes, the project database entries must be synchronized with the user's current drawing file data elements. One synchronization process operates as follows:

1. Read each comment field in each data element of the drawing file. In the Microstation drawing file, this is accomplished by reading the data in the tag set.

2. Send each UCID to the project database.

3. At the project database, parse the comment field data to locate any UCID's.

4. Update the existing project database entries based on the newly received UCID data.

In an alternative embodiment of the present invention, the entries of the user's project database are redundantly stored at the first location. Additional configurations are within the scope of the present invention. For example, the comment field parsing process may be performed at the user's location in a program that executes in conjunction with the CAD application program.

V. Identification Numbers

As described above, the present invention uses four different types of identification numbers, namely a generic building component identification number (GCID), a vendor identification number (VID), a unique building component identification number (UCID) represented in an unencoded or encoded form, and an external object identifier (EOI).

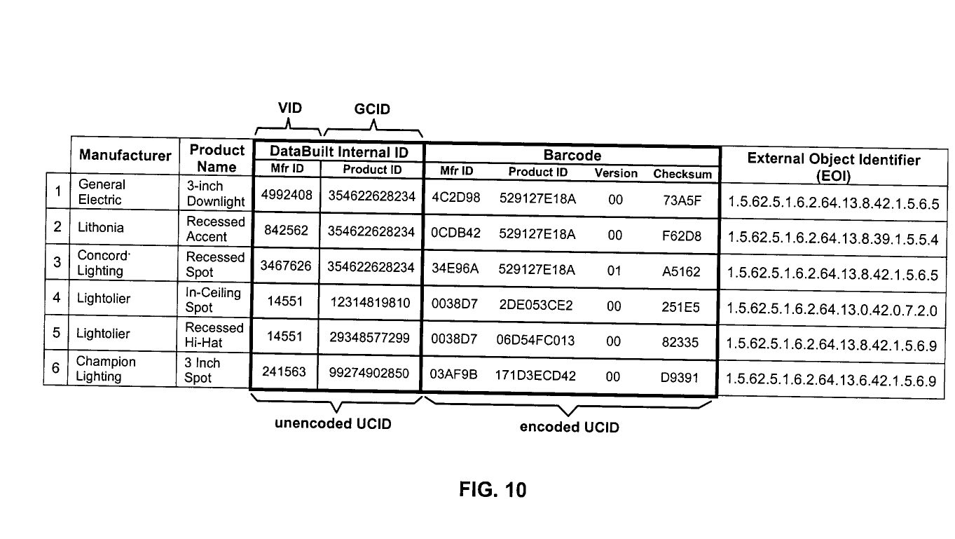

FIG. 10 shows an example of identification numbers that are assigned to various building components. As described above, the UCID (DataBuilt Internal ID) is comprised of the VID and the GCID, such as a concatenation of both. The UCID is shown as being separated into the two parts for illustration purposes only. In one embodiment of the present invention, the VID has a numeric range from 0 to 16,777,215 and the GCID has a numeric range from 0 to 1,099,511,627,775. When used together, the VID and the GCID make up a unique identifier for any building component being manufactured in the world.

The encoded UCID (bar code) is shown for illustration purposes only as being separated by spaces. It is comprised of the concatenation of zero-padded hexadecimal numeric equivalents of the VID, the GCID, a version number, and a checksum value. The VID uses a six hexadecimal digits, and the GCID uses ten hexadecimal digits. Two hexadecimal digits follow and provide a version number within the bar code, and the trailing five hexadecimal digits are used to store a mathematically calculated checksum that provides a level of data integrity checking with less than a single chance in one million of a random checksum matching an unencoded UCID. When producing a scannable bar code of the encoded UCID, one suitable bar code symbology is a Code39 format. However, the encoded UCID may be created in any suitable format and with any suitable checksum scheme.

Referring to FIG. 10, products 1, 2 and 3 are functionally equivalent products made by different vendors. Therefore, all three products share an identical GCID. However, since they have different vendors, each has a different UCID. Products 4 and 5 are made by the same vendor and thus have the same VID. However, since products 4 and 5 are functionally different products, they have different GCID's, and thus different UCID's.

The version digits of the encoded UCID are used to identify building components of vendors that have changed vendor due to a sale, merger, acquisition, or the like. An encoded UCID that has a “01 ” indicates that a sale, merger, acquisition, or the like has occurred. A special lookup table (shown in FIG. 9) is provided at the component database for mapping such encoded UCID's to the appropriate unencoded UCID's. In this manner, the unencoded UCID's can remain unchanged over their lifetime even if there is a vendor change as a result of a sale, merger, acquisition, or the like. Most building components will be encoded with a “00” indicating that no sale, merger, acquisition, or the like has occurred. The unencoded UCID of an encoded UCID having version digits of “00” may be obtained by a simple decoding process (i.e., a reversal of the encoding process).

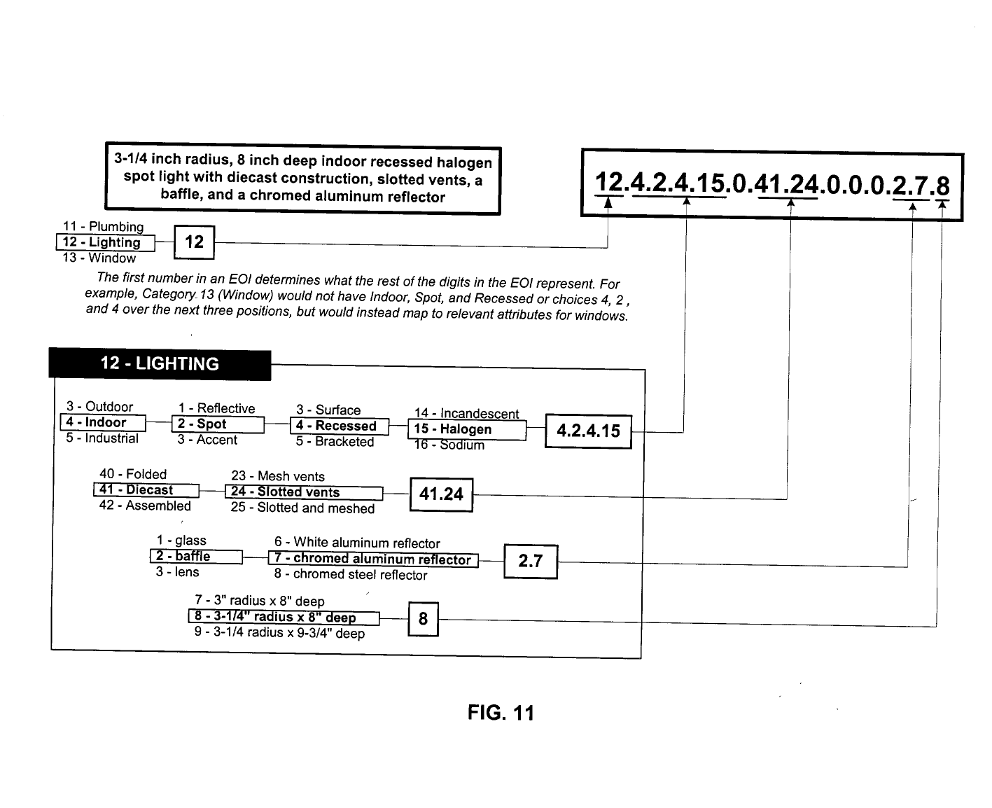

FIG. 11 shows a simplified example of an encoding scheme for a characteristic-based EOI for one category of building component, namely windows. In an actual example, there would be significantly more characteristics, and thus the EOI would be much longer. If a specific building component does not include a characteristic that is part of the encoding scheme for that building component category, then a “0” is placed in that digit. Otherwise, the building component is assigned the appropriate digit. If the characteristic has many values, such as color, then the characteristic is given a multi-digit number.

Referring again to FIG. 10, building components 1, 2 and 3 are functionally equivalent building components made by different vendors. Therefore, all three building components share an identical GCID. However, building components 1 and 2 have three differing characteristics, and thus have close, but not identical EOI's. Depending upon the user's needs, it may be possible to substitute these building components for one another. If the user had to rely solely upon the GCID to find substitutable building components, this potential match would not be located. Building components 1 and 3 are identical (based upon the characteristics that make up the EOI), and thus have the same GCID, as well as the same EOI.

Preferably, there is an encoding scheme for each building component category. In this manner, the number of digits that do not have meaning for a particular building component can be kept to a minimum, and thus the total number of digits of the EOI can be kept to a reasonable length.

In one embodiment of the present invention, the details of the encoding process is maintained as a trade secret. That is, building components are assigned EOI's in exactly the manner described above, but neither the characteristics (attributes) or the assignment of values to a particular building component are visible to the user. Nonetheless, the user may employ a search engine to take advantage of the EOI process to search for comparable, equivalent, or substitutable building components.

One scheme operates as follows:

1. The user enters an encoded UCID of a building component into a search engine. The UCID may be obtained from product information, a bar code on the building component, or from other public sources.

2. The search engine consults a cross-index table that contains the data shown in FIG. 10, and obtains the EOI for the encoded UCID. This step is hidden from the user's view.

3. The EOI is automatically plugged into the search engine, and building components with similar EOI's are located. Best match algorithms are used. Furthermore, details of the encoding process may be used to improve the matching process. For example, the encoding process may order the digit positions from most important characteristic to least important characteristic from the standpoint of a user's typical concerns when matching products from different vendors. Thus, if two building components were located that have only one different digit, the building component that differs in the lower position digit may be selected as the better match. A similar encoding process may be used for selecting the digits within each position (e.g., if the EOI of the entered UCID has a “5” in the eighth digit position, a “4” in the eighth position of another EOI may be a better match than a “7” in the eighth position of another EOI). This step is hidden from the user's view.

4. The encoded UCID of the best matches are located. This step is hidden from the user's view.

5. The encoded UCID's are displayed to the user, and all available details of the building components associated with the encoded UCID's are displayed.

VI. Selection of Building Components

Users select building components from a library in the conventional manner. For example, if a user is adding a window to a CAD drawing file, the user views a display of windows and selects a desired window. Drag-and-drop selection may be used in the conventional manner. In the present invention, the library of building components (shown in FIG. 9) are tagged with UCID's so that the user is selecting a window associated with a specific vendor, as opposed to a generic window.

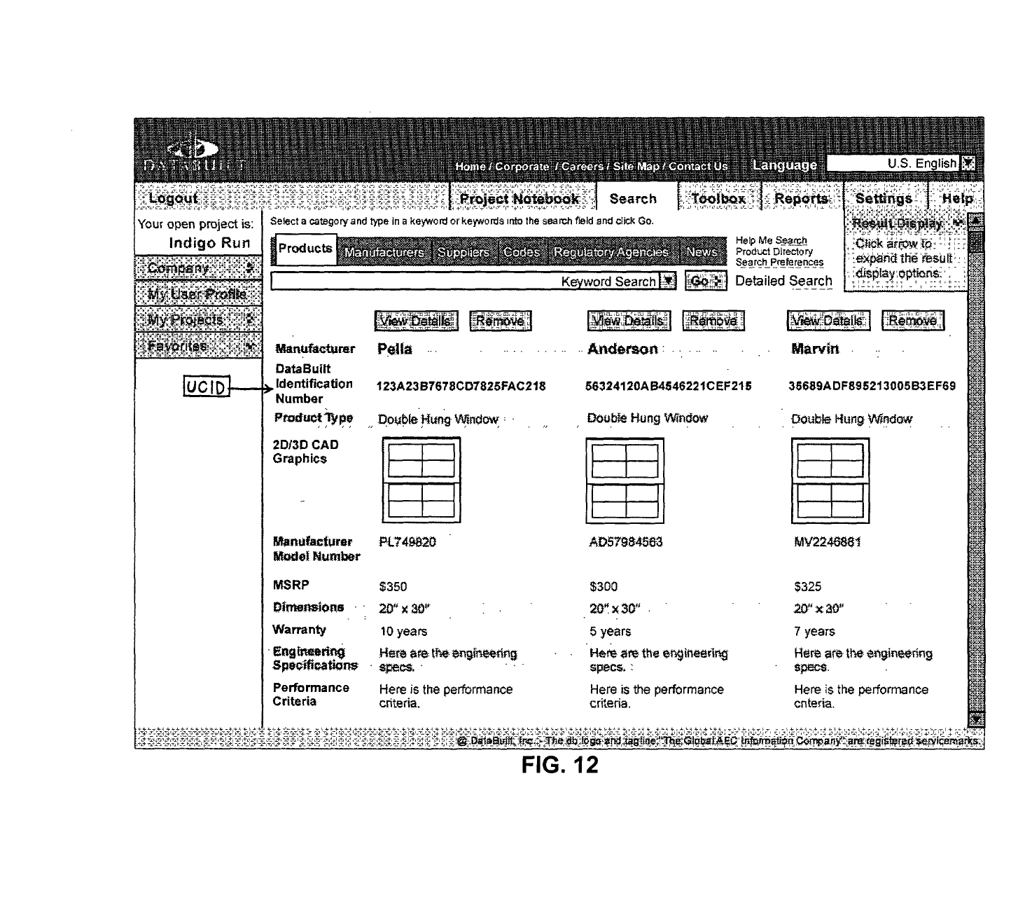

FIG. 12 shows an example of a user interface screen for selecting a double-hung window from the library. Additional details about each window may be obtained by selecting “View Details” next to the window.

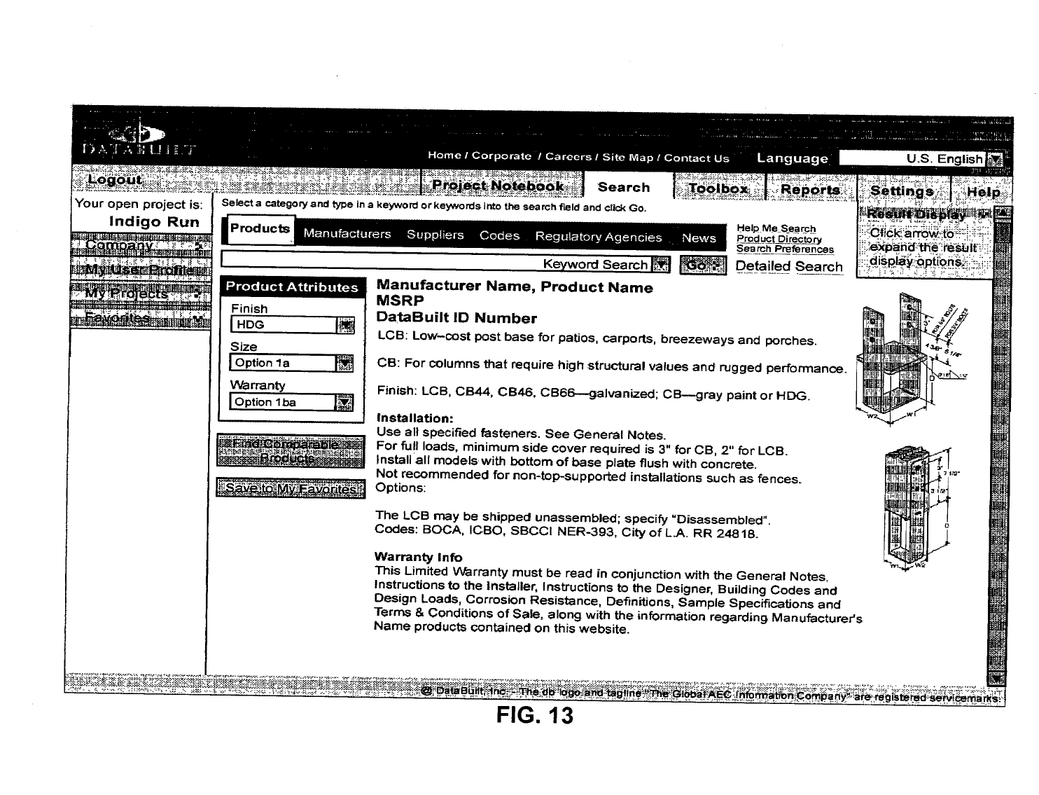

FIG. 13 shows an example of the full details that the user can view for a specific building component. This information is typically provided by the vendor in either paper or electronic form, but is reformatted for the component database so as to be in a standardized electronic format for all vendor building components.

VII. Regulatory Code Compliance Testing

Regulatory codes are typically densely worded documents. However, they define testable rules, with pass or fail results. That is, for a building component to be compliant with the regulatory codes applicable within a particular jurisdiction, the building component must meet all of the specific standards defined in applicable regulations, while avoiding any explicitly forbidden attributes or states defined by the regulations.

For example, the following text is a section from the regulatory standards of an international building code agency:

Polished wire glass installed in fire doors, fire windows, and view panels in fire-resistant walls shall comply with ANSI Z97.1

This compliance requirement (like any regulation) can be broken down into two primary elements, those being a TARGET to which the requirement applies, and a TEST that should be applied to the target to ensure compliance. The TARGET and the TEST are both comprised of RULES. Taken together, the TARGET and the TEST are called a RULESET.

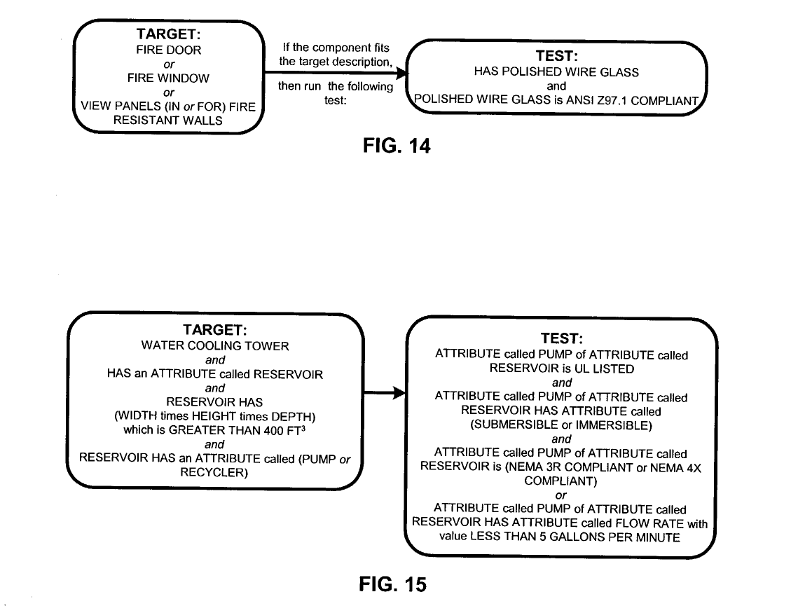

FIG. 14 shows a ruleset for defining the above-described regulatory code. In this case, the TEST would be run if the building component being examined is classified as a FIRE DOOR, a FIRE WINDOW, or a VIEW PANEL in or for FIRE RESISTANT WALLS. The regulatory code compliance testing process attempts to substantiate all assertions (using standard database and programmatic techniques) in the TEST. In this example, the system tests both that the building component HAS an attribute of the type POLISHED WIRE GLASS, and that the POLISHED WIRE GLASS has an attribute marking it as ANSI Z97.1 COMPLIANT. If both of these assertions are found to be true, the TEST returns a TRUE status code. If the TEST fails, then a FALSE status code is returned by the testing engine.

All tests are written to provide a positive outcome if the TARGET is compliant with the regulatory code being checked by the TEST. This means that if a regulatory code forbids a component from having some state or attribute, then the TEST must be to see if the component does NOT have that state or attribute. Successfully passing such a TEST means that the item has not been found to be in breach of the regulation.

TARGETS and TESTS can be simple match cases, such as in the above-described case, or they can be more complex, checking for many specifics on both the target and rule levels.

FIG. 15 shows a more complex ruleset. By combining multiple TARGET and TEST specifications within one ruleset, regulatory code compliance checks become meticulously precise in the levels of detail that they support.

An additional feature of the Regulatory Code Compliance Testing System is the ability to include recursive “macros”, which are symbolic references to larger groups of tests. This means that a TEST might include a commonly used test as a subordinate.

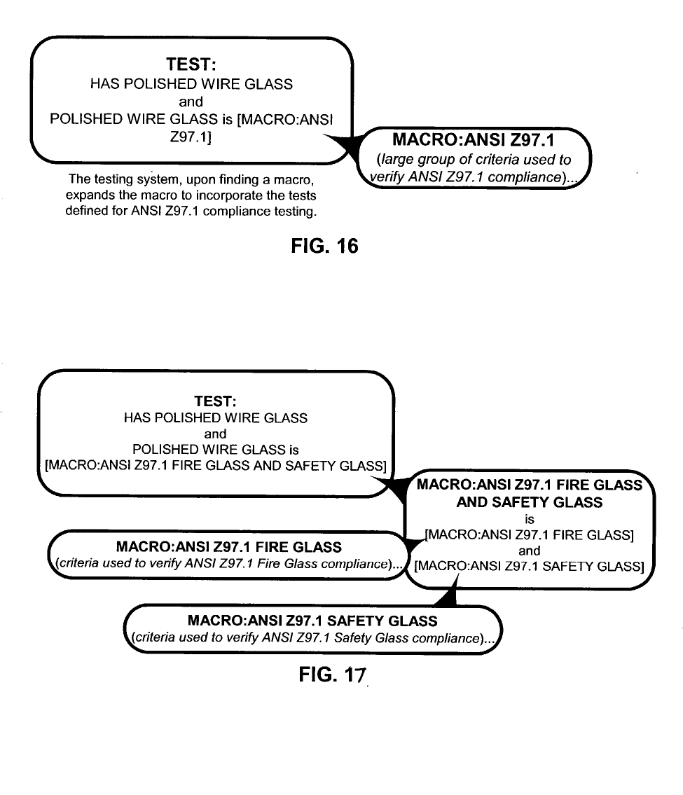

FIG. 16 shows an example of this process which is an expansion of the TEST shown in FIG. 14. Through the inclusion of such macros, needless repetition is avoided in the TEST sections of rulesets. There is the frequent case where only a portion of a compliance standard or common test is relevant for the item in question. In such a case, the standards or common tests may be entered as several sections of tests, divided logically by the targets they would apply to. A recursion macro can be used to incorporate several such items into a more complex test, if necessary. For example, if tests exist for safety glass and fire-safe glass within the ANSI Z97.1 standard, a macro may be used which references both the safety glass and the fire glass code sections.

FIG. 17 shows an example of the flow of such a TEST section. Through standard programming integrity practices, infinite recursion loops are avoided in macro expansion (that is, a macro cannot reference another macro that, directly or indirectly, incorporates the first macro).

Certain building components also must meet specific engineering standards. Underwriters Laboratories (UL) is one well known standard. If a building component has passed such an engineering standard, then an appropriate certification will be provided. If such a certification is a relevant marketing point, then the vendor typically includes the certification in their product description materials. The engineering certification thus becomes part of the component database. To test whether a building component complies with a specific engineering standard, a simple query is entered for the name of the certification and the attributes of the building components in the project database are searched to test for the presence of the engineering certification.

FIGS. 4A-4D show some regulatory code data which is extracted from vendor information. See, for example, the UL Flammability Class (FIG. 4B), the Certifications field showing that the filters are ISO-9002 certified (FIG. 4C). FIG. 5 shows that Product Test data is part of the ERD. The product test data include the type of tests and the test results. FIG. 6 also shows that Product Code Compliance is part of the ERD. The attributes and data in the product analysis data spreadsheets of FIGS. 4A-4D and the ERD's ultimately become coded into the component database which may then be used to test building components that are in a specific project for code compliance.

VIII. Regulatory Compliance of Projects

An important feature of the present invention is that regulatory compliance of a project can be performed quickly and accurately. The tools described above may be used in any of the following ways:

1. Project creation—All projects are tagged with geographic and zoning identifiers which, together, define a set of rules that must be met by all building components used in the project. The building components in the component database are tested against these rules in a rule engine, and a subset of selectable building components is defined. As the user builds the project, only compliant building components may be selected (e.g., dragged-and-dropped into a drawing file). Non-compliant building components are thus hid from the user's view. Alternatively, non-compliant building components are allowed to be selected, but the user is provided with a warning to that effect.

2. Project compliance checking—A project that was previously created without regard to regulatory compliance can be instantly tested for regulatory compliance. The building components in the project database are tested against the rules in the same manner as described above. If no project database exists, but the drawing file used building components tagged with UCID's, then the drawing file may be read to extract the UCID's.

3. Project copying—A project that was created using UCID-tagged building components is copied to another building location. This process is initiated via the user interface screens shown in FIGS. 7G and 7H. Since the new project has a new building location, it may be subject to different regulations, especially, different building codes. The building component testing process described immediately above for project compliance checking is conducted using the new geographic identifier. Any building components that are not compliant in the new geographic location are immediately identified.

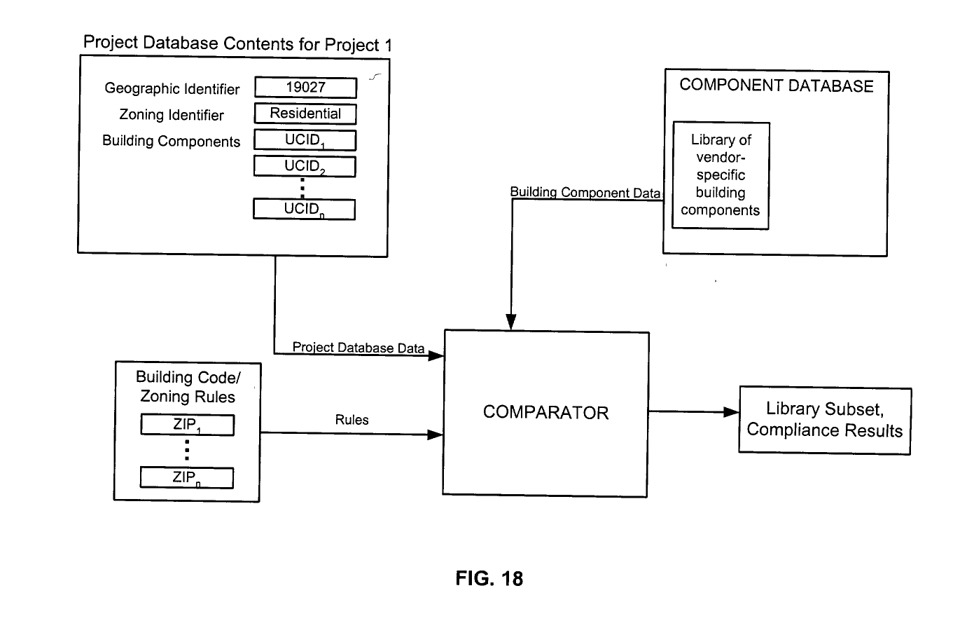

FIG. 18 shows a schematic block diagram of the process described above. For simplicity, a zip code of the project is used as the geographic identifier. In practice, building code jurisdictions do not fall neatly within zip code boundaries.

IX. Vendor Substitution

The present invention provides a rapid technique to identify building components from a specified vendor in a design file or drawing file. In one preferred embodiment of the present invention, the project database contains encoded UCID's. The encoded UCID's are either decoded or cross-indexed against the unencoded UCID's. The unencoded UCID's may then be parsed for vendor data, as shown in FIG. 10. If it is desired to change vendors, then the GCID or EOI may be used to select either an identical, or comparable, equivalent, or substitutable building components for those identified in the project database. Again, the details of the VID, GCID and EOI are preferably hidden from the user. The user only has knowledge of the encoded UCID and the particular search fields that are presented to the user via a user interface.

X. Material Costing

Since the project database contains a list of vendor-specific building components, accurate material costing may be performed based on the MSRP of the building components. FIG. 7A shows a Total Product Cost view for a particular user's project based on the selected building components. Such information is extremely useful for insurance companies, insurance assessors, and the like, in valuing the component costs of a project.

XI. Non-Cad Document Systems

The examples provided in the accompanying figures primarily illustrate how the present invention operates in a CAD environment. However, the scope of the present invention includes non-CAD environments as well. For example, building component elements may be selected and placed into non-CAD documents, such as word processing documents (e.g., Microsoft Word files) and spreadsheets. Regardless of where the building component element is placed, the project database still records the selection and places an entry in the project database. As long as the UCID is preserved in the building component data element, all of the same functions can be performed on non-CAD documents that are described above with respect to CAD-based drawing files.

XII. Marketing

By maintaining a single, large database of vendor-specific building components, contents of the project database has significant value to vendors, project managers and other AEC industry players. For example, vendors can learn exactly where their building components are being used. Recall and safety updates can be handled efficiently. Warranty, installation and maintenance instructions for building components are instantly available. Replacement parts may be readily identified.

Detailed Disclosure—Embodiment 2

I. Background Information for Embodiment 2

Another embodiment of the present invention is described below. Most of the features in the second embodiment are similar or complementary to the first embodiment. The nomenclature of the second embodiment differs slightly from the nomenclature of the first embodiment. Most of the differences are self-explanatory. Some of the differences are as follows:

Databuilt Unique Primary ID (PID) is equivalent to the UCID in the first embodiment.

Company Primary Identifier is equivalent to the VID in the first embodiment.

One structural difference between the first and second embodiment is that in the second embodiment, a Java applet creates the graphic representation of a building component from parametric data of the building component, whereas in the first embodiment, a conventional rendering process is used to create the graphic representation of a building component.

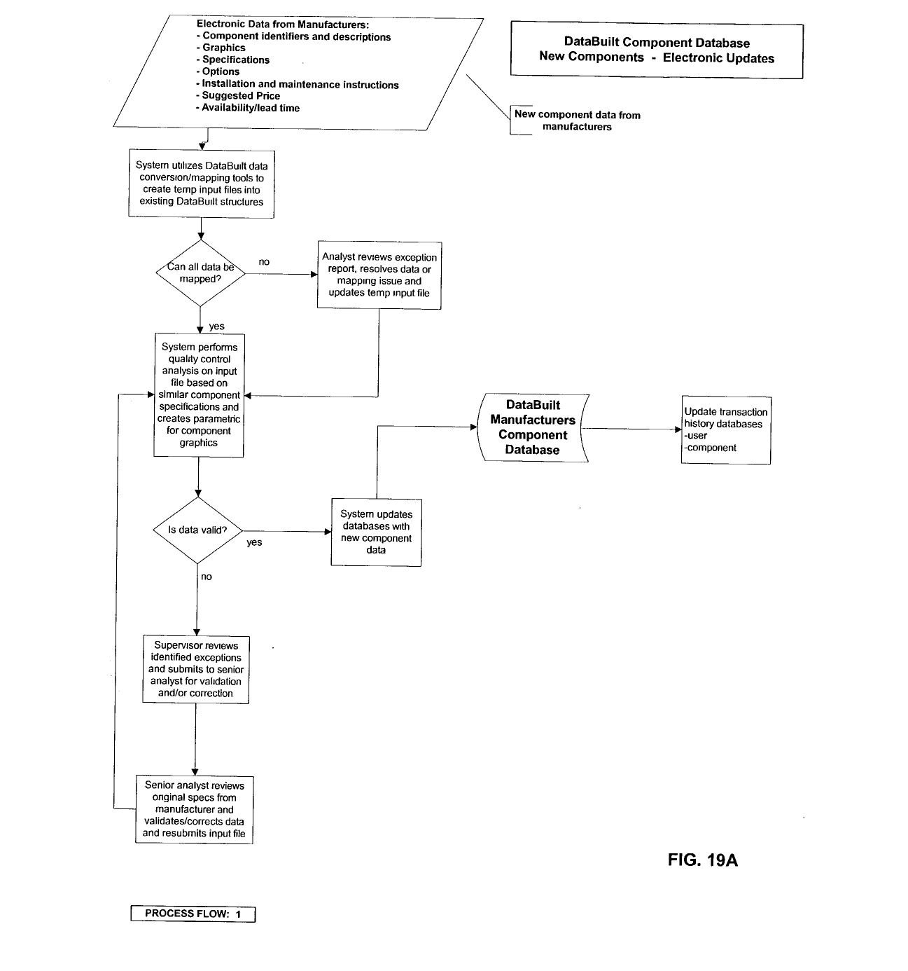

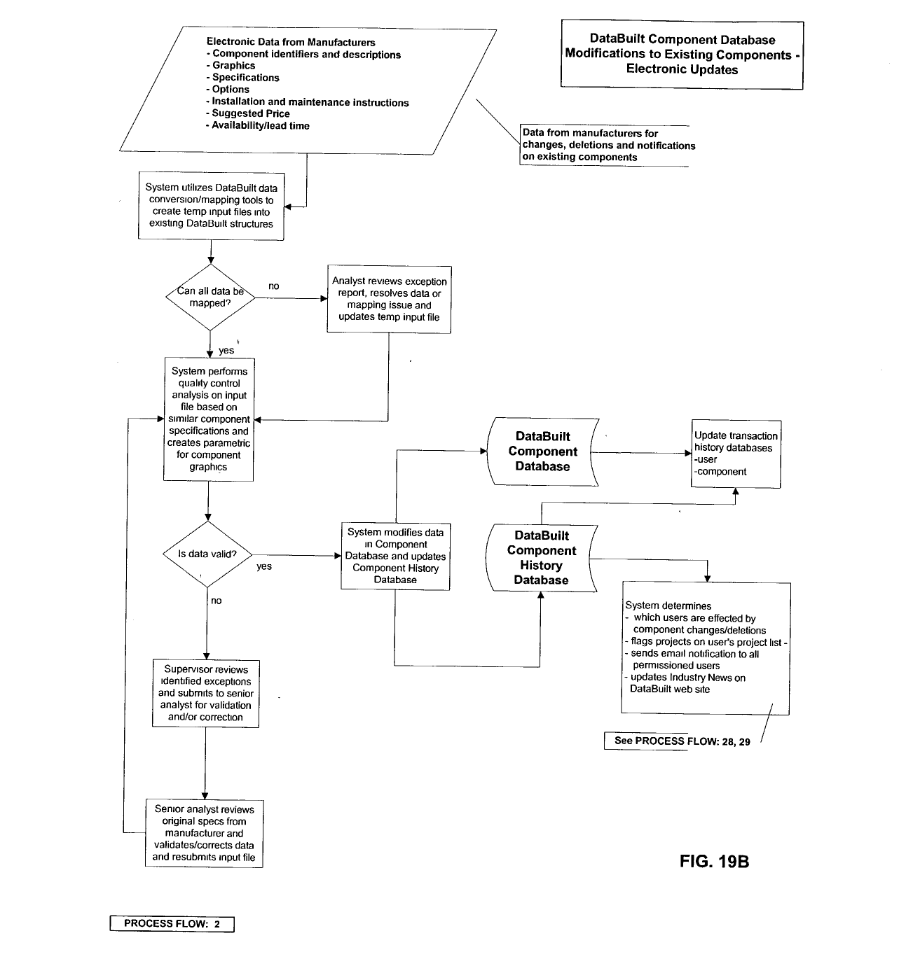

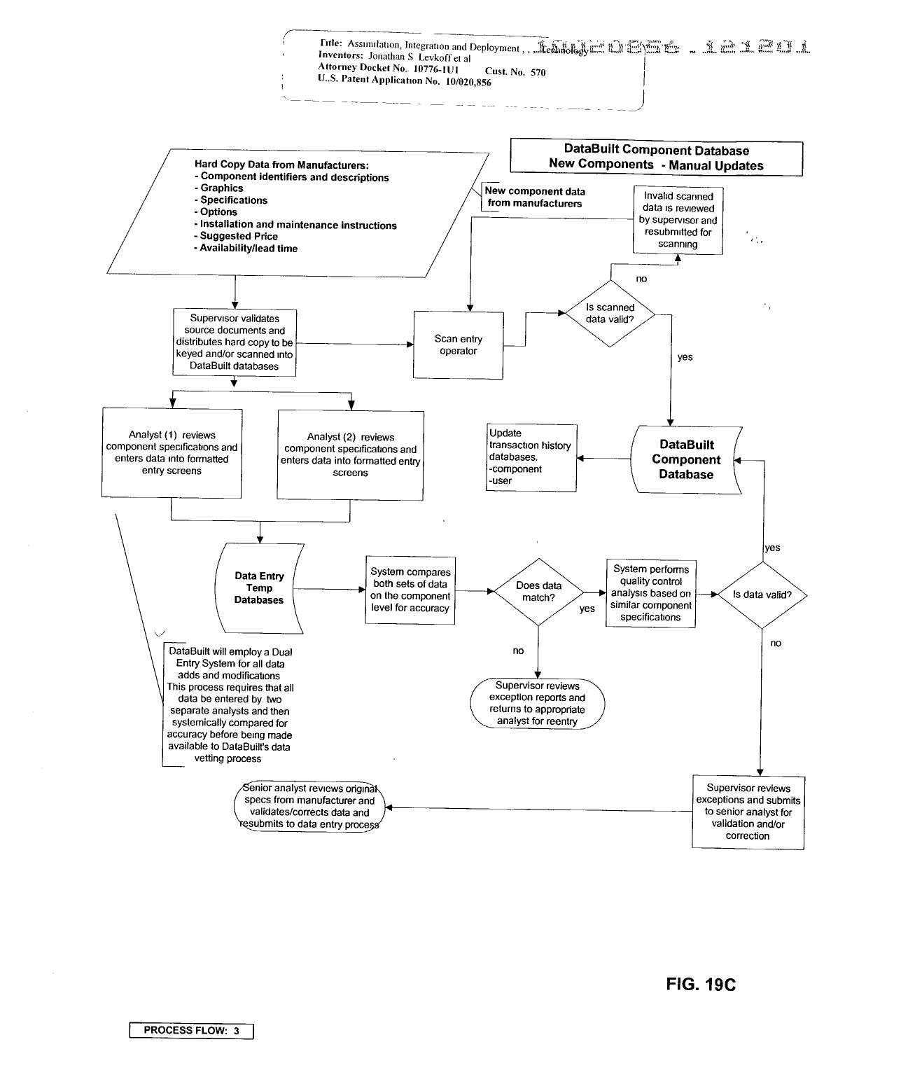

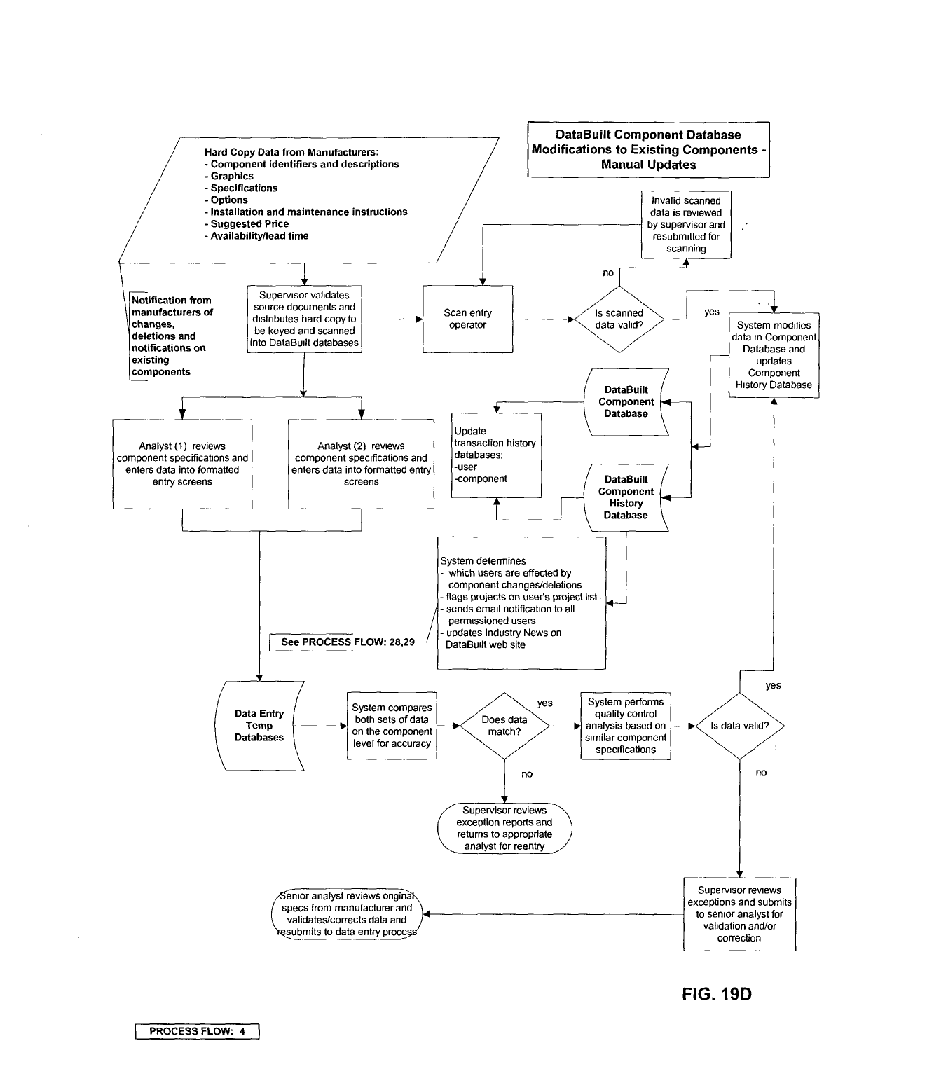

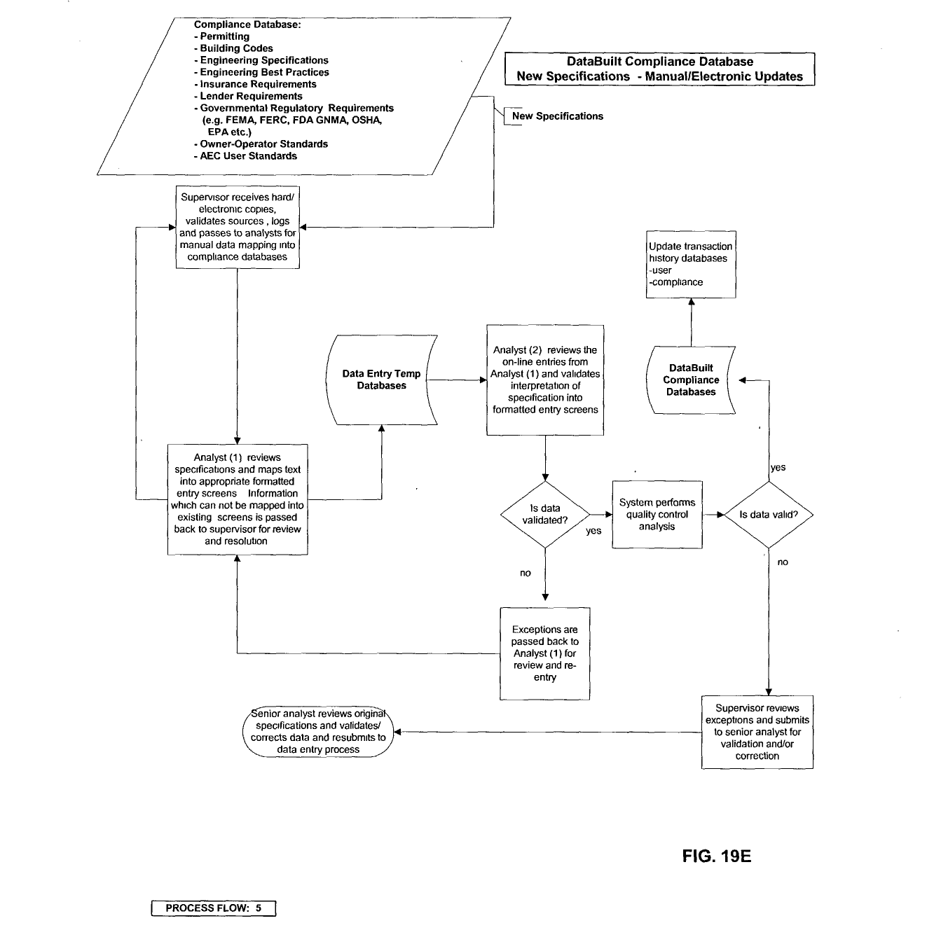

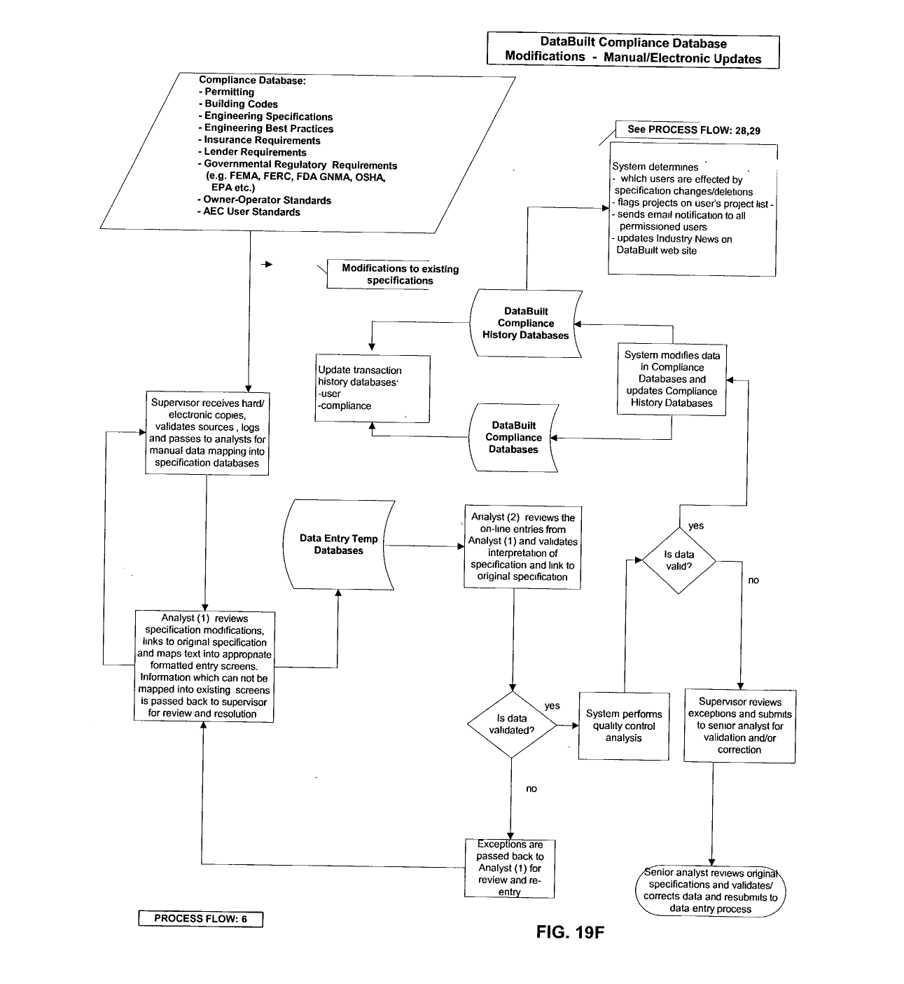

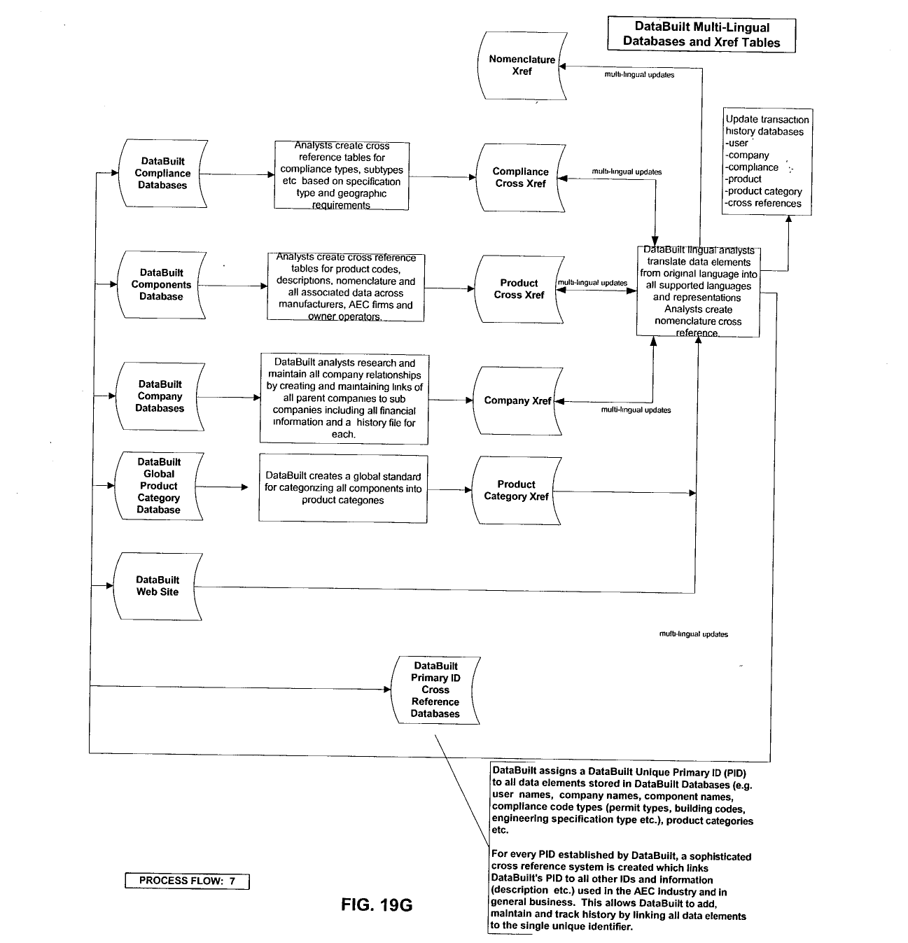

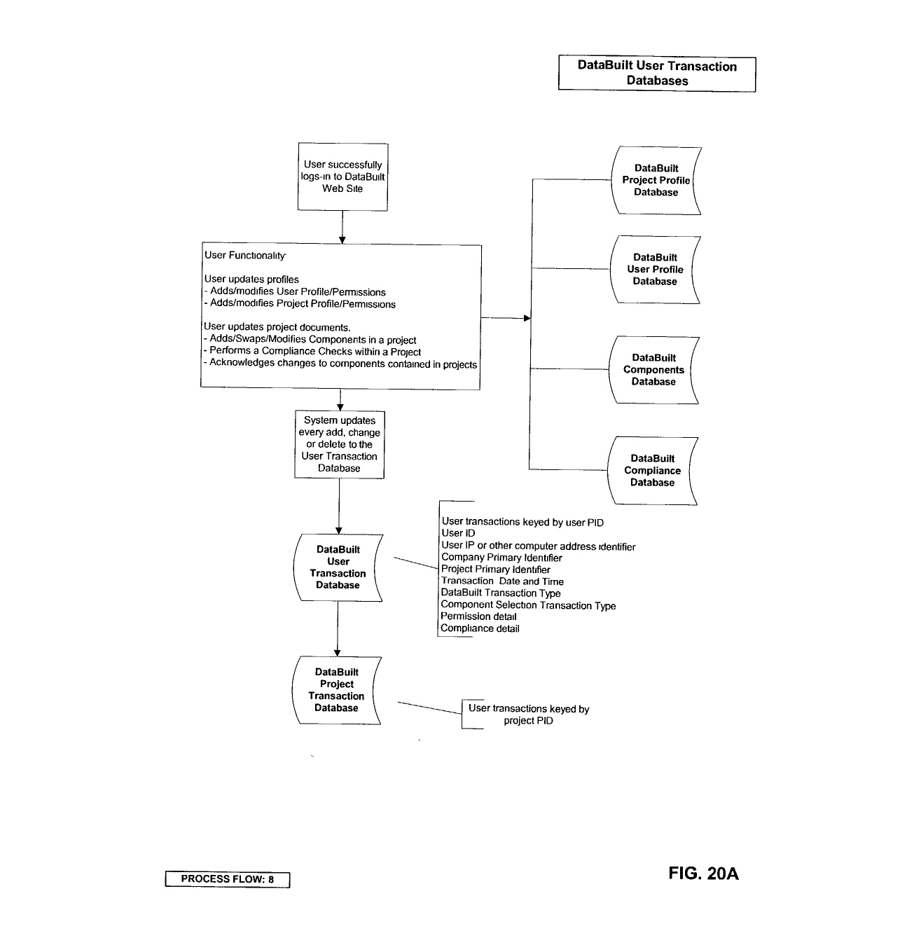

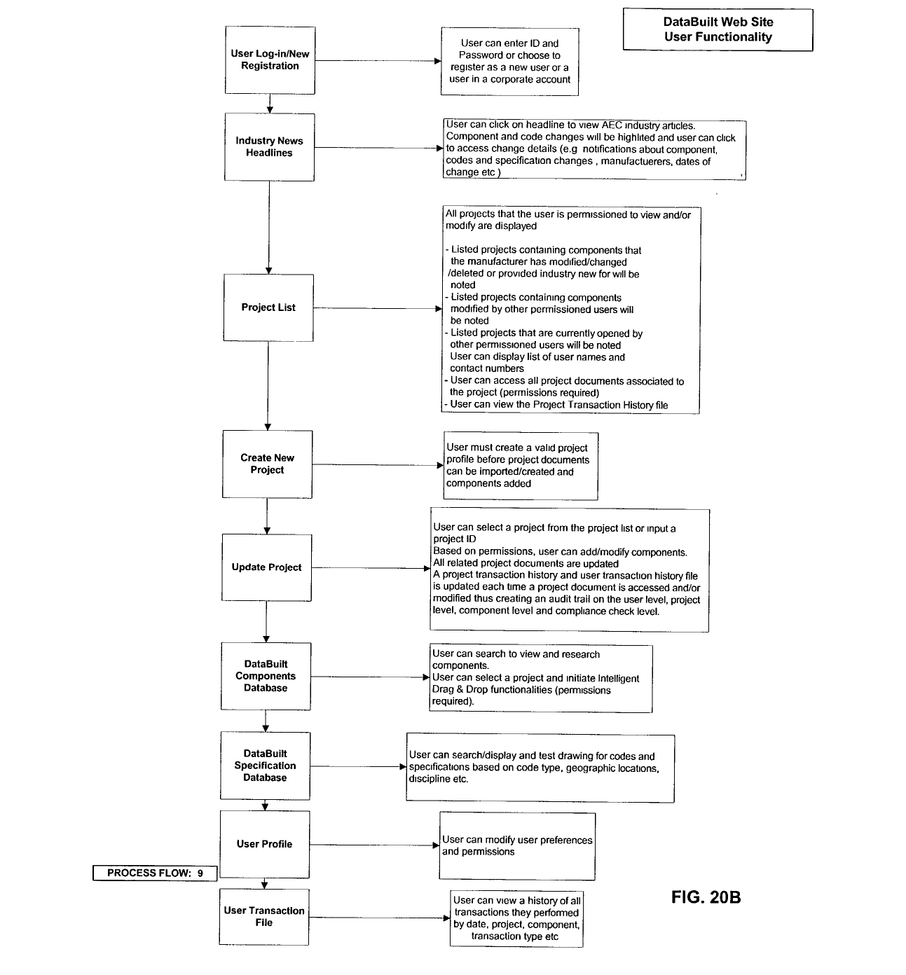

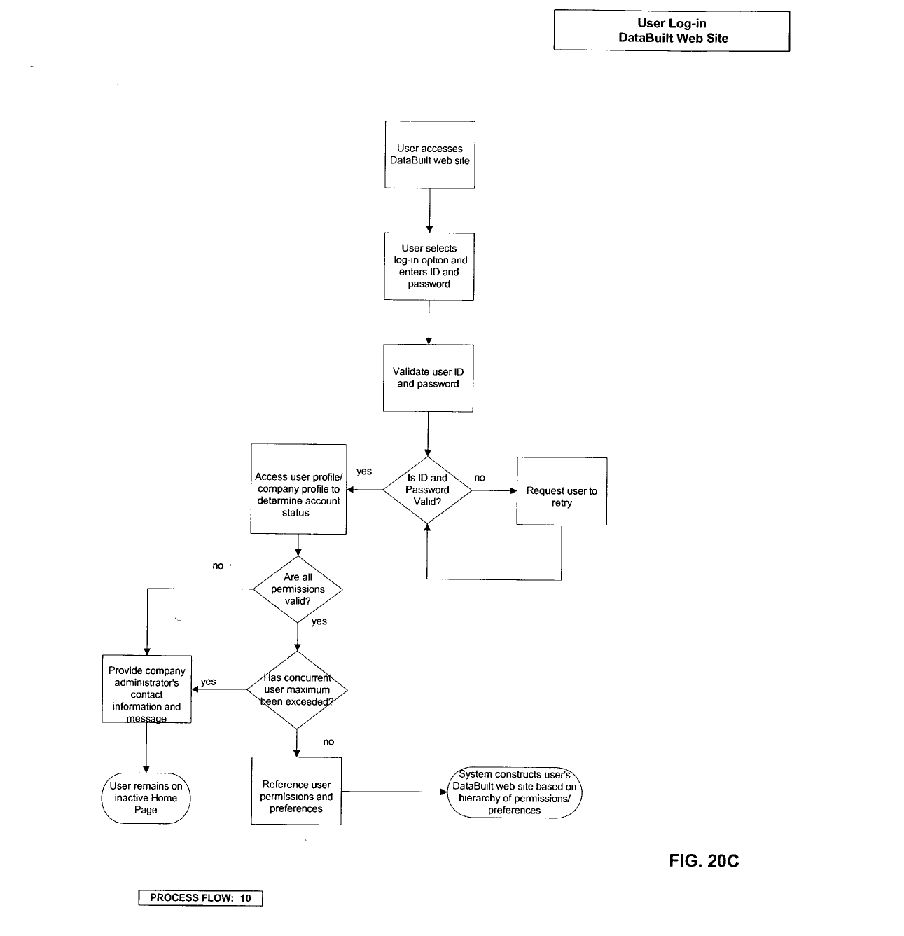

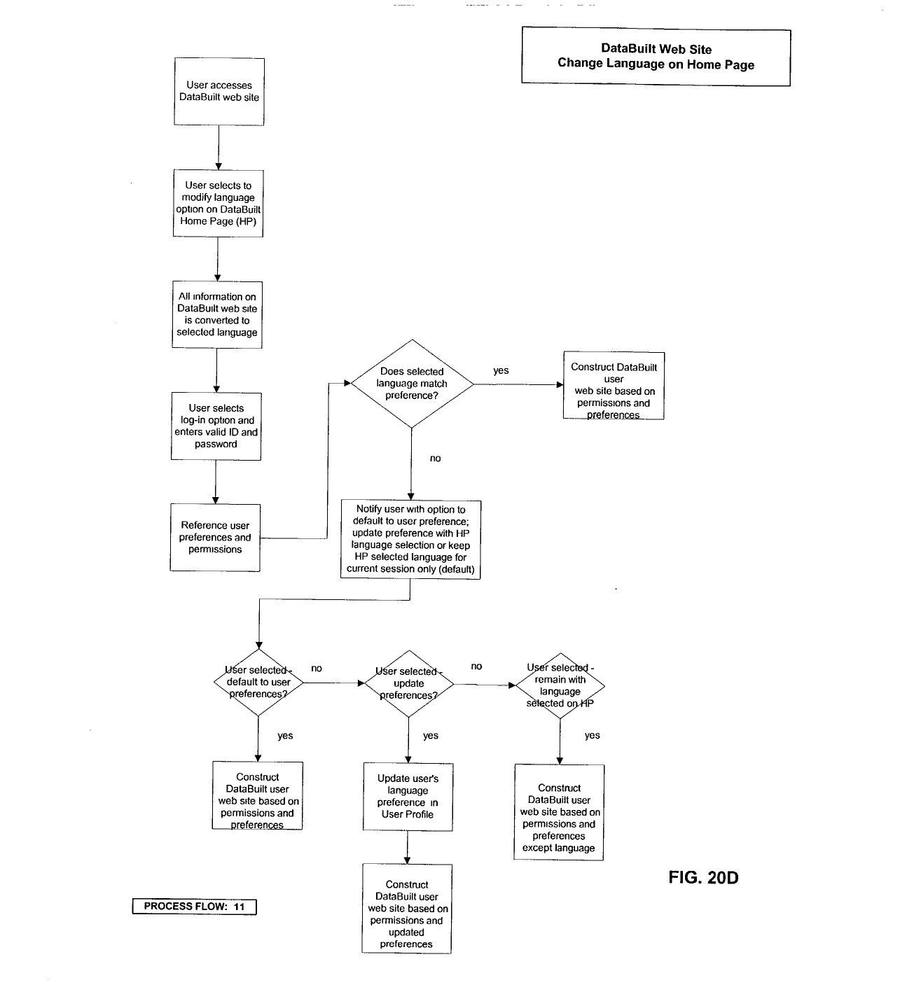

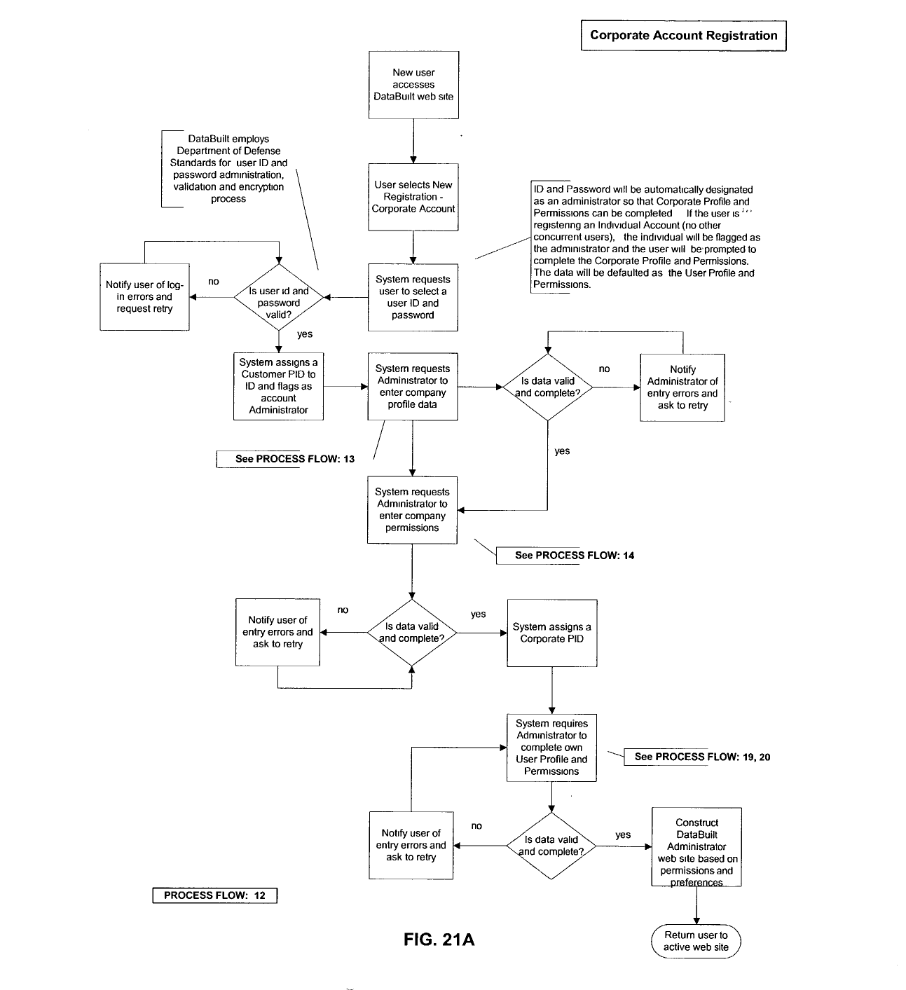

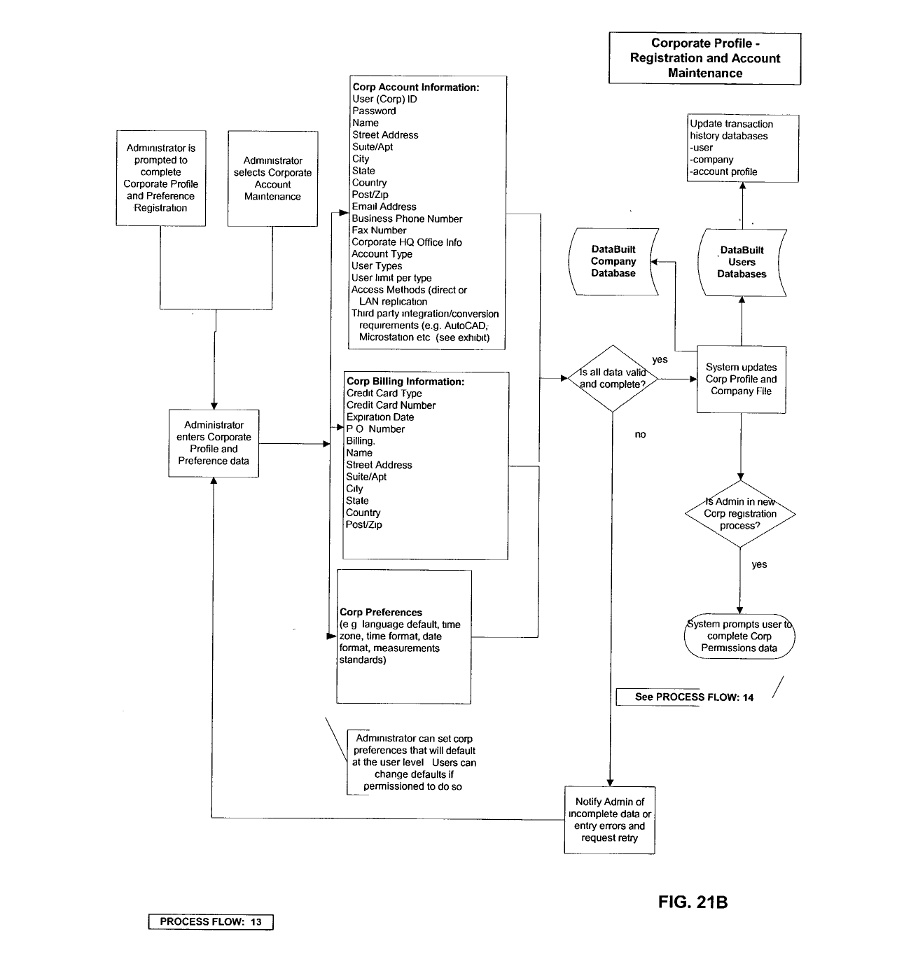

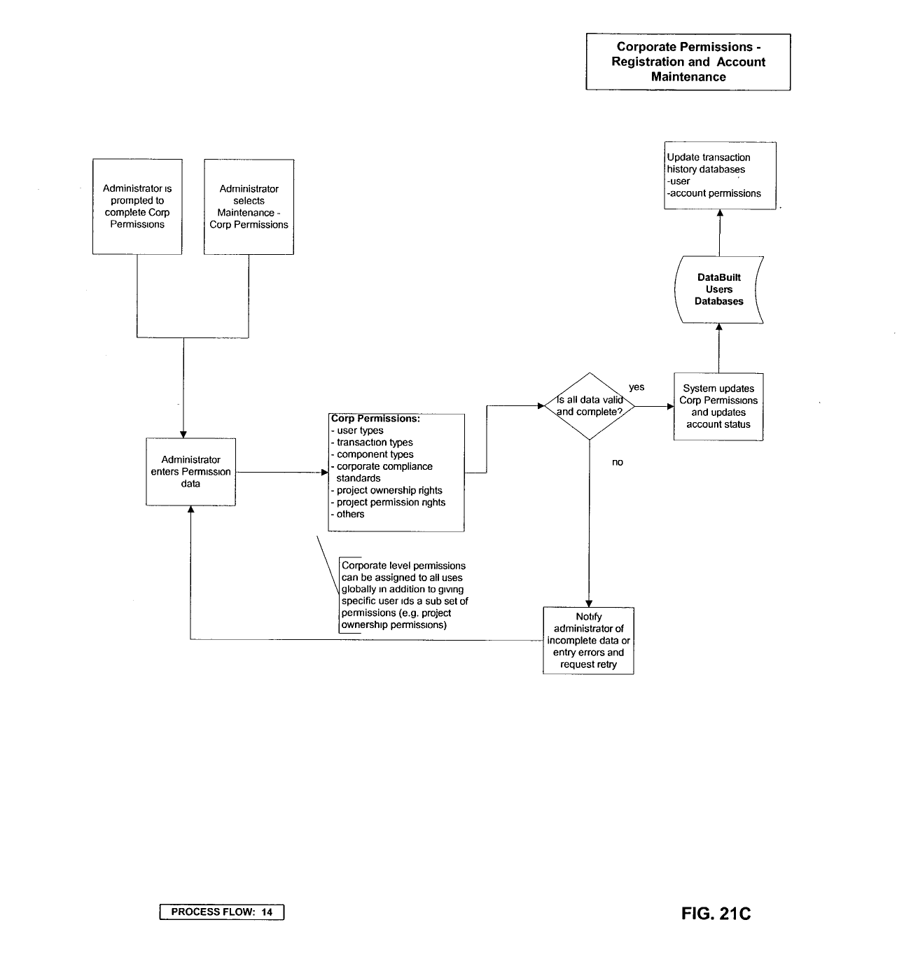

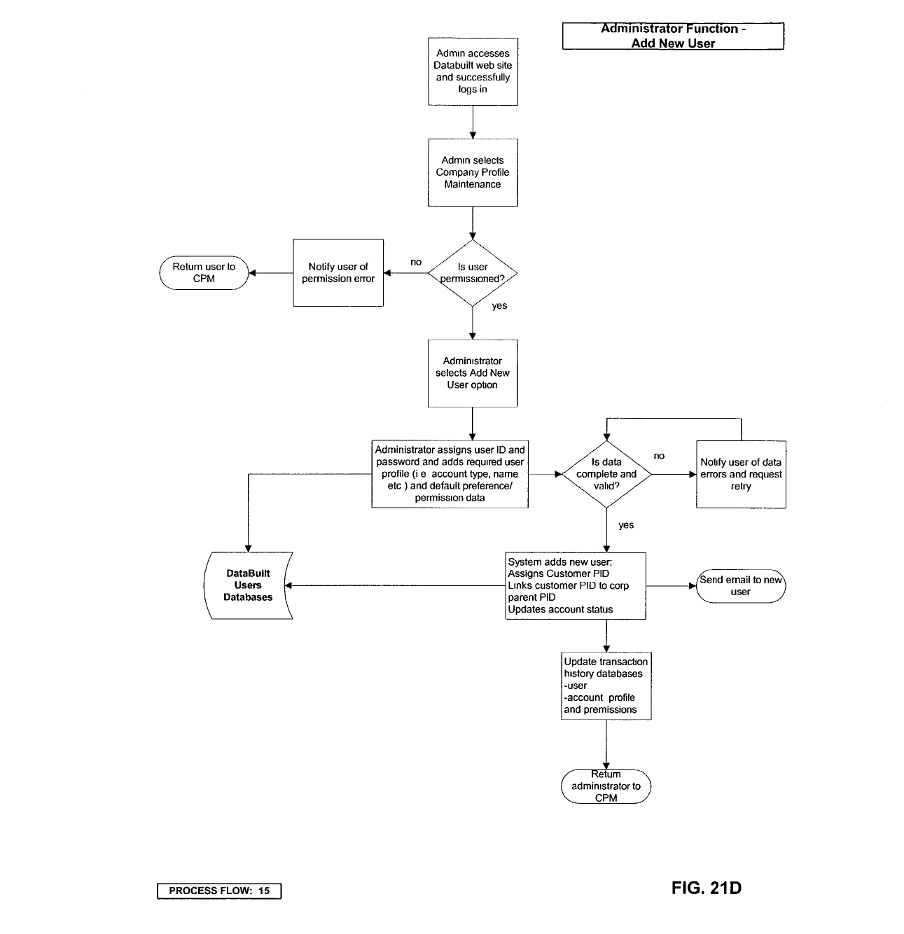

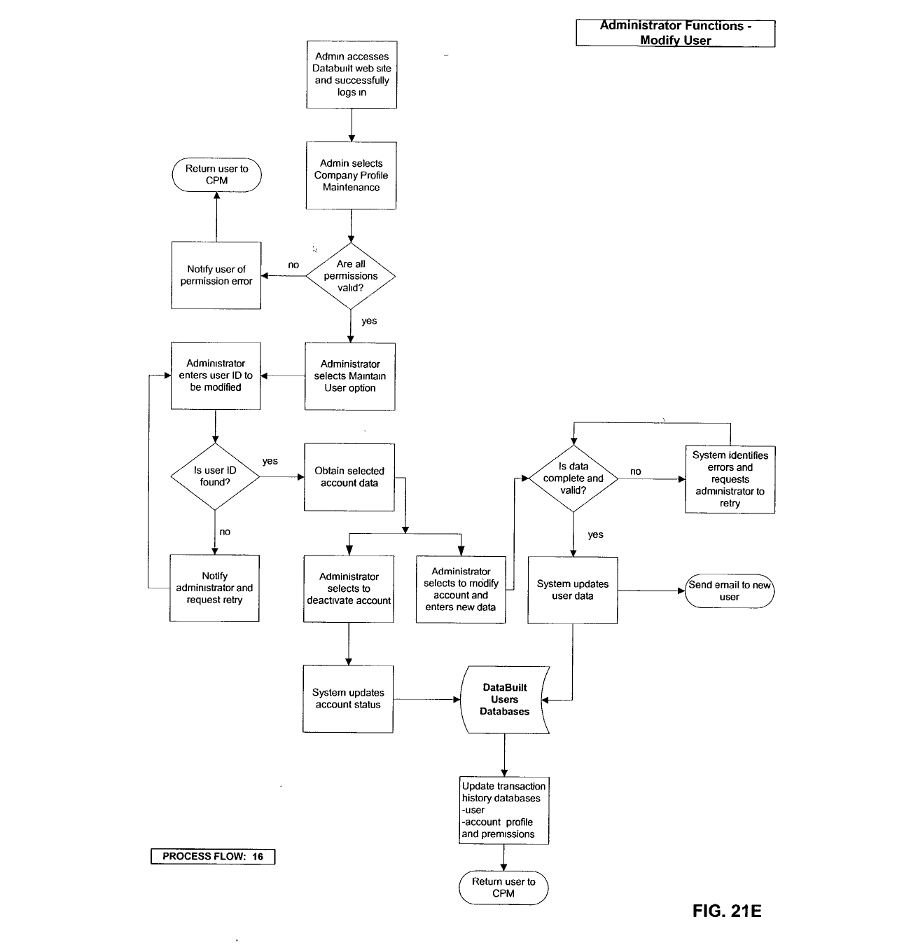

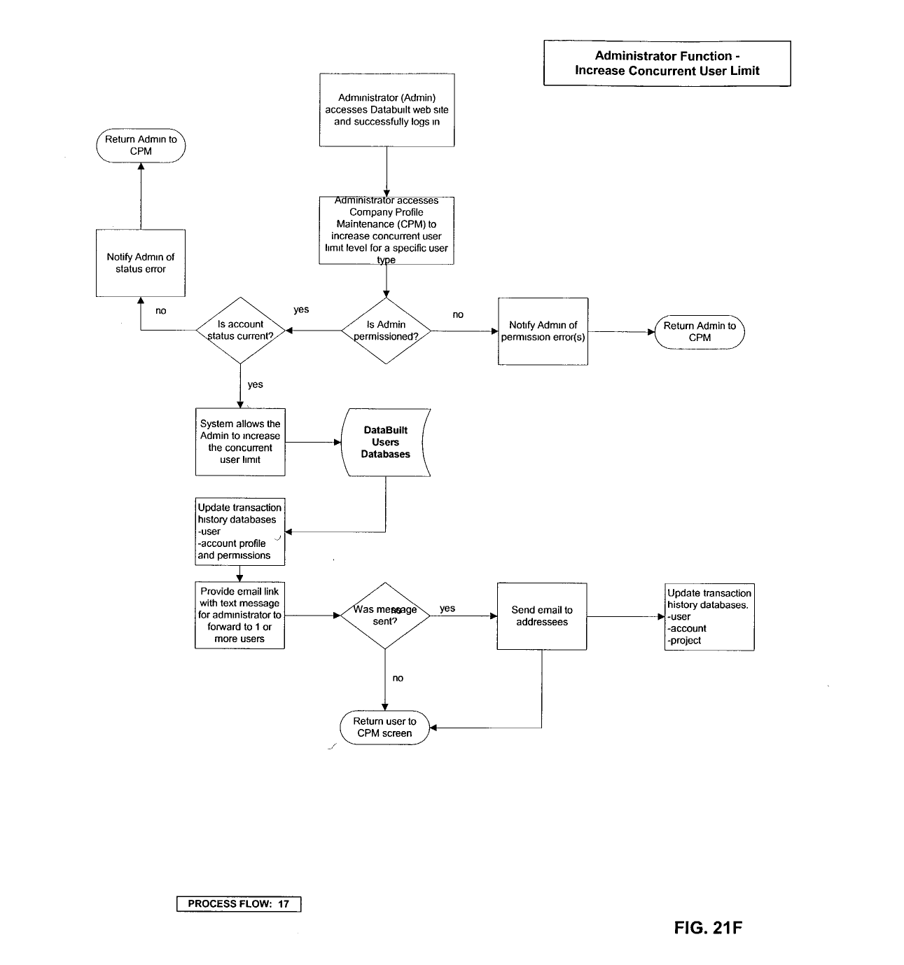

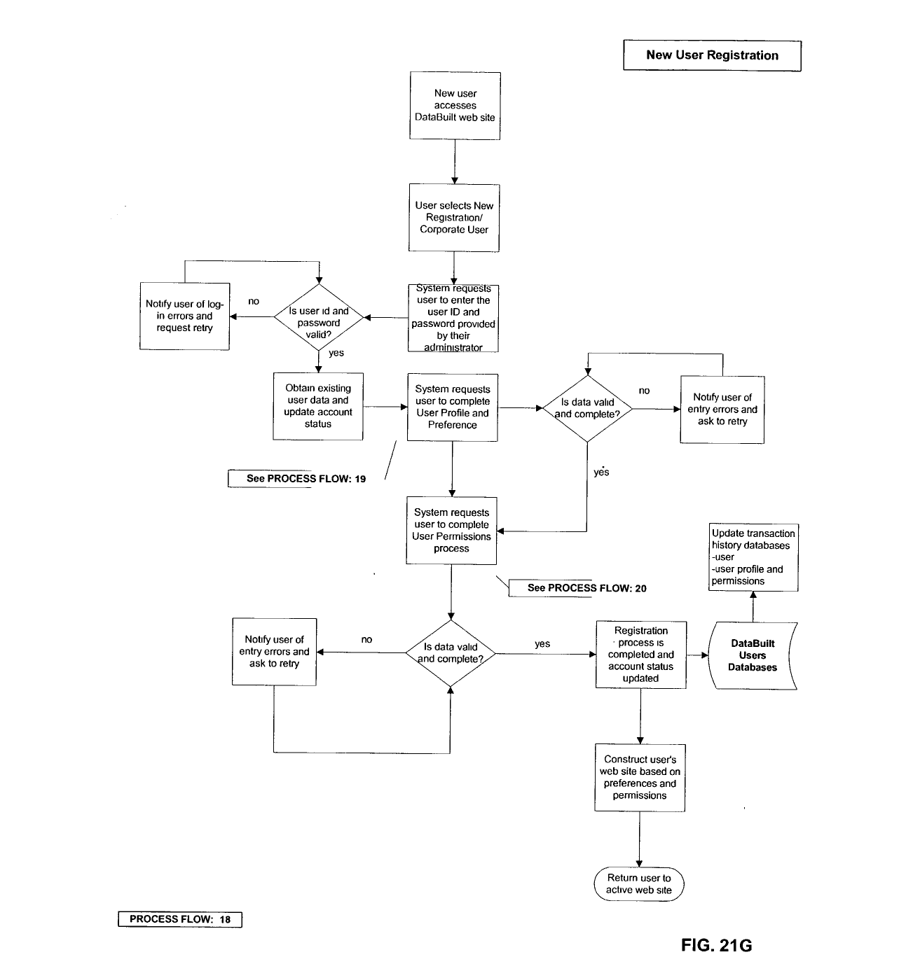

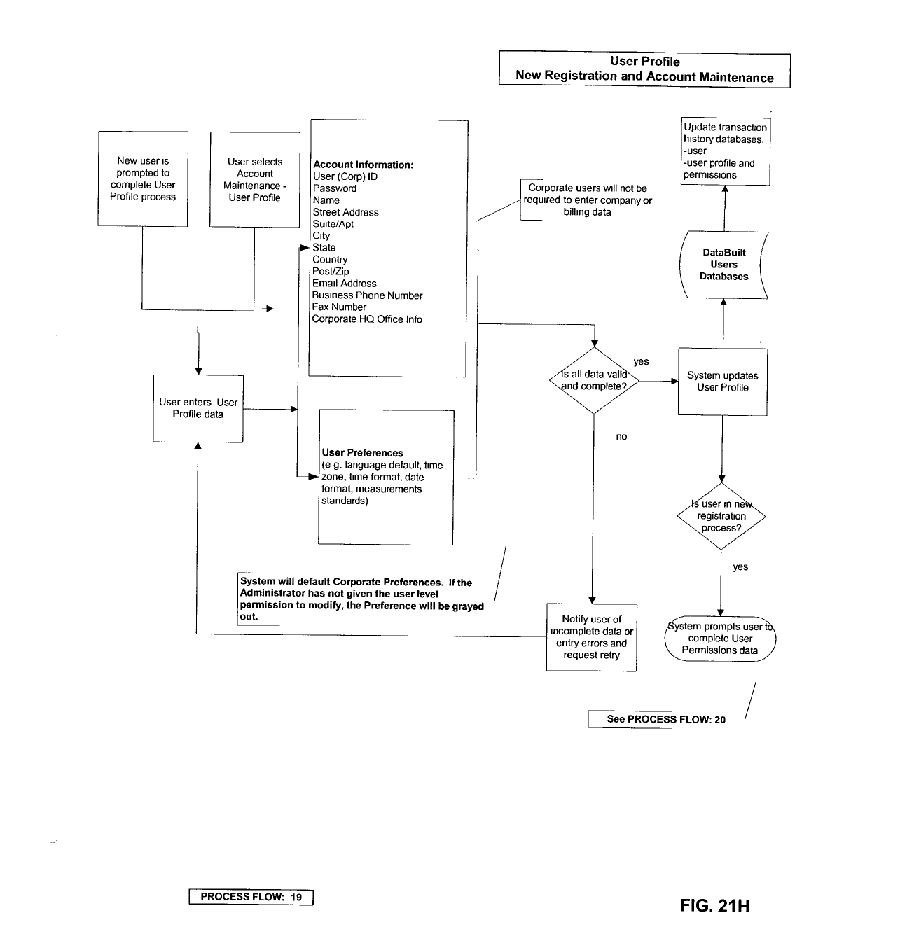

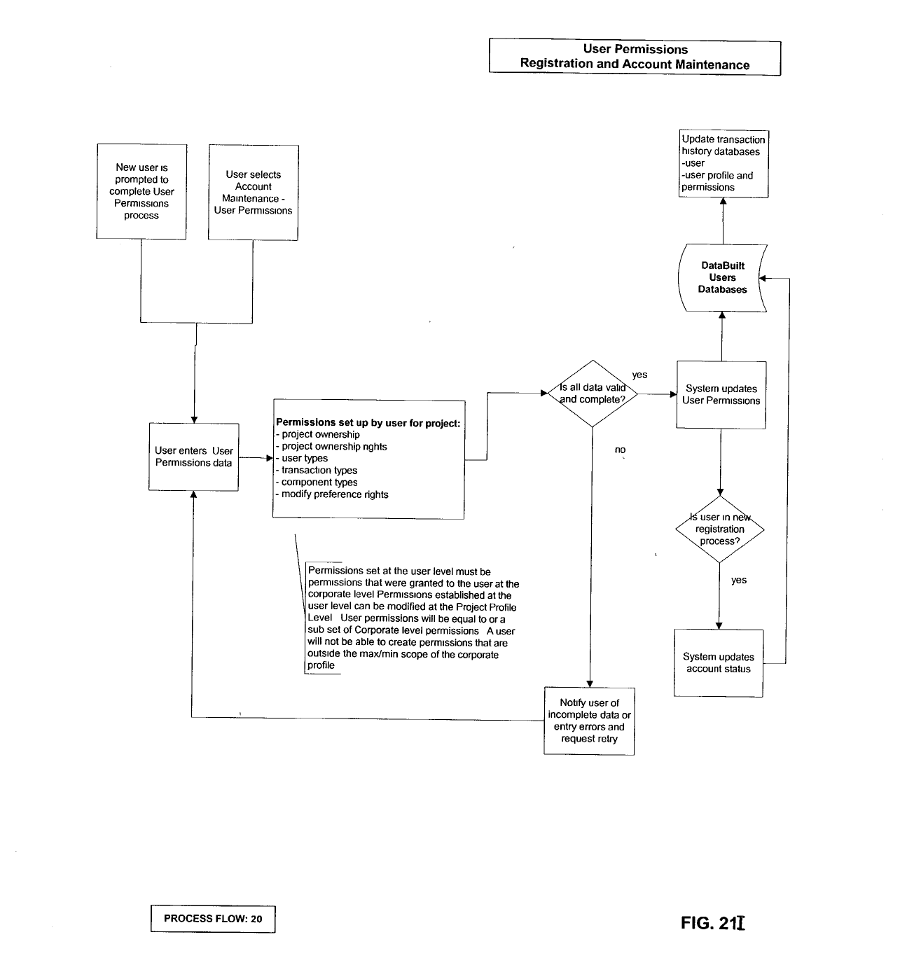

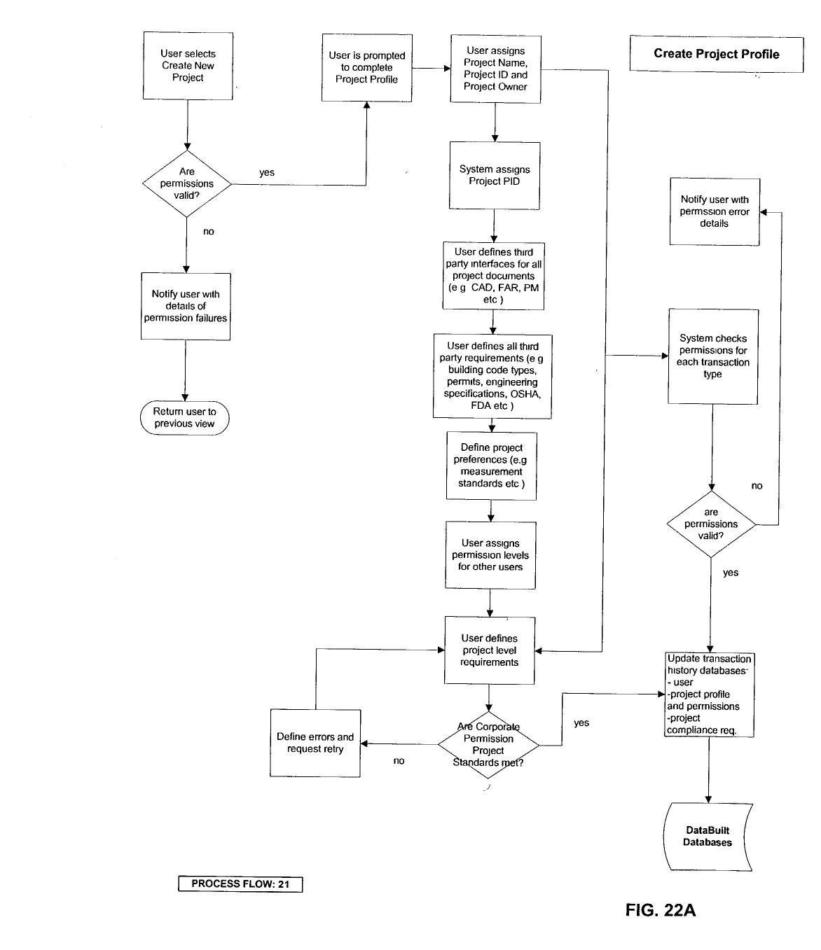

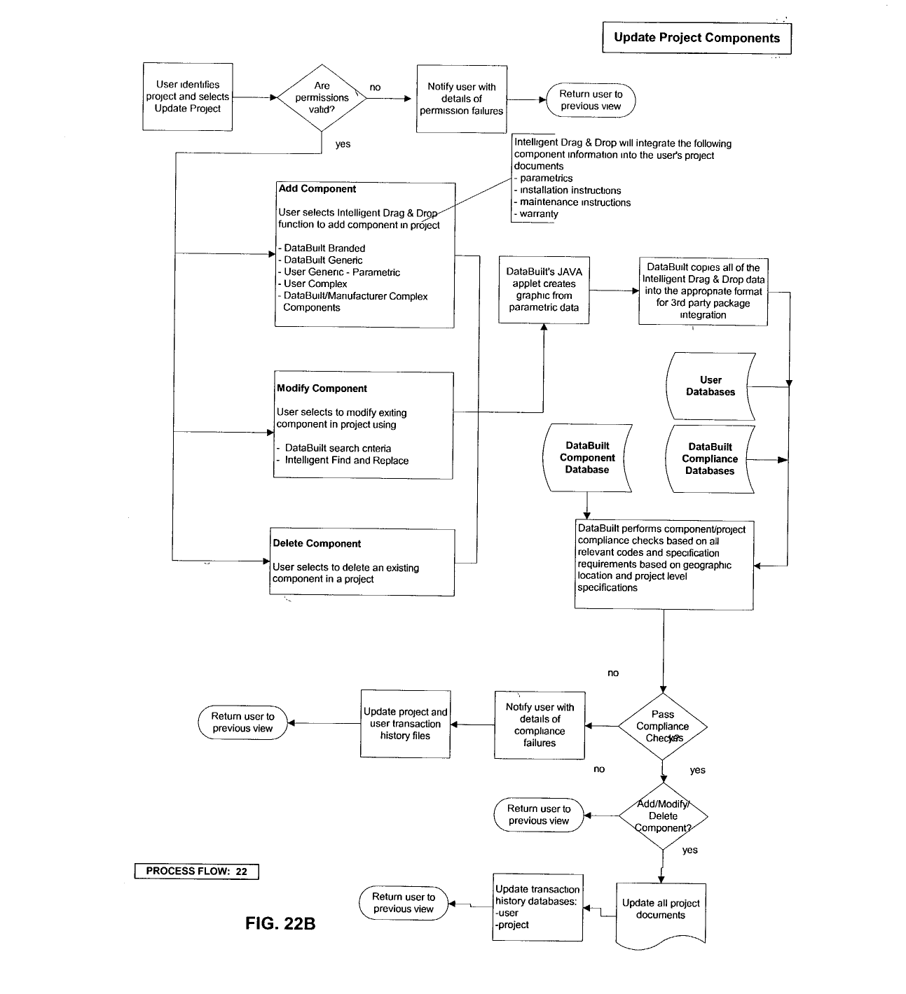

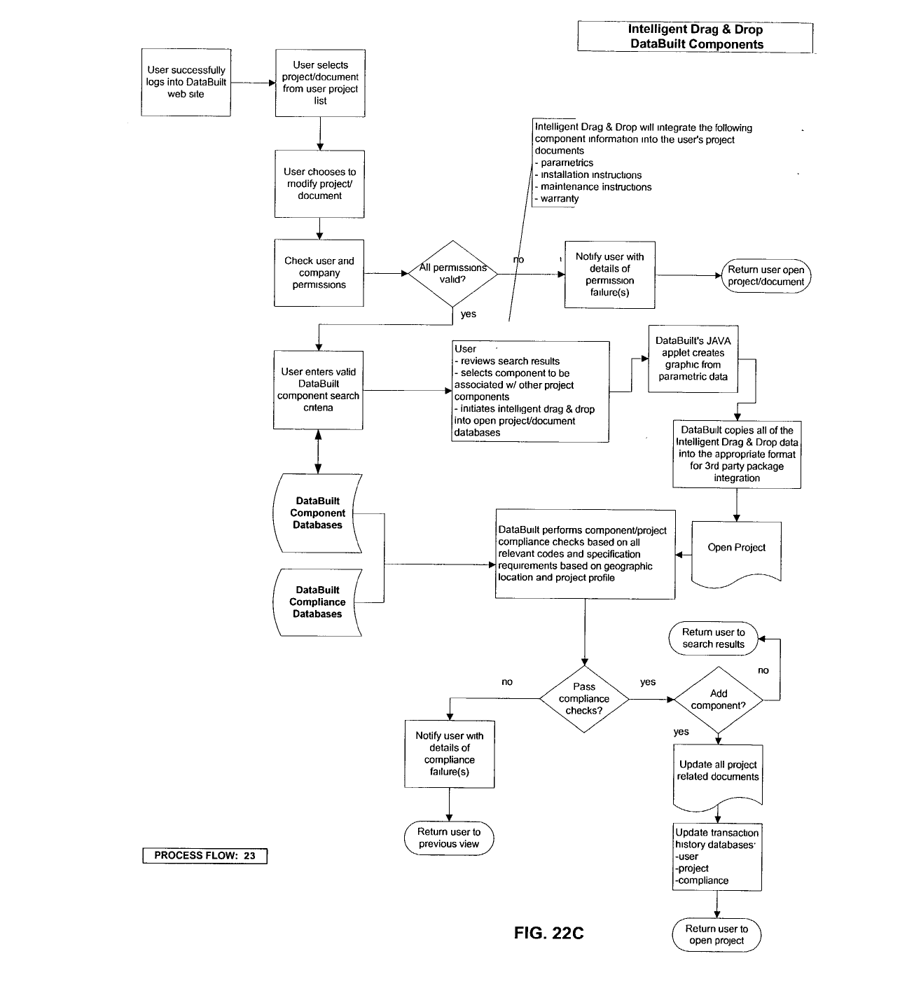

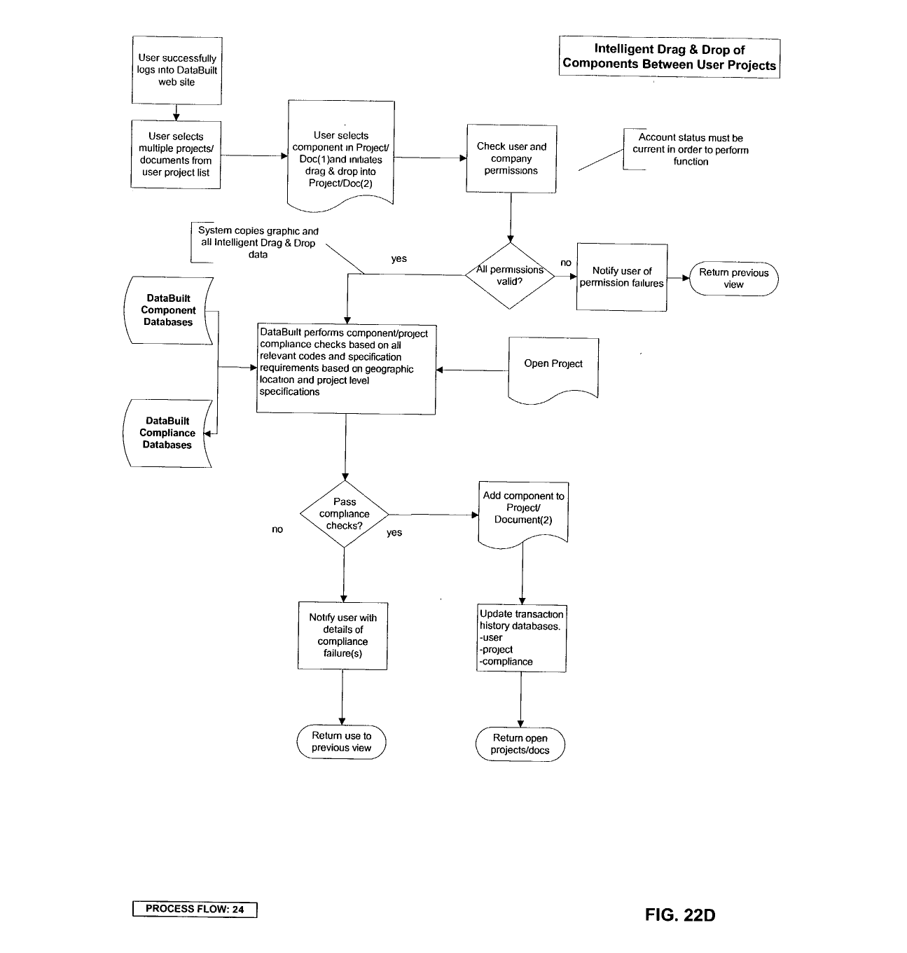

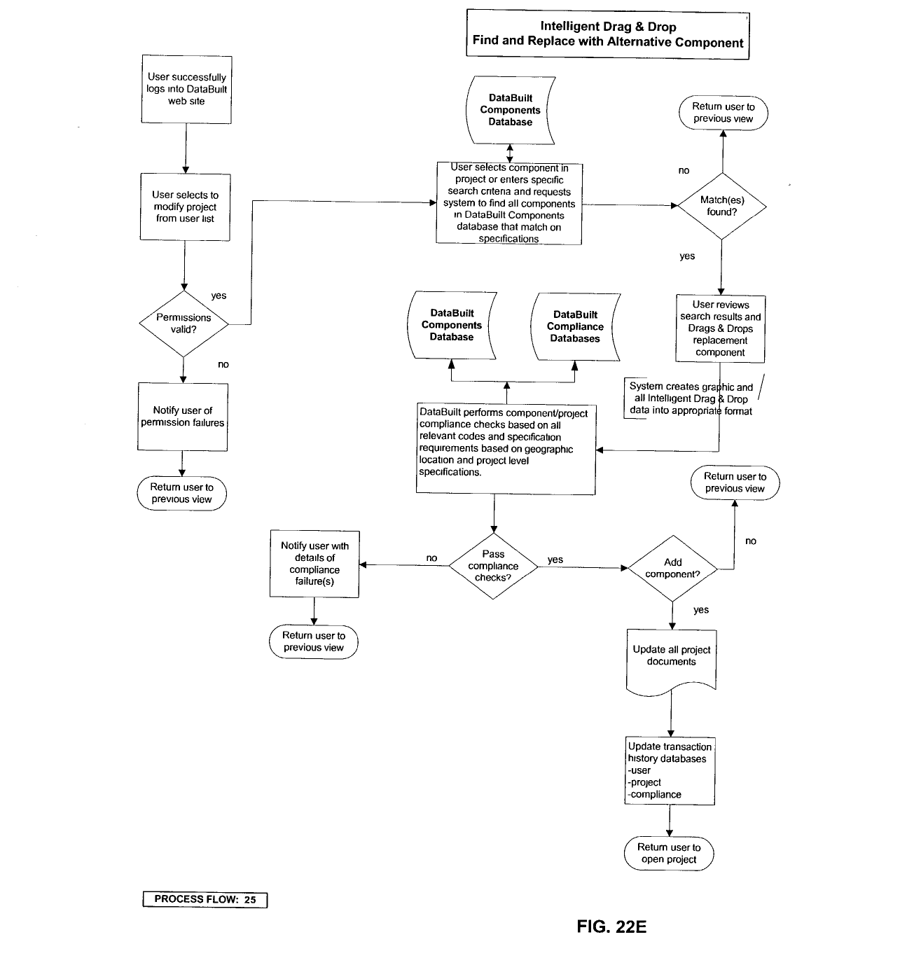

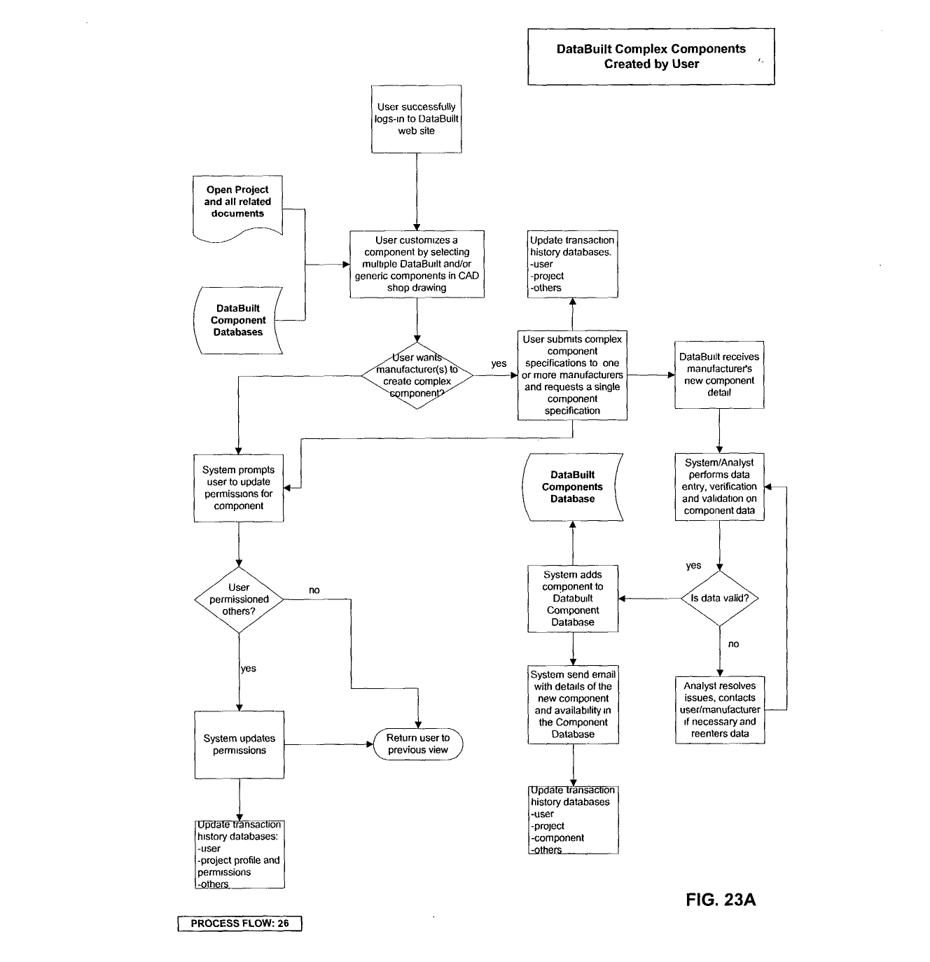

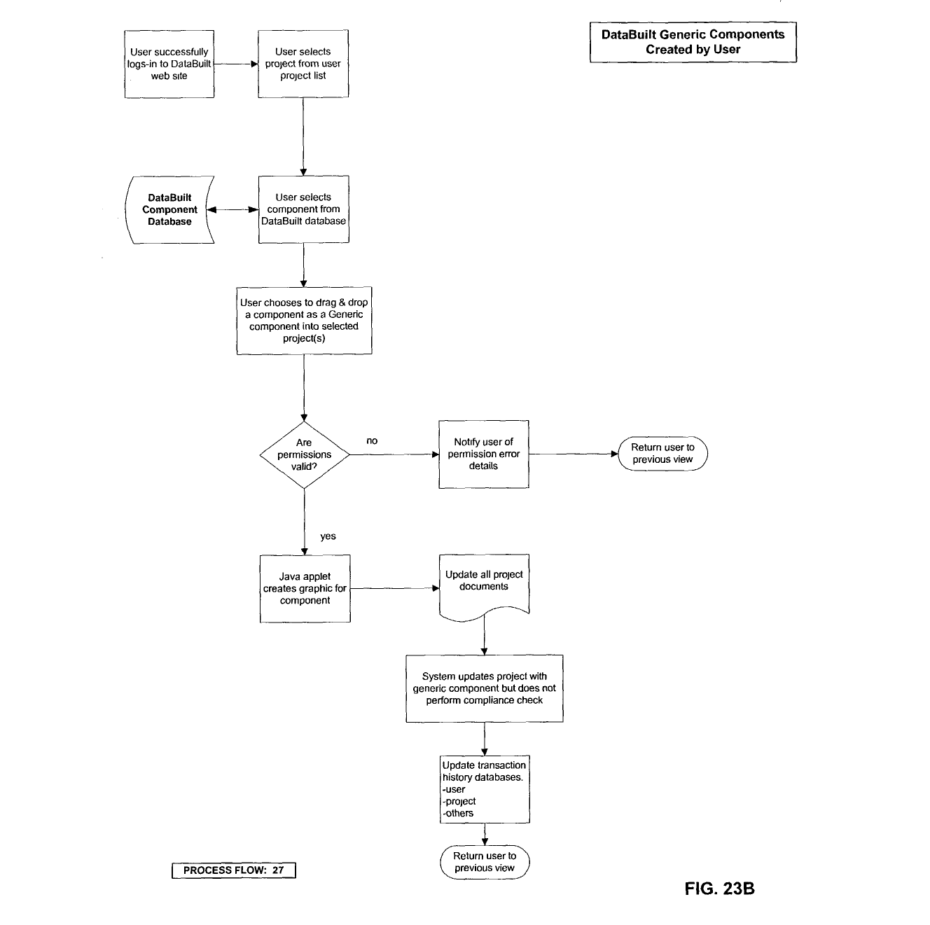

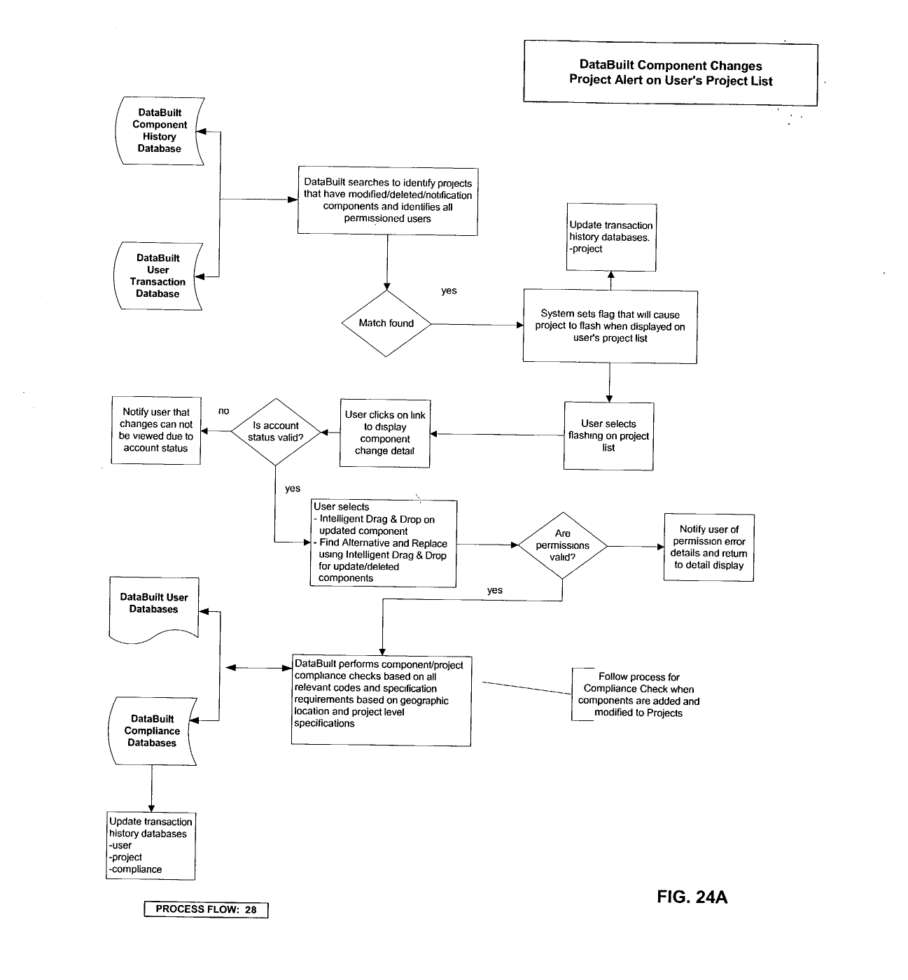

The process flows described below are illustrated in FIGS. 19A-24B.

II. Disclosure

DataBuilt is a network-based (Internet or Intranet) Architectural, Engineering and Construction (AEC) information services company. DataBuilt products include, but are not limited to:

(1) Proprietary databases containing AEC building products; regulatory requirements and engineering standards;

(2) Intelligent computer software applications to search, access and integrate all DataBuilt information; and

(3) Intelligent software applications that allows users to integrate DataBuilt AEC building products, regulatory requirements and engineering standards into Computer-Aided Design (CAD) and non-CAD documents.

DataBuilt uses proprietary mechanisms for organizing, codifying, naming, cross-referencing and electronically exchanging all AEC information. DataBuilt mechanisms serve as the global AEC standards for all of the above categories of AEC information manipulation.

DataBuilt databases, designed and organized using the above noted mechanisms, include user account and project profiles. The entire DataBuilt system is designed to facilitate user activities. In order to minimize the time spent setting up each project for use with DataBuilt, users create both user and project profiles. The user profiles define defaults that are applied to all activities of a user. Project profiles define a broad range of project related default standards, access permissions and other relevant data to be used with specific projects.

DataBuilt databases also include information on manufactured AEC building components which includes, but is not limited to 2-D and 3-D graphical representations, product specifications, product options, installation and maintenance instructions, warranties, manufacturer's suggested price, and availability (lead time and suppliers).

In addition to construction materials and other AEC manufactured components, DataBuilt components include all machinery and equipment necessary for commercial, industrial, infrastructure, and public utility building projects to function in a specified manner (e.g., capital goods for manufacturing plants, etc.). Information on machinery and equipment includes, but is not limited to 2-D and 3-D graphical representations, product specifications, product options, installation and maintenance instructions, warranties, manufacturer's suggested price, and availability (lead time and suppliers).

DataBuilt databases also include information on statutory, regulatory codes and requirements, including permitting requirements, building codes, usage-related regulations (e.g., OSHA, NRC, FERC, FDA), engineering standards, best practices standards, lending requirements (e.g., GNMA, FNMA, FHLMC, commercial mortgage lenders, etc.), insurance requirements (e.g., FEMA, commercial property and casualty companies, etc.), and building owner standards for implementing building projects.

DataBuilt application software allows individuals to access, search and otherwise use the DataBuilt information. DataBuilt application software allows individuals to validate DataBuilt information, such as validating that the components comply with all relevant statutory and regulatory requirements.

Users are provided with the capability to conduct searches of all DataBuilt databases based upon user selected search parameters. All search criteria is context-sensitive. For example, users searching for certain types of residential windows would be presented search criteria based upon the selection of the DataBuilt product category “residential windows.” Likewise, someone searching for regulatory requirements for manufacturing foods products would be presented search criteria based upon the selection of the DataBuilt building usage category “food manufacturing and preparation.”

An extension of the DataBuilt context-sensitive parametric search provides users the ability to search, view, select and compare DataBuilt AEC components and/or other DataBuilt information.

The purpose of DataBuilt is to facilitate certain functions now performed manually by AEC professionals. In addition to its time-saving function, DataBuilt is also designed to assist AEC professionals in limiting errors in building component selection vis-a-vis compliance with all appropriate project requirements and standards. DataBuilt application software incorporates knowledge-based assessment of the appropriateness of any building component and the placement thereof, in various documents. The intelligence integrated into DataBuilt applications software includes, but is not limited to detection of conflicts between component selection and regulatory codes and requirements, engineering standards and user-specified project standards. Conflict resolution occurs via real-time notification to user of conflict, suggestion of alternative components, limitation of user ability to include non-conforming components into a document, and other means as appropriate.

Conflicts between DataBuilt information and usage are detected (e.g., users cannot “drag and drop” a 3-D component into a 2-D CAD drawing). Conflicts among DataBuilt building components with respect to the placement thereof in a document are also detected (e.g., DataBuilt software does not allow an electrical line to be placed inside a water pipe, etc.).

DataBuilt applications software provides users the ability to intelligently “drag and drop” complete information sets on DataBuilt building components and other information into user CAD and non-CAD documents. DataBuilt provides the capability for users to simultaneously import DataBuilt information into multiple document formats.

DataBuilt applications software accommodates “intelligent drag and drop” into all existing commercial AEC-related document systems including, but not limited to computer-aided design (CAD) software for renderings and supporting documents (e.g., bills of materials, Product Specifications, etc.), facilities management and plant maintenance software systems, fixed asset management systems, other AEC-related software systems, desktop publishing systems (e.g., Adobe, etc.), and business information and productivity systems suites (e.g., Microsoft—Word, Excel, PowerPoint, etc.).

DataBuilt applications software provides users the capability to search for replacements for components that have been “dragged and dropped” into the above noted third party application software products. “Intelligent Find and Replace” searches and validates code compliance for alternative components. Replacement of all information on one or more occurrences of the component to be replaced can be effected by simply selecting the appropriate replacement component.

The DataBuilt “Intelligent Global Component Compliance Validation” application provides users the capability to instantaneously validate the availability and compliance of all components in an AEC document for locales other than those for which an AEC project was initiated. For example, consider the owner-operator who wanted to build two identical chemical plants at different locations (e.g., Atlanta, Ga., USA, and Qiba, Japan). The following steps may be executed in DataBuilt:

(1) User creates a new DataBuilt project/project profile is created defining the user AEC standards for the first location. A user may define minimum project standards that exceed regulatory requirements and/or engineering standards.

(2) The plant is then designed and engineered using DataBuilt components, regulatory requirements codes and engineering standards for that location.

(3) A new (second) project (project profile) is created setting user standards for the second location.

(4) The original set of design documents (CAD and non-CAD) is copied to second project location.

(5) “Validate Component Availability and Compliance” is selected from the “Tools” menu.

(6) The result provided by the DataBuilt application software is a red-lined version of component availability and compliance issues with recommendations for modification.

DataBuilt application software allows users to create and store simple or complex components. The user-created components can be assembled from groupings of existing DataBuilt components and/or sub-components. They can also be created from shop drawings produced by the user. Complex components could be as simple as a table and chair grouped into a single component or as complex as an entire nuclear power generation facility.

DataBuilt application software includes functions that allow users to covert CAD and non-CAD documents and databases to other formats. DataBuilt also provides the user with access to its database schemas and database access algorithms.

An overview of proprietary processes implemented by DataBuilt, software applications and database content will now be discussed (see process flow diagrams for additional information). An audit trail is established for all database transactions. Additions to all databases are tagged with date, time and source of data. Modifications and deletions to all databases are tagged with date, time, source and reason for modification or deletion of data. A times series history file is created on the data element level for all DataBuilt database activity.

DataBuilt cross-reference databases implement multi-lingual terminology and nomenclature cross-reference using DataBuilt terminology primary identifier, DataBuilt terminology primary name (cross-reference to DataBuilt nomenclature table), language code, and terminology name.

DataBuilt cross-reference databases may be searched using a company and organization primary identifier, company primary name (cross-reference to company name table), organization type (see organization type table), domicile of company (ISO world geography table), parent company primary identifier, company alternate identifier table, company alternate identifier, company alternate identifier type (see alternate identifier table), company alternate identifier source, company alternate identifier language, and ISIC Codes (n).

DataBuilt product category cross-reference (n-level cross-reference) databases may be searched using a primary DataBuilt product category identifier, primary DataBuilt product category descriptor, alternate product category, alternate product category source identifier (see company and organization cross-reference—alternate sources may be manufacturers, trade associations, DataBuilt users, etc.), alternate product category identifier, alternate product category descriptor, and alternate product category language.

DataBuilt manufactured component databases may be searched using a DataBuilt manufacturer's primary identifier, DataBuilt product category, manufacturer's component product identifier, manufacturer's component product description, and manufacturer's sub-components product identifiers (table). The manufactured component information database is recursive to the extent that product sub-component and options are reflected in the sub-component table. DataBuilt manufactured component databases may also be searched using a manufacturer's component product graphical representation, DataBuilt parametric description of manufacturer's graphics, manufacturer's component product specifications, manufacturer's component product options, manufacturer's component product installation instructions, manufacturer's component product maintenance instructions, manufacturer's component product warranty information, manufacturer's suggested product price, and product availability and order lead time. User created components and complex components are treated in the same manner. A user identifier may be substituted for a manufacturer's primary identifier. Under manufacturer's product description, a descriptor may be selected from a “user-defined component type” Table).

Electronic updates may be carried out for the manufactured component database. Information may be added to a temporary file, data may be converted and parsed as necessary, quality control processes may be performed and data vetted, parametrics may be created for graphics, and information may be added to a primary component database.

Modifications may be performed by adding to a temporary file, converting and parsing data as necessary, performing quality control processes and vetting data, updating a primary database, updating a component history file, and searching a user transactions file to notify a user regarding modifications.

Deletions may be performed by updating a primary database, updating a component history file, and searching user transactions file to notify a user regarding deletions. Manufacturer's notifications may also be implemented.

Manual updates to a manufactured component database may be performed by validating source documents, scanning where possible, converting and parsing data as necessary using DataBuilt database mapping tools, adding to temporary files using dual entry data validation processes, and executing subsequent process flows to update DataBuilt databases for additions, modifications and deletions, as described above.

The DataBuilt project compliance databases include both full text and codified data entity representation. Actual data entities and data structures vary in accordance with the type of compliance code in question. The DataBuilt project compliance databases are designed to allow DataBuilt to validate the use of any and all DataBuilt components in specific user projects: e.g., a user is not be able to insert DataBuilt building components into a document if the component and/or its placement violate any compliance code. The DataBuilt project compliance databases are also designed to allow DataBuilt users to link specific physical assets to appropriate compliance tests for purposes of maintenance, repair and replacement.

The various compliance codes are cross-referenced to by political/geographic jurisdiction, DataBuilt product category, DataBuilt project category, and DataBuilt industry classification (ISIC). DataBuilt Project Compliance Databases include building codes, permitting agency requirements, engineering standards and specifications (all disciplines, all industries), engineering best practices (all disciplines, all industries), global supra-national and governmental regulatory requirements (e.g., in the US, FEMA, FERC, NRC, FDA, GNMA, OSHA, EPA, etc.), project owner standards, property & casualty and other insurance requirements, and lender requirements.

DataBuilt stores, in perpetuity, all transactions performed by any user that involves DataBuilt component selection and insertion into a project. DataBuilt also stores, in perpetuity, all modifications to company, user and project definitions and permissions. The User Transactions Database includes user identifier, user IP or other computer address identifier, company primary identifier, project primary identifier, transaction date and time, and DataBuilt transaction type including component selection transaction information or company, user, project, permission modification information.

DataBuilt users may elect to perform one or more of the DataBuilt related business functions in the DataBuilt technology environment. These functions include, but are not limited to the creation of CAD and non-CAD project documentation, electronic filing of information with interest parties, maintenance and re-engineering of projects, or the like. Similarly, users may choose to use the DataBuilt technology environment as a backup facility for databases that reside primarily on users' own sites. Lastly, users may elect to replicate all or part of the DataBuilt technology environment in the user's facilities and to store certain user databases in that environment.

DataBuilt profile and permissions databases include corporate profile and permissions, user profile and permissions, and project profile and permissions. DataBuilt provides a facility for representatives of agencies requiring code compliance verification, and other interested parties, to document code compliance through the storage of text, voice, and pictorial (digital still and video) compliance audits. DataBuilt software products (see below) allow compliance officers and others to validate compliance through comparison of pictorial and CAD documents.

Account Set-Up and Maintenance implements corporate account profile and permissions, individual user profiles and permissions, and administrator functionality.

DataBuilt user access and functionality is provided via the Internet and/or Intranet, display login screen, user login—validate permissions and profile, access transaction history file and login screen functions.

The login screen functions include a DataBuilt information display for accessing industry news headlines, project list, display project and project permissions. Notifications may be displayed by project to review DataBuilt component modifications made by other authorized users, manufacturer's changes, additions, deletions, news for components, and other DataBuilt users currently accessing a project.

DataBuilt functions may be accessed to update a user profile and for project management. Projects may be added and/or modified. All third party interfaces may be defined, such as CAD, fixed asset register, plant maintenance, etc. Third party requirements may be defined —e.g., building and permitting codes and requirements, regulatory requirements (e.g., OSHA, FDA, FERC, NRC, etc.), engineering standards, etc. Project parameters may be defined (locale, languages, metrics, etc.). User defined project standards and permission project users may be created and/or modified. Project standards must meet or exceed corporate account profile standards and regulatory requirements. Projects for DataBuilt Activity may be selected.

DataBuilt application functions may be used to search DataBuilt for components, update projects (all project documents) with DataBuilt information, search and/or add components via “intelligent drag and drop” including DataBuilt branded, DataBuilt generic, user generic—parametric, user complex, and DataBuilt/manufacturer complex. Component selection may be modified (modify all project documents) via specific search and via parametric search (e.g., find alternative and replace). Components may be deleted (modify all project documents). Complex components may be created from component parts, from complete components, and from shop drawings and parametric drawings. User generic and complex components may be electronically submitted to a manufacturer. The manufacturer sends new component detail to DataBuilt, DataBuilt updates all databases with new component details, and DataBuilt notifies a user of the existence of the new component. DataBuilt data conversion programs may be used for Computer-Aided Design (CAD) systems, facilities management and plant maintenance systems, fixed asset management systems, other AEC related software systems, desktop publishing systems, and business information and productivity systems.

In process flow # 1 (DataBuilt Component Database-New Components-Electronic Updates), new component data is received from component manufacturers in electronic format. Details of the data include, but are not limited to component identifiers and descriptions, graphics, specifications, options, installation and maintenance instructions, warranty, manufacturer's suggested price, availability, shipping lead time, or the like. The system utilizes the Databuilt data conversion mapping tools to create temporary input files. If the data cannot be mapped into the input files, an analyst reviews the information, resolves the data issues and reenters the data. The system performs quality control analysis on the input files based on similar components and specifications. If the data is not valid, a supervisor reviews an exception report and sends it back to a senior analyst. The analyst reviews the original specifications from the manufacturer, resolves the issue and re-enters into the temporary file for reprocessing. If the data is valid, the system updates the component database with component details and the parametric data to create the component graphics. The system updates the transaction history databases (user and component). Once the data is mapped into temporary files, a check is performed to determine whether all data can be mapped. If the data that is coming in from the manufacturer electronically cannot be mapped, an analyst reviews an exception report and the problem is resolved and the input files updated so that all data is captured. If all the data can be mapped or the data that is mapped resides now in a temporary file, the system performs quality control analysis on the input file.

When data is received, the system utilizes the DataBuilt data conversion mapping tools to create temporary input files in order to handle the data. The tools vary based on the information coming from different manufacturers. Once the data is mapped into temporary files, a check is performed to determine whether all data can be mapped. If all of the received data cannot be mapped, an analyst reviews an exception report, resolves the problem and updates the input files so that all data is captured. If all of the received data can be mapped or the data that is mapped resides now in a temporary file, the system performs quality control analysis on input file based on similar components and specifications, and the graphic for the component is created based on the received data. The information on a particular component is compared to other similar components to insure that the received data is within a certain tolerance of accuracy. If the data is not valid, a supervisor reviews an exception report, determines what needs to be done and it is sent back to a senior analyst for review against the original specifications from the manufacturer or the problem that has been identified as part of a data problem is collected and sent back in a temporary file for reprocessing against validation procedures. If the data is valid, then the DataBuilt manufacturer's component database is updated. After updating the databases or simultaneously updating the component database, the transaction files are updated. The transaction files capture every transaction that effects a piece of data on the DataBuilt database. The transaction files are captured on the user level. The type of data that was entered and the transaction type is captured, along with the time and the date stamp that changes to the data are made or when data is added, and the user ID of the individual that was processing the data. If data was added, the identity of the analyst that mapped the data is captured as well. In summary, the DataBuilt transaction files provide an audit trail of all data going into the DataBuilt databases. The user ID, the transaction type, the type of data and complete time stamps indicating where the data originated from and how it was processed.

In process flow # 2 (DataBuilt Component Database Modifications to Existing Components-Electronic Updates), changes to existing components are electronically updated in the DataBuilt component database. Modifications, deletions or notifications regarding existing components in the component database are received from the manufacturers in electronic format. Details of the modification, deletion or notification of the data include, but are not limited to: component identifiers and descriptions, graphics, specifications, options, installation and maintenance instructions, warranty, suggested price, availability, shipping lead time, or the like. The system utilizes the DataBuilt data conversion mapping tools to create temporary input files. If the data cannot be mapped into the input files, an analyst reviews the information, resolves the data issues and reenters the data. The system performs quality control analysis on input file based on similar components and specifications. If the data is not valid, a supervisor reviews an exception report and sends it back to a senior analyst. The analyst reviews the original specifications from the manufacturer, resolves the issues and re-enters into the temporary file for reprocessing. If the data is valid, the system updates the component database with component details and the parametric data to create the component graphics. The system updates the transaction history databases (user, component and component history). The system looks up the component identifier in the customer user transaction history database and determines the permission user IDs and project IDs affected by the component change. The system flags the project identifier so that it flashes on the user's project list when displayed on the DataBuilt website. This is described in detail in process flow # 28. The system sends an e-mail notification to all permissioned users for that project. This is described in detail in process flow # 29.

This process flow refers to electronic change data received from manufacturers regarding existing components that are in the DataBuilt component database. The data may be a notification indicating that there may be an impending change to a component. This process is similar to process flow # 1 where mapping tools are used to map received data into a temporary file. If the data cannot be mapped, an analyst reviews the information resolves the problem and goes back to put the information into the temporary file. Once in the temporary file, DataBuilt compare the information to similar components to test data validity. If the data is not valid, a supervisor reviews the exception report and passes it back to an analyst who reviews the original specification to determine what the problem with the data is. The problem is resolved and the data is returned into the temporary file and is processed again for validation. If the data is valid, the system updates information about the changes to the component. The type of update could be a deletion. The DataBuilt component database is updated, including the component history database. There are two separate databases provided so that the component database reflects all current specifications for a particular component. The history file is an audit trail of all information that the database has on the particular component on a historical basis. Once a change is made, the component database once again updates the DataBuilt transaction files which include the users files as well as the component transaction file and the component history file. The system also searches the user transaction file and the DataBuilt user file. DataBuilt also includes a customer transaction file which is used to determine which of the customers are effected by component changes. DataBuilt searches the customer transaction file and flags the project on the user project list and sends an e-mail notification to all permission users for that project, indicating that there has been a component change and the type of component and the specific component change that had been implemented.

In process flow #3 (DataBuilt Component Database-New Components-Manual Updates), data is received from component manufacturers in hard copy format. Details of the data include, but are not limited to component identifiers and descriptions, graphics, specifications, options, installation and maintenance instructions, warranty, manufacturer's suggested price, availability, and shipping lead time, etc. A supervisor validates the source document and distributes the hard copy to be keyed and scanned into DataBuilt databases. The system determines whether the scanning process has created valid data. If the date is not valid, the supervisor reviews the output and resubmits for scanning or resolution. The system performs quality control analysis on the input file based on similar components and specifications. If the scanned data is valid, the system updates the DataBuilt component database. The system updates the history transaction databases (user and component). Data to be entered manually is distributed to two separate analysts. The analysts key the information into on-line entry formatted screens that have been created by DataBuilt. The data entered by each analyst is written to temporary files for data comparison. The system compares both sets of data on a component level to determine accuracy (dual entry data comparison). If the data does not match on a component level, the supervisor reviews the exception report and determines the source of the error. The supervisor submits the data to the appropriate analyst to be re-entered and validated. If the data matches, the system performs a quality control analysis based on similar components specifications. If the data is not valid, the supervisor reviews the exception reports and submits to a senior analyst for validation or correction. If the data is valid, the system updates the component database with component details and the parametric data to create the component graphics. The system updates the transaction history databases (user, component and component history).

The information is received from the manufacturer is associated with new component information in a manual format hard copy, not in an electronic format. A supervisor reviews a source document which could be a manufacturers component catalog, and distributes the hard copy to be keyed and scanned into DataBuilt databases. The information is scanned where appropriate and where possible. As the information is scanned, a determination is made as to whether the scanning process has created valid data. If it has not, it is reviewed by a supervisor and resubmitted for scanning or resolution. If the DataBuilt process has scanned properly and does not have a problem, the scanned information is updated by the DataBuilt component database. The transaction file is updated in the component transaction file. For information that is not scanned, a supervisor validates and distributes the source documents to analysts who key the source documents into on-line entry formatted screens that have been created by DataBuilt. These entry screens capture the data that is on the hard copy and into a temporary file. Each analyst examines the hard copy and make entries independently so that more than one set of the same information is stored in a temporary file. The system compares both sets of data on a component level to determine accuracy, and compare the information entered by different analysts. If the data sets are not identical on the data element level on the screen (e.g., a file), an exception report is sent. If the data sets do not match exactly, a supervisor reviews the exception report and determines who (which analyst) made the error and returns it to the appropriate analyst for re-keying and the process is repeated to make sure that both data sets agree before an update is implemented. If the data does match, the system performs a quality control analysis based on similar component specifications. Component information is entered and compared to similar components and a quality control process is implemented to make sure that the data is valid. If the data is valid, the component database and transaction files are updated with history information and new component data. The user transaction files indicate who entered the data, the type of transaction, in addition to updates, the user ID and complete time stance. If the data is not valid, the supervisor reviews the exception reports and the analyst goes back and reviews the information to determine whether the information coming in from the manufacturer was incorrect.

In process flow # 4 (DataBuilt Component Database Modifications to Existing Components-Manual Updates), component modification, deletion and notification data is received from component manufacturers in hard copy format. Details of the updates include, but are not limited to component identifiers and descriptions, graphics, specifications, options, installation and maintenance instructions, warranty, manufacturer's suggested price, availability, and shipping lead time, or the like. A supervisor validates the source document and distributes the hard copy to be keyed and scanned into DataBuilt databases. The system determines whether the scanning process has created valid data. If the date is not valid, the supervisor reviews the output and resubmits for scanning or resolution. The system performs quality control analysis on the input file based on similar components and specifications. If the scanned data is valid, the system updates the DataBuilt component database. The system updates the history transaction databases (user, component and component history). Data to be entered manually is distributed to two separate analysts. The analysts key the information into on-line entry formatted screens that have been created by DataBuilt. The data entered by each analyst is written to temporary files for data comparison. The system compares both sets of data on a component level to determine accuracy (dual entry data comparison). If the data does not match on a component level, the supervisor reviews the exception report and resubmits to the appropriate analyst to be re-entered and validated. If the data matches, the system performs a quality control analysis based on similar component specifications. If the data is not valid, the supervisor reviews the exception reports and submits to a senior analyst for validation or correction. If the data is valid, the system updates the component database with component details and the parametric data to create the component graphics. The system updates the transaction history databases (user, component and component history). The system looks up the component ID in the customer user transaction history database and determines the permission user IDs and project IDs affected by the component change. The system flags the project ID so that it flashes on the user's project list when displayed on the DataBuilt website. This is described in detail in Process Flow # 28. The system sends an e-mail notification to all permission users for that project. This is described in detail in process flow # 29.

This process enables a manufacturer to send in changes to DataBuilt regarding modifications to the components of the manufacturer. The process can also implement a deletion or a notification about a component. The information is manually updated. The supervisor receives the source document, which indicates the type of component change and the supervisor forwards the document to two analysts. The analysts enter the data separately into a temporary file. The temporary files are compared to each other as described previously.

In process flow # 5 (DataBuilt Compliance Database New Specifications-Manual Electronic Updates), compliance and specification data is received in hard copy and electronic formats. Compliance data includes, but is not limited to permitting requirements, building codes, engineering specifications, engineering best practices, insurance requirements, lender requirements, governmental regulatory requirements (e.g., FEMA, NRC, FERC, FDA, GINNIE MAE, OSHA, EPA) and owner operator standards. A supervisor receives the hard copy or the electronic formats, validates the source, logs the information and submits to an analyst. The analyst uses DataBuilt mapping tools to reformat the hard copy and electronic data into a temporary file. A second analyst reviews the data online and validates the accuracy. If the data is not valid, the second analyst makes corrections and the corrected data is resubmitted to the first analyst for verification and validation. If the second analyst certifies that the data is valid, the system performs quality control analysis on those codes and specifications where applicable. If the data is not valid, a supervisor reviews the exception reports and submits to a senior analyst for correction and validation. This senior analyst reviews the engineering specifications or the building code specifications to resolve the data issue. If the data is valid, the system updates the compliance database. The system updates the transaction history databases (user and compliance).

The compliance database consists of all the information that is necessary to check a component against codes, specifications, and other requirements that an architect or engineer is interested in knowing so that it can be determined that the component is a valid component to be placed into a particular structure. Owner operator standards and AEC user standards are stored in a compliance database for implementing both manual and electronic updates.

In process flow # 6 (DataBuilt Compliance Database Modifications-Manual Electronic Updates), modifications to compliance and specification data are received in hard copy and electronic formats. Modifications to compliance data include, but are not limited to permitting requirements, building codes, engineering specifications, engineering best practices, insurance requirements, lender requirements, governmental regulatory requirements (e.g., FEMA, FERC, FDA, GNMA, FNMA, FHLMC, OSHA, EPA) and owner operator standards. The supervisor receives the hard copy or the electronic formats, validate the source, log the information and submit to an analyst. The analyst uses DataBuilt mapping tools to reformat the hard copy and electronic data into a temporary file. If the data is not valid, the second analyst makes corrections and the data is resubmitted to the first analyst for verification and validation. If the second analyst certifies that the data is valid, the system performs quality control analysis on those codes and specifications where applicable. If the data is not valid, a supervisor reviews the exception reports and submit to a senior analyst for correction and validation. This senior analyst reviews the engineering specifications or the building code specifications to resolve the data issue. If the data is valid, the system updates the compliance database. The system updates the transaction history databases (user, compliance and compliance history). The system looks up the compliance ID in the customer user transaction history database and determine the permission user IDs and project IDs affected by the change. The system flags the project ID so that it flashes on the user's project list when displayed on the DataBuilt website. This is described in detail in process flow # 28. The system sends an e-mail notification to all permission users for that project. This is described in detail in process flow # 29.

In process flow # 7 (DataBuilt Multilingual Databases and Cross-reference Tables), every data element stored in the DataBuilt databases (e.g., compliance, component, company, product category) is assigned a DataBuilt primary identifier (PID). The PID for each data element is never changed. The PID is used to cross-reference the data element (i.e., company name, product category, component identifier etc.) to all other identifiers and or names used in the AEC industry to identify the data. Cross-reference files are created and maintained to link all other IDs to the DataBuilt PID with full transaction history databases for each data element. DataBuilt analysts create multi-lingual cross-reference databases for all data elements.

The DataBuilt databases are individual databases that process similar types of data. There are compliance databases, a component database, company databases, global product category database, and a DataBuilt primary ID cross-reference database. The DataBuilt compliance database has all the information relevant to compliance requirements that may be needed in the industry to determine whether a specific component placed in a specific area of a drawing meets all of the requirements as defined by the compliance database (e.g., engineering specifications, owner/operator specifications, etc.). All types of compliance information is coded into tables consisting of types and subtypes, based on specific specification type and geographic requirements. This information always is linked to a primary identifier so that every element placed in the compliance database is identified with a primary ID and any other nomenclature that is used to indicate the same type of compliance specification, subtype or geographic requirement type. The primary ID is used in the cross-reference database to create the compliance cross-reference and provide a look-up table or translation table from English into all other supported languages. Similarly, in the component database, all of the data elements that would be consist being used in the component's database such as product codes, descriptions, all the data associated with a particular component, all of that information is created on a data element level and for every instance of a particular product code, a primary ID would be assigned to that product code and therefore all other ways of identifying that particular product, whether it was a manufacturer's product code or another description for the product code, all of that would be referenced back to a DataBuilt primary ID for that particular component data element in the component database and therefore DataBuilt can create a cross-reference table for all that information which is then linked back to a single primary identifier on clement levels and once again can translate that information into all the supported languages. For the DataBuilt company database, all information on the company level is created and stored in the company database. The particular company has a primary identifier assigned to it and all other names that are used to identify the same company would then be linked through that primary identifier and stored as well as linked to subsidiaries of that company and parents of that particular company would always be linked by using DataBuilt's primary identifier for that specific company. If the company experiences a name change or goes through a merger and hence changes its name, even though the name associated with the company would be changed the primary identifier for the company would never change. Furthermore, the information for the company can be translated into multiple languages.

The DataBuilt global product category database consists of the DataBuilt created standard for categorizing all components into product categories. DataBuilt would assign a specific primary ID for a particular component category and all other ways of describing or defining or numbering those categories would be linked to DataBuilt's primary identifier so that no matter what reference tool you were using to determine a particular component's category. It always would be linked back to a single primary identifier that would never change, but would link all other industry standards for calling a particular category something back to DataBuilt's standard for a particular category. Once again the product cost category cross-reference is created based on the one particular primary ID being linked to all other ID's used for that category and can be translated into multiple languages.

The DataBuilt website, although not necessarily a cross-reference table, the information on that website is handled for translation so that a user of the website can indicate what language the user would prefer the website to be displayed in. The user can change the default language setting, both at the homepage of the website (e.g., in the user preferences).

In process flow # 8 (DataBuilt Website User Functionality), the user successfully logs into the DataBuilt website. The user chooses a function in the active DataBuilt website (e.g., add or modify profile or permissions, update or add project profile permissions, open project documents, update projects, perform a compliance check and/or acknowledge project notification from DataBuilt). The system identifies the user ID, transaction type, project ID, and all data changes resulting from the transaction. The system updates all appropriate DataBuilt transaction history databases with full detail and time stamps to create a complete audit trail for each transaction.

When the user successfully logs into the DataBuilt website, it is assumed that the user has a valid login ID and a valid password, and has entered both into the login screen and has passed all validation and is now in the active website where the user has access to DataBuilt functionality. As the user chooses a function in the active DataBuilt website, a user can add or modify user profiles or permissions, update or add project profile permissions, access project documents, and update components, by either adding, swapping components or modifying components. A compliance check can be performed within a project by utilizing DataBuilt databases and information as to the status of the compliance check can be obtained by the user in the project. The user is able to acknowledge the notification from DataBuilt electronically that a component or compliance item in the project has been modified since it was last reviewed. The user can choose one or more of those functions after successfully logging onto the website. The system takes the transaction that the user initiated and updates the DataBuilt user transaction database. So that accessing the website and accessing a function within the website always causes an update to the DataBuilt transaction database. Updating that database captures the user ID, the IP address or computer identifier, the company primary identifier that the user has logged on with, the project primary identifier, the transaction type, the transaction date and time, the component selection transaction type, if that's the type of transaction that was executed, permission detail changes or compliance detail. Not all of these items are part of every transaction type but could be part of a transaction type. Once the transaction database has been updated, either the project profile database, the user profile, the component database, the compliance database, the user can actually move on to the next transaction. This process flow depicts capturing every user keystroke that causes a change to the status to a database by the user to be logged so that there is a complete audit trail for all the changes that the user may make to the user's project or profiles.

In process flow # 9 (DataBuilt Website User Functionality), the user can select the following functions in the DataBuilt website user log-in or new user registration. Access industry news, click on a headline to view AEC industry articles or see component and code changes that are highlighted, indicating that there are changes. The project list is viewed (the projects that appear after a user has logged in are only those projects that the user is permissioned for). The projects flash to indicate that a particular component or compliance item has changed since the user last logged in. The user can see a list of other users that are currently have the project open. The user can also access any other project documents that are associated with that particular project, provided that the permissions are set for the user to see the additional documents. The user can view a project transaction history file. The user can create a new project. The user is requested to create a project profile with specific information before the user can actually import other documents into that project. After the user creates the profile, the project can be updated using DataBuilt component and compliance functionality. DataBuilt transaction history databases is maintained for all transactions on the user and project levels. The user can access the component database to research and update a project using DataBuilt Intelligent Drag & Drop functionality. The user can access Databuilt specifications database to research and test components for a selected project. The user can modify the preferences and permissions on the user level and project level. The user can view the user transaction file to see a complete history of all the transactions that were by performed by user and/or project with full date, component, and compliance details.

This process flow is a definition of the types of functionality that the user can access once successfully logged into the DataBuilt website. The user can log in or choose to do new registration. The user can access the industry news headlines by clicking on a headline to view AEC industry articles or to review component and code changes that are highlighted, indicating that there are changes. The next step the user can access is the user's project list. The projects that appear after a user has logged in are only those projects that the user is permissioned for. The projects flash to indicate that a particular component or compliance item has changed since the user last logged in. The user can then also see a list of people that are currently using or have the project open. The user can also access any other project documents that are associated with that particular project, provided that the permissions are set for the user to see the additional documents. The user can also view a project transaction history file, which would be all transactions that were used to create or update a particular project that the user has selected. The user can also select to create a new project whereby the user is requested to create a project profile with specific information before the user can actually import other documents into that project that would be translated for the user to update in addition to what was done in another third-party package.

The update project selection is the ability to choose a project that a user is permissioned to make changes and modifications to. Provided the user's permission, components can be added or modified, related project documents can be viewed, the transaction history file can be viewed, and a review can be implemented on what other users have actually updated or made changes to the project as well. The other function a user can choose is DataBuilt component database that enables the user to actually access the component database where the user can use a criteria search to find components and initiate DataBuilt's intelligent drag and drop functionalities, provided the user is permissioned to drag and drop components into a particular project. The user can view the DataBuilt specifications database where the user can search and display specifications that are part of the DataBuilt compliance tables and the user can search and display and test drawings based on specifications and code types, geographic locations, etc. Another function the user can choose is the user profile where the user can choose to modify user preferences or permissions on the user level. The user can also choose to see the user transaction file where the user can view a history of all the transactions that the user performed by date, by project, by component, which is different than the project transaction history file which is specific to a project

In process flow # 10 (User Log-In DataBuilt Website), the user accesses the DataBuilt website and selects the login option. The user enters the user ID and the user password. The system validates that the user ID and password are correct. If the ID and password are not valid, the system requests the user to retry. If the ID and the password are correct, the system accesses the user profile and the company profile to determine that the account status is valid. If the account status is not valid, the system requests the user to contact the administrator. If the account status is valid, the system checks that the log-in does not exceed the permissioned concurrent user maximum for the account. If the login exceeds the maximum, then the system sends a message to the person trying to log in, indicating the maximum number of users has been exceeded and the administrator should be contacted. If the maximum has not been exceeded the system looks at the user's permissions and preferences to construct the website specific to the user.

The user brings up the DataBuilt website and selects the login option. Enters the user ID and the user password. The system validates that the user ID and password are correct if the ID and password are not valid, the system requests the user to retry. If the ID and the password are correct, the system accesses the user profile and the company profile to determine that the account status is valid. If the account status is not valid the system provides the company's administrator's name and contact information in a message telling the user the reason access was denied is on the account level and that the user needs to contact the company administrator to determine why access was denied. If the account status is determined that is good and the permission are valid, the system then checks to determine that with this login that the number of concurrent user maximum has not been exceeded. If the login causes the maximum to be exceeded, then once again the system sends a message to the person trying to log in, indicating that there is a login problem and that the company administrator should be contacted because the number of users has been exceeded and that access has been denied. If in fact the current maximum amount has not been exceeded, the system looks at the user's permissions and preferences to determine what particular items and the types of display formats, etc., the user has chosen for viewing DataBuilt information and based on that the system constructs the website specific to the user that has just successfully logged in.

In process flow # 11 (DataBuilt Website Change Language on Home Page), the user accesses the DataBuilt website. The user selects to modify language on the homepage. All information on the DataBuilt website is converted to the selected language. The user selects to log-in and enters a valid ID and password. The system accesses the preferences and the permissions and determines whether the language that was selected from the homepage is the same as the default language preference setting for the user. If the language selected before the log-in is the same as the user's language preference setting, the system creates constructs the DataBuilt website for the user. If the language selected on the home page is a different language the preferences than the user's language preference setting, the system notifies the user that a language was chosen that is different than the preference of the user and gives the user the choice to:

(1) Default to user preference;

(2) Update preference with the language preference selected on the home page; or

(3) Use selected language on home page for this log-in only. If the user selects option (1), the system constructs the website based on the permissions and preferences that were established in the profile. If the user selects option (2), the system changes the language to the language that was selected on the homepage in the user profile and then constructs the website based on the new user preferences and permissions. If the user selects option (3), the system does not update the user's profile preferences and permissions and constructs the user's DataBuilt website based on the user's permissions and preferences except for language.

The user selects to modify language on the homepage of the DataBuilt website prior to logging in. All information on the DataBuilt website is converted to the selected language from the language that it had been brought up in. The user then can chose to login and enters a valid ID and password.

In process flow # 12 (Corporate Account Registration), the new user accesses the DataBuilt website. The new user selects a new registration for a corporate account. The system requests the user to select a user ID and password. The system indicates that the user ID selected is assigned administrator privileges. The user enters an ID and password. The system determines whether the ID and password meet the standards that are required for new passwords and IDs. If the password or ID is not valid, the system notifies the user of the login errors and requests the user to re-enter the data. If the ID and password are valid, the system assigns a DataBuilt customer primary ID to the new user ID and password and flags it as an account administrator. The system requests the administrator to enter the company profile data—explained in detail in Process Flow # 13. The system checks the profile data. If the data is not valid, the system notifies the administrator of the entry errors and asks the administrator to re-enter the data. If the data is valid, the system requests the administrator to enter the company permissions—defined in detail in Process Flow # 14. If the permission data is not valid, the system identifies the error and requests the administrator to re-enter the data. If the data is valid, the system assigns a DataBuilt corporate primary identifier to the corporate account. The system requires the administrator to complete a user profile and permissions (defined in detail in process flows # 19 and # 20). The system validates the user's profiles and permissions data. If the data is not valid, the system notifies the user that the information is not correct, identifies the errors and asks the user to retry. The system updates the user transaction history databases (corporate account profile permissions, administrator profile permissions and user ID). If the information is correct, the system constructs the DataBuilt administrator's website based on the preferences, permissions and functions for the corporate administrator. The system returns the user to the active website.

This is just an overview, but if all the profile data has been entered, the system checks to make sure that profile data is valid. If the data is not valid, the system notifies the administrator of the entry errors and asks the administrator to retry. If the data is valid, the system requests the administrator to enter the company permissions, which is further broken down in Process Flow # 14. If the permission data is not valid, the system identifies the error and asks the administrator to reenter the information. If the data is valid the system now assigns a DataBuilt corporate primary identifier to the corporate information and the company that has been entered. The system requires the administrator to complete user profile and permissions data in order to complete the process. The user profiles and permissions data is entered, and if the data is not valid the system notifies the user that the information isn't correct, identify the errors and ask them to retry. If the information is correct, the system constructs DataBuilt administrator's website based on the permissions and preferences that the user has defined for the corporate profile. The user is then directed to the active website.

In process flow # 13 (Corporate Profile-Registration and Account Maintenance), the system prompts the administrator to complete the corporate profile and preference information, or the system administrator selects corporate account maintenance. The administrator enters or modify the profile and preference data. Examples of the data includes, but is not limited to password, company name, company address, company content information, account type, user types, maximum log-ins by type, third party software, company billing information, corporate preferences, or the like. The system validates the data. If the data is not valid, the system notifies the administrator with error details and request re-entry. If the data is valid, the system creates or updates the corporate profile. The system updates the user transaction history databases (corporate account profile and user). If the administrator is in the corporate registration process, the system prompts the administrator to complete the corporate permissions.

This process flow is a more detailed description of the information that was requested in Process Flow # 12 when requesting the administrator to enter company and profile data. This information is an example of the information that is going to be requested when asking an administrator to enter the company profile. The administrator is prompted to complete corporate profile and preference information or the administrator can select to maintain a corporate account profile preference information. The administrator enters or modifies the profile and preference data and corporate account information including the corporate ID, the password, the company name, etc. All of this information is linked back to a corporate primary ID. The corporate billing information for that particular company is also linked back to the primary ID. The preferences that the administrator has chosen for the corporate account, such as, language default, time zone, the time format display, date format, etc., measurement standards, is established during the corporate profile and preference registration, or can be modified by the administrator after it has been set up. The preferences default to the user level and the user can change these preferences if the administrator has permissioned the user to do so. So if all this data is not valid or some of this data is not valid, the system indicates that there have been errors made in entering the data and asks the administrator to retry entering that information. When the data is valid, the system either creates or updates the corporate profile and the company profile based on the information that was entered by the administrator. If the administrator is in the corporate registration process then the system knows that and prompts the administrator to complete the permissions part of this process. If the account has already been established, the system does not prompt the corporate administrator to enter any more of the data. Once the data has been entered successfully, both the DataBuilt user, database and the company database is updated, as well as the user transaction tables for the account profile, company transaction files, and the administrator user transaction file.

In process flow # 14 (Corporate Permissions-Registration and Account Maintenance), the system prompts the administrator to complete the corporate permissions information, or the system administrator selects corporate account maintenance. The administrator enters or modifies permissions data. Examples of the data include, but is not limited to user types, transactions types, component types, corporate compliance standards, project ownership rights, and project permission rights. The system validates the data. If the data is not valid, the system notifies the administrator with error details and requests re-entry. If the data is valid, the system creates or updates the corporate permissions. The system updates the user transaction history databases (corporate account permissions and user). If the administrator is in the corporate registration process, the system prompts the administrator to complete the Administrator's user profile and permissions.

The administrator, during the process of adding a new account, is prompted to complete the corporate permission section, or the administrator can select to maintain corporate permissions if the account already exists. The administrator enters the permission data. Examples of the permission types include the user types, transaction types, component types, corporate compliance standards, project ownership rights, project permission rights, or the like. This database indicates for a particular company the types of permissions that are going to be allowed by users to either add or update projects and components and compliance information in the users' projects. If the corporate permission data is not valid, the system determines the errors, notifies the administrator of the errors and asks the administrator to retry entering the data. Once all data is valid, the system updates the corporate permission database for this particular company and update the account status that is now a phone active account, updates the DataBuilt user's data base to indicate that this company is now a valid DataBuilt user and updates the user transaction and company profiles.

In process flow # 15 (Administrator Function-Add New User), the administrator accesses the DataBuilt website and successfully logs in. The administrator selects company profile maintenance. The system checks to make sure the user is permissioned to update company profile. If the user is not permissioned, the system notifies the selected function is not valid for the ID. If user is permissioned, the administrator selects the “Add New User” option. The administrator assigns the user ID and a password to each user that is added to the system. The administrator specifies account type, name, preferences and permissions for the new user. The system validates the data. If the data is not valid, the system identifies the errors and asks the administrator to retry entering that information. If the data is valid, the system adds the new user to the corporate account. The system assigns a customer primary ID and links that customer primary ID to the corporate parent ID and updates the account status. The DataBuilt transaction history database is updated (user, account profile and permissions). The system sends an e-mail to the new user.

In process flow # 16 (Administrator Functions-Modify User), the administrator accesses the DataBuilt website and successfully logs in. The administrator selects company profile maintenance. The system validates user permissions. If the user is not permissioned, the system notifies the user that the selected function is not valid for the ID. If the user is permissioned, the administrator selects “Maintain User Option.” The administrator enters the user ID to be modified. The system validates the ID exists in the corporate permissions. If the ID is not found, the system notifies the administrator that the ID is invalid and requests the re-entry. If the ID is found, the system identifies and displays all the account data related to the ID. The administrator modifies or enters new data for the ID, or selects to deactivate the ID. If this administrator deactivates the ID, the system updates the account status and logs off the user, if logged on. If the administrator selects to modify/add account data, the system validates the new data. If the data is not valid, the system notifies the administrator with the details of the errors and requests the user to re-enter the data. If the data is valid, the system updates the account data. The system updates the DataBuilt transaction history databases (user, account profile and permissions). The system sends (e.g., via e-mail) an updated user ID.

In process flow # 17 (Administrator Function-Increase Concurrent User Limit), the administrator accesses the DataBuilt website and successfully logs in. The administrator selects company profile/permissions maintenance. The system validates user permissions. If the user is not permissioned, the system notifies the user that the selected function is not valid for the ID. If the user is permissioned, the administrator selects “Increase User Limit” option. The system checks to validate whether the account status is current. If the account status is not current, the system notifies the administrator that there is an account status error and then returns the administrator to the corporate profile maintenance function. If the account status is current, the system allows the user to increase the concurrent user limit. The system updates the DataBuilt transaction history databases (user, corporate profile and permissions). The system provides an e-mail link with the text message for administrators to forward to one or more users.

The purpose of this e-mail is that if the administrator has received messages indicating that people cannot log in successfully because the limit has been exceeded, the administrator can then go in and increase the limit. Therefore, if the limit is successfully increased, a pop-up e-mail link is provided so that the administrator can then quickly send e-mail messages to one or more users telling them that the limit has been increased and that the users should try to log in again. If the administrator chooses to use the e-mail link the system sends the e-mail to the addresses that the administrator put in. If the administrator does not want to send the e-mail then this system returns the administrator to the corporate profile maintenance function.

In process flow # 18 (New User Registration), the new user selects the new registration option. The system requests the user to enter the user ID and password provided by the user's administrator. The system checks to see if the user ID and password are valid. If the data is not valid, the system notifies the user and asks the user to retry. If the data is valid, the system obtains the existing data for the user ID and updates the account status. The system requests the user to complete the user profile and preference information (described in detail in process flow # 19). The system validates the data. If the data is invalid, the system notifies the user and asks the user to retry. If the data is valid, the system requests the user to complete the user permission process (described in detail in process flow # 20). The system validates the data. If that information is not valid, the system notifies the user and asks the user to retry. If the data is valid, the registration process for the new user has completed and the account status is updated by the system. The system updates the DataBuilt transaction history databases (user, user profile and permissions). Based on the information that has been entered by the user, the system constructs the user's website.

In process flow # 19 (User Profile-New Registration and Account Maintenance), the system prompts the user to complete the profile and preference information, or the system user selects account maintenance. The user enters or modifies the profile and preference data. Examples of the data includes, but is not limited to password, name, address, contact information, language preference, and display preferences. The system validates the data. If the data is not valid, the system notifies the user with error details and request re-entry. If the data is valid, the system creates or updates the user profile. The system updates the user transaction history databases (user and user profile and permissions and project). If the user is in the registration process, the system prompts the user to complete the user permissions.

In process flow # 20 (User Permissions-Registration and Account Maintenance), the system prompts the user to complete the user permissions information, or the user selects user account maintenance. The user enters or modifies permissions data on the project level. Examples of the data include, but is not limited to user types, transactions types, component types, corporate compliance standards, project ownership rights, and project permission rights. The system validates the data. If the data is not valid, the system notifies the user with error details and request re-entry. If the data is valid, the system creates or updates the user permissions. The system updates the user transaction history databases (user account permissions and user, project). The system constructs the user's DataBuilt website based on the user's profile and permissions.

The user's permissions are equal to a set of corporate level permissions that were set by the administrator prior to the user establishing permissions. Once again the user is not able to create a permission that is outside of permissions that establish maximum or minimums at the corporate level. Corporate level permissions regarding minimum or maximum types of permission levels always override anything that the user tries to establish. Once the user enters the permission data, or updates permission data, the system checks to make sure that all of the data is valid. If the data is not valid, the system notifies the user of the errors and asks the user to re-enter the information. If the data is valid the system updates the user permissions table and determines whether the user is in the new registration process. If the user is in the registration process this would be the last step to complete the registration process and the system would then update the account status. If the user was modifying existing permissions, the DataBuilt user database would be updated with the new permission information and then the user transaction files and permission files would be updated.

In process flow # 21 (Create Project Profile), the user selects the option to “Create Project Profile.” The system validates permissions. If the permissions are not valid, the system notifies the user that an invalid option was selected. If the permissions are valid, the user is prompted to complete the project profile. The user enters a project name, project ID and indicate the project owner. The system assigns the project primary identifier. The user identifies all of the third-party interfaces, third-party type requirements (e.g., building code types, permits types, engineering specifications), project preferences, project permissions on the user level and the compliance level. The system compares all project level permissions to corporate level permissions to validate that corporate level requirements are met or exceeded. If permissions are invalid, the system defines the error details and requests the user to re-enter the data. If the data is valid, the system completes the project profile. The DataBuilt transaction history databases are updated (user and project profile).

The project primary identifier is an internal unique identifier that DataBuilt assigns to each and every project that is entered, and that project ID always remains with the project regardless of the name of the project changing or the owner of the project changing, or any of the other project identifying information that would change. However, those pieces of information would always be cross-referenced to the project primary identifier that was assigned. The user must identify all the third-party interfaces that are valid for this particular project and all documents are required to be converted in order to be used with DataBuilt information. The user defines the third-party type requirements for the specific project, for example, building code types, permits types, engineering specifications, and requirements on all these must be defined on the project level since the user can differ between projects. The user is requested to define project preferences. These preferences could be different then the user preferences for example, measurement standards, default data formats, other types of information display, or information default that could be different on the project level than on the user level. So the user is able to create a project preference list of attributes. The user than assigns permission levels for other users that access the project and the level of access, the types of transactions that the users are able to perform for this particular project. The user then defines project level requirements, indicating even though there are standards, engineering standards and specifications or building code types and specifications that are required at a regulatory level the user can define for this particular project requirements that exceed those other requirements levels and therefore DataBuilt ensures that when checking compliance, the project level requirements are always strict when they exceed the requirements of other regulatories or agencies or engineering type requirements. While entering this information, the system checks to make sure that all of the information that was entered is compared to a corporate permission profile indicating that the corporate level can mandate minimum standards so that if a project level set of minimum standards was entered but it does not meet the corporate level minimum standards, then the system does not allow the user to enter this information at the project level. The system defines the error indicating that the standards that were established for this particular project do not meet the minimum standards that have been set for the corporate level and asks the user to check the information and reenter that information. If the information is entered correctly, the information is written to the DataBuilt compliance databases and all of the compliance transaction files and user transaction files are updated. All profile information that is entered and the system has checked for permission information for each type of profile attribute for everyone that is accepted and passes the permission check, the user database and the project profile database are updated indicating that a user has set a preference or permission for this particular process and all the transaction files and the project profile transaction files are updated.

In process flow # 22 (Update Project Components), after the project profile is created, the user can update the project components as described by following process. User selects to update project from user list. The system checks to validate permissions. If permissions are not valid, the system notifies the user that selected option is not permissioned for the user ID. If permissions are valid, the user can then select to add a component, modify a component in a project, or delete a component that exists in a project. The user selects DataBuilt's Intelligent Drag & Drop (criteria search or find and replace functions) to add or modify components as DataBuilt branded, DataBuilt generic, user generic, user generic-parametric, user complex, or DataBuilt manufacturer complex components. The system integrates all of the data from the DataBuilt component databases for the selected component into the user's project. The DataBuilt Java Applet creates the graphic representation from the parametric data. The system performs component compliance validation based on the selected component, placement in the drawing, and all codes and specifications relevant to the project. If the project fails the compliance check, the user is notified with the compliance failure details. If the project passes the compliance check, the user is notified of the pass status and prompted to indicate whether the component is to be added. If the user adds the component, the system integrates all of the data from the DataBuilt component databases for the selected component into the user's project and all related documents. The user can delete an existing component from a project and the system updates the user's project and all related documents. The DataBuilt transaction history databases are updated (user, project and compliance).

In process flow # 23 (Intelligent Drag & Drop DataBuilt Components), the user successfully logs into the DataBuilt website. The user selects a specific project from the user project list. The system validates permissions. If the permissions are not valid, the system notifies user with the permission detail failures. If the permissions are valid, the user enters DataBuilt component search criteria. The system finds all components that match the specific criteria. The user reviews the results display. The user selects a component uses the DataBuilt intelligent drag and drop function to copy the component information into the user's project. The Intelligent Drag & Drop function copies all the component detail into the project. The DataBuilt Java Applet creates the graphic representation from the parametric data. The system performs component compliance validation based on the selected component, placement in the drawing, and all codes and specifications relevant to the project. If the project fails the compliance check, the user is notified with the compliance failure details. If the project passes the compliance check, the user is notified of the pass status and prompted to indicate whether the component is to be added. If the user adds the component, the system integrates all of the data from the DataBuilt component databases for the selected component into the user's project and all related documents. The user can delete an existing component from a project and the system updates the user's project and all related documents. The DataBuilt transaction history databases are updated (user, project and compliance).

In process flow # 24 (Intelligent Drag & Drop of Components Between User Projects), the user successfully logs into the DataBuilt website. The user selects a specific project from the user project list. The system validates permissions. If the permissions are not valid, the system notifies user with the permission detail failures. The system initiates the “copy” function of DataBuilt component data. The system validates permissions and account status. The permissions are not valid, or the account status is not current, the system notifies the user of the error details. If all permissions are valid and the account status is valid, the system allows the user to copy all of the information related to one or more selected components into one or more permissioned projects. The system performs component compliance validation based on the selected component, placement in the new drawing, and all codes and specifications relevant to the new project. If the project fails the compliance check, the user is notified with the compliance failure details. If the project passes the compliance check, the user is notified of the pass status and prompted to indicate whether the component is to be added. If the user adds the component, the system integrates all of the data from the DataBuilt component databases for the selected component into the user's project and all related documents. The DataBuilt transaction history databases are updated (user, project and compliance).

In process flow # 25 (Intelligent Drag & Drop-Find and Replace with Alternative Component), the user successfully logs into the DataBuilt website. The user selects a specific project from the user project list. The system validates permissions. If the permissions are not valid, the system notifies user with the permission detail failures. If the permissions are valid, the user selects a DataBuilt component and requests the system to identify all alternative components in the DataBuilt component database. The system finds all components that match the specific criteria. The user reviews the results display. The user selects a component and uses the DataBuilt intelligent drag and drop function to copy the component information into the user's project. The Intelligent Drag & Drop function copies all the component detail into the project. The DataBuilt Java Applet creates the graphic representation from the parametric data. The system performs component compliance validation based on the selected component, placement in the drawing, and all codes and specifications relevant to the project. If the project fails the compliance check, the user is notified with the compliance failure details. If the project passes the compliance check, the user is notified of the pass status and prompted to indicate whether the component is to be added. If the user adds the component, the system integrates all of the data from the DataBuilt component databases for the selected component into the user's project and all related documents. The user can delete an existing component from a project and the system updates the user's project and all related documents. The DataBuilt transaction history databases are updated (user, project and compliance).

In process flow # 26 (DataBuilt Complex Components Created by User), the user successfully logs into the DataBuilt website. The user creates a complex component by selecting one or more components (using intelligent drag & drop functions) from the DataBuilt component database and/or a generic component from within a CAD shop drawing/document. The system uses the DataBuilt Java Applet to create the component graphics and all specifications are copied to the project. The system prompts the user to select one or more manufacturers for DataBuilt to send the complex component details to, so that the manufacturer(s) can evaluate and then manufacture as a single component. The user does not have to send a request to a manufacturer. The system prompts the user to identify whether other users are to be permissioned to use the complex component. If the user selects to permission others, the system prompts the user to identify the user IDs. The system updates the permissions for the user IDs. The system updates the transaction history databases (user, project, project profile and permissions, and components). If the user selects not to permission other users for the complex component, the user returns to the previous view in the open project. If the user selects to send the complex component to manufacturers, the specifications for the multiple components are sent to one or more manufacturers, as specified by the user. The system updates the transaction history databases (user, project and components). DataBuilt receives the response from one or more manufacturers regarding the new component detail and all of the data to support the new component. The system analyst verifies and validates the new component data. If the information is valid, the system adds the new component to the component database and updates the transaction history databases (user, component and project). The system sends e-mail with the detail of the new component to the user. If the data is invalid, the analyst resolves the problem, which may include contacting the user or the manufacturer, and re-enters the new component data for system validation. The system updates the transaction history databases (user, project and component).

In process flow # 27 (DataBuilt Generic Components Created by User), the user successfully logs into the DataBuilt website. The user selects a project from the user's project list. The user selects a component from the DataBuilt component database. The user initiates the “generic” intelligent drag and drop function to copy the selected component into the selected project. The system verifies that the user is permissioned to use generic components at the user, project and company levels. If the user is not permissioned to add a generic component, the system notifies the user of the permission error details and returns the user to the previous view. If the user is permissioned, a DataBuilt Java Applet creates the graphic representation of the component and updates the project and all related documents in the project. The system updates the project but does not perform the compliance check since the data to support component compliance checking is not included as an update to the project documents. The system updates the transaction history databases (user and project). The user is returned to the previous view in the open project.

In process flow # 28 (DataBuilt Component Changes—Project Alert on User's Project List), after the system has modified, deleted or received a notification from the manufacturer regarding an existing component in the DataBuilt component database, the system automatically checks the DataBuilt user transaction database to identify all projects that have been affected by any specific component modification, deletion or notification. If a match is found, the system identifies all permissioned users for the project. The system sets a project alert flag for the project primary ID. An alert flag on a project primary ID causes the project to flash when displayed on the project list on the permissioned user's website. The system updates the transaction history databases (user and project). When the user clicks on the flashing project, the system checks the account status. If the account status is not valid the system notifies the user that the changes cannot be viewed due to the account status and the user should contact the administrator. If the account status is valid, the system displays all of the details for the component change. If the user selects to update the component in the project, the system checks to see whether the user is permissioned to modify the project. If the user is not permissioned, the system notifies the user that the information can be viewed, but cannot be integrated into the project. If the user is permissioned to modify the project, the user can select the “intelligent drag and drop function” to update the component in the project or; select the “find alternative and replace function” to replace the component. If the user makes a change to the project by either updating the component or finding an alternative component, the system performs the component compliance check based on the codes, specifications, geographic locations and project level requirements. The system proceeds with the component and compliance processes, as defined in previous sections (e.g., process flow # 23).

In process flow # 29 (DataBuilt Component Changes-Project Alert on User's Project List), after the system has modified, deleted or received a notification from the manufacturer regarding an existing component in the DataBuilt component database, the system automatically checks the DataBuilt user transaction database to identify all projects that have been affected by the specific component modification, deletion or notification. If a match is found, the system identifies all permissioned user IDs for the project. The system determines whether the account status is valid. If the account status is not valid, the system determines the e-mail address for the user ID and sends an e-mail to the user indicating that the user's project has a component that has been changed, but the details cannot be forwarded to them due to the account status. If the account status is valid, the system sends an e-mail (with return receipt) indicating that a component in the user's project has been changed. The e-mail links to the website so that the user can click on the link and view all the details. The transaction history databases are updated (user and project).

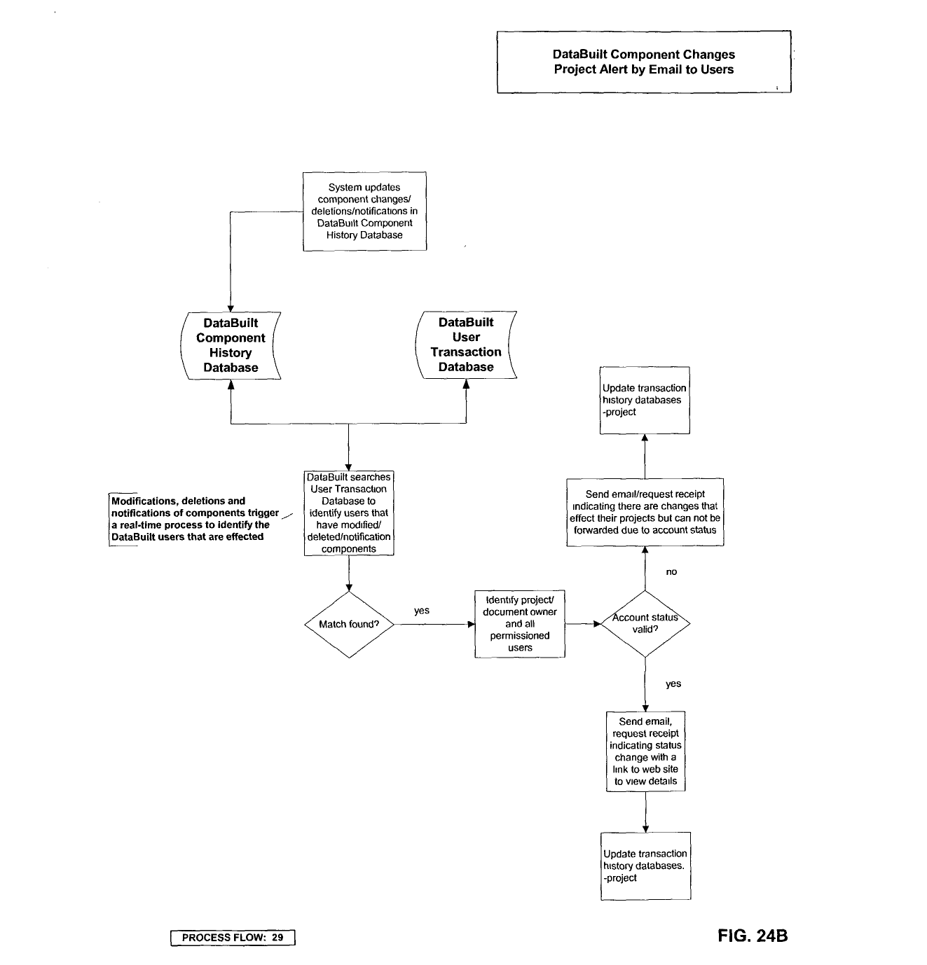

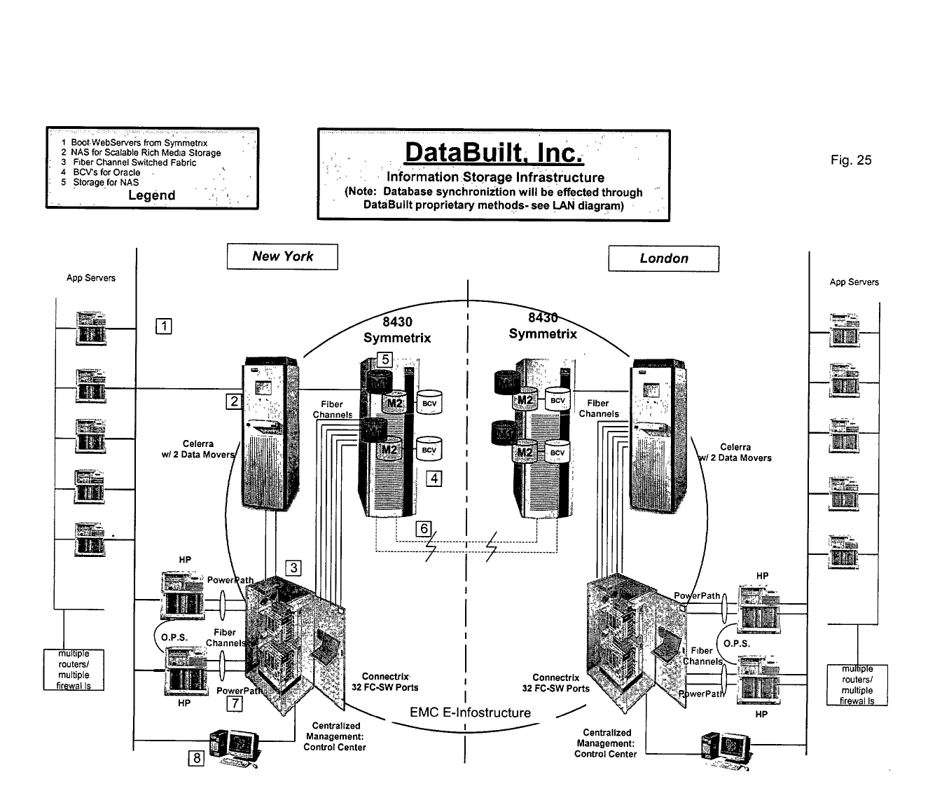

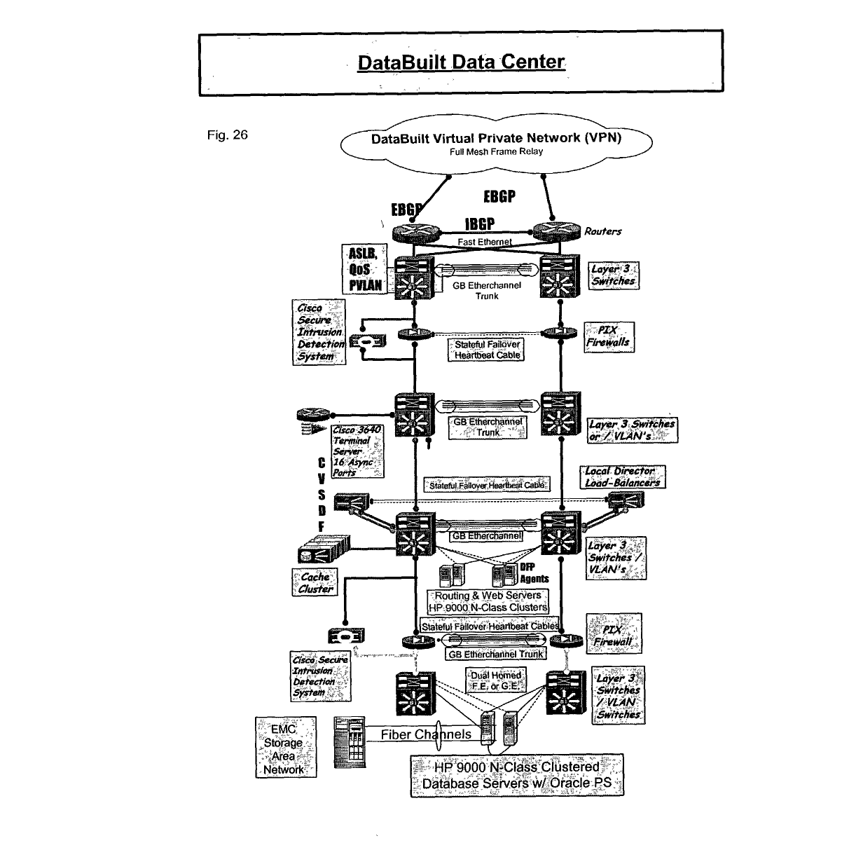

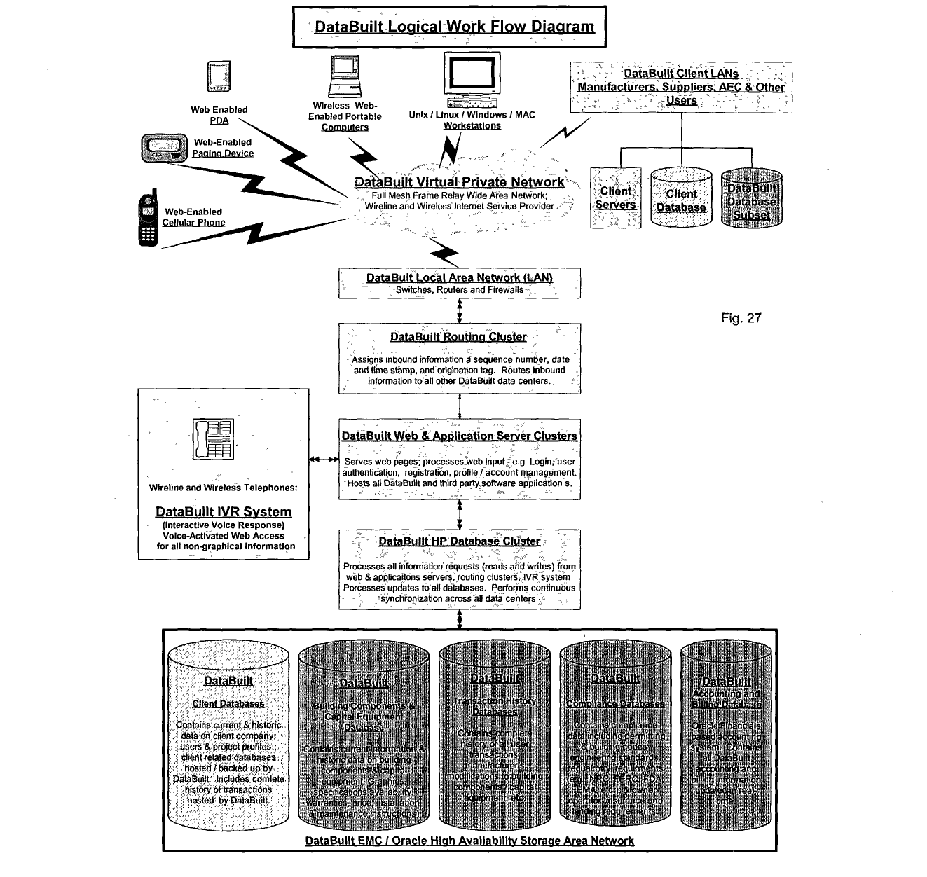

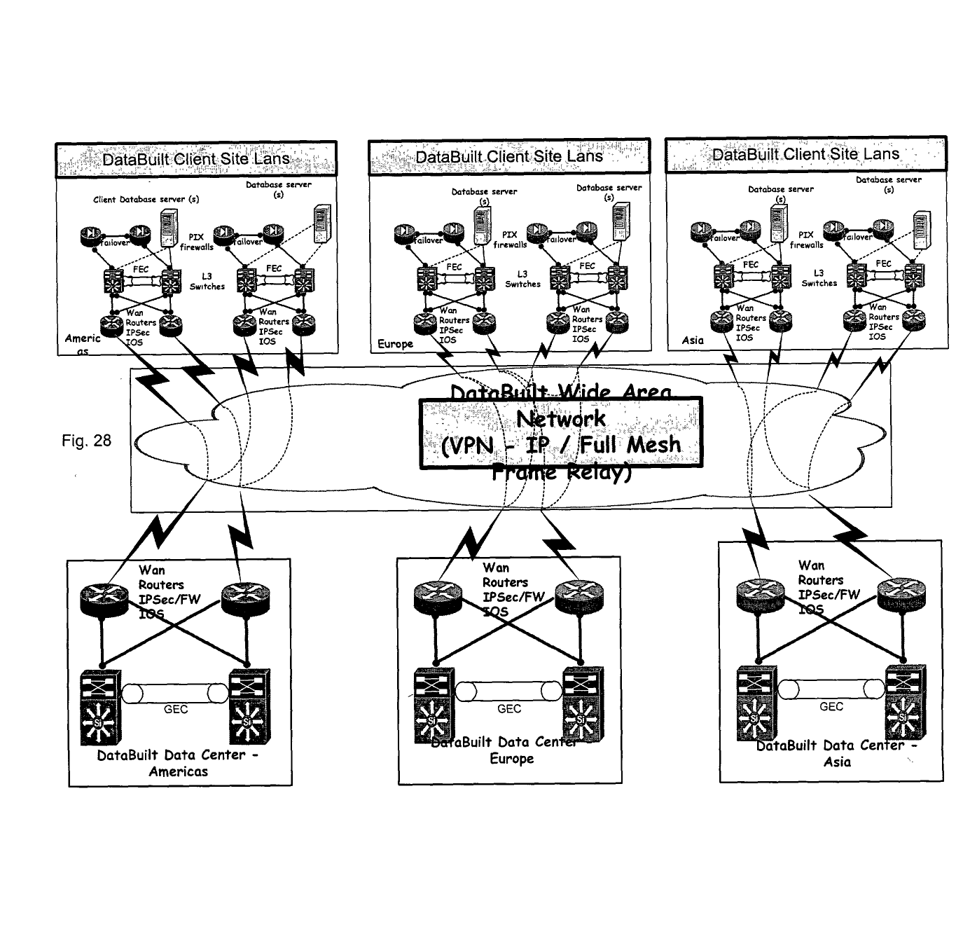

FIGS. 25, 26, 27, 28A and 28B show a network configuration and hardware architecture configuration of a database system for the second embodiment of the present invention. This network configuration and hardware architecture configuration may also be used in the first embodiment of the present invention.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Changes can be made to the embodiments described above without departing from the broad inventive concept thereof. The present invention is thus not limited to the particular embodiments disclosed, but is intended to cover modifications within the spirit and scope of the present invention.

What is claimed is:

1. A method of preparing a design file or drawing file for a project, each design file or drawing file including a plurality of building component data elements, each representing a specific building component, each unique building component having a unique building component identifier, the method comprising:
(a) selecting one or more building component data elements for the design file or drawing file, each building component data element comprising physical attributes of the data element; and
(b) storing the unique building component identifier of each selected building component data element in a project database.

2. The method of claim 1 wherein each building component data element represents a vendor-specific building component, the project database thereby containing the contents of the building components in the project identified by vendor.

3. The method of claim 2 wherein step (a) further comprises selecting the one or more building component data elements for the design file or drawing file from a library of vendor-specific building component data elements.

4. The method of claim 2 further comprising:
(d) maintaining a component database of vendor-specific building components, each building component including one or more non-physical attributes of the building component.

5. The method of claim 1 wherein the unique building component identifier is stored in a comment field of the building component data element.

6. The method of claim 5 wherein each building component data element is a cell file and the unique building component identifier is stored in a comment field of the cell file.

7. The method of claim 1 wherein each building component data element is a defined by a drag and drop component.

8. The method of claim 1 wherein the unique building component identifier of each selected building component data element is stored in a project database that is separate from the design file or drawing file.

9. A method of identifying a vendor-specific building component data elements by vendor, the method comprising:
(a) assigning a unique building component identification number (UCID) to a vendor-specific building component; and
(b) storing the UCID in a comment field of a building component data element, thereby providing any design or drawing file that uses the building component data element with sufficient information to identify building components in the design or drawing file on a vendor-specific level.

10. A method of determining the contents of a design file or drawing file on a vendor-specific basis, the design file or drawing file including a plurality of building component data elements, at least some of the building component data elements having a vendor-specific unique building component identification number (UCID) stored in a comment field of the building component data element, the method comprising:
(a) parsing data of the building component data elements to obtain the vendor-specific UCID's from the comment fields; and
(b) creating an inventory of the contents of the design file or drawing file from any UCID's located in the comment fields.

11. The method of claim 10 further comprising:
(c) maintaining a project database that contains the inventory of the contents of the design file or drawing file.

12. The method of claim 11 wherein steps (a) and (b) are performed subsequent to the initial creation of the design file or drawing file, the method further comprising:
(d) updating the project database with the current inventory of the contents of the design file or drawing file.

13. A computer-implemented method of creating projects that comply with building codes of a geographic location of the project, the building codes of a plurality of geographic locations being stored in a database of rules, each project including a plurality of building components, at least some of the building components being stored in a library of building components and having building code-related data associated therewith, the method comprising:
(a) maintaining a project database that contains:
(i) the contents of the building components in a design file or drawing file of the project;
(ii) a geographic identifier that represents the geographic location of the project represented by the design file or drawing file;
(b) using the geographic identifier, the database of rules for the geographic location, and the building code-related data to identify which building components in the library comply with the building code for the geographic location of the project; and
(c) creating a library subset of selectable building components from the identified building components, wherein a user's selection of building components for the design file or drawing file from the library is limited to the library subset.

14. The method of claim 13 wherein the geographic identifier is a zip code.

15. A computer-implemented method of checking projects for compliance with building codes of a plurality of different geographic locations, the building codes of the geographic locations being stored in a database of rules, each project including a plurality of building components, at least some of the building components being stored in a library of building components and having building code-related data associated therewith, the method comprising:
(a) maintaining a project database that includes the contents of the building components in a design file or drawing file of the project;
(b) assigning a geographic identifier that represents the geographic location of the project represented by the design file or drawing file; and
(c) using the geographic identifier, the database of rules for the geographic location, and the building code-related data to check whether building components that are in the project database comply with the building code for the geographic location of the project.

16. The method of claim 15 further comprising:
(d) identifying any building components in the project database that do not comply with the building code for the geographic location.

17. An apparatus for creating projects that comply with building codes of a geographic location of the project, each project including a plurality of building components, at least some of the building components being stored in a library of building components and having building code-related data associated therewith, the apparatus comprising:
(a) a project database that contains:
(i) the contents of the building components in a design file or drawing file of the project;
(ii) a geographic identifier that represents the geographic location of the project represented by the design file or drawing file;
(b) a rule engine including a database of rules based upon building codes of a plurality of different geographic locations; and
(c) a comparator that uses the rule engine and the building code-related data in the database of building components to create a library subset of selectable building components from the identified building components, wherein a user's selection of building components for the design file or drawing file from the library is limited to the library subset.

18. The apparatus of claim 17 wherein the geographic identifier is a zip code.

19. A method of searching for a building component in a database of building components, each building component being represented by (i) a unique building component identifier, and (ii) characteristic identification number formed by a string of numbers, each digit or group of digits in the string of numbers representing one characteristic of the building component and having one or more values related to a description of the characteristic, the method comprising:
(b) the search engine using the unique building component identifier to locate the corresponding characteristic identification number of the building component; and
(c) the search engine using the characteristic identification number to identify other building components that have characteristic identification numbers that match or closely match the entered characteristic descriptions.

20. A method of encoding building components with unique identification numbers, each building component being associated with a specific vendor, the method comprising:
(a) assigning an arbitrary vendor identification number to each of vendor of building components;
(b) assigning an arbitrary generic building component identification number to each physically unique building component; and
(c) algorithmically combining the arbitrary vendor identification number and the arbitrary generic building component identification number to obtain a unique building component identification number for each building component.

21. The method of claim 20 wherein the algorithmic combination is a concatenation of the vendor identification number and the generic component identification number.

22. The method of claim 20 wherein the algorithmic combination is a concatenation of a hexadecimal equivalent of the vendor identification number and a hexadecimal equivalent of the generic component identification number, with additional hexadecimal checksum digits, thereby creating an encoded version of a unique building component identification number for each building component.
